(19) United States
(12) Patent Application Publication
(10) Pub. No.: US 2004/0039621 A1
(43) Pub. Date: Feb. 26, 2004

(54) Resource management planning

(76) Inventors: James C. Wood, Essex, VT (US); Warren T. McFall, Boise, ID (US); Kristen E. Keith, Nampa, ID (US); Jenifer C. Beddoes, Boise, ID (US)

Correspondence Address: Ormiston & McKinney, PLLC, Suite 400, P.O.Box 298 802 W. Bannock, Boise, ID, 83701-0298, US

(21) Appl. No.: 10/455,914

(22) Filed: Jun. 6, 2003

Related U.S. Application Data
(60) Provisional application No. 60/387,112, filed on Jun. 7, 2002.

(51) Int. Cl. G06F 17/60

(52) U.S. Cl. 705/7

(57) ABSTRACT

In one embodiment, a resource management planning system that includes a web server having access to digital imagery of geographic areas and geospatial information associated with the digital imagery, computer programming for compiling geospatial information for a site selected from the digital imagery, and computer programming for generating a conservation plan identifying resource problems for the site and identifying practices that when implemented are expected to solve the resource problems. In another embodiment, the system includes computer programming for generating a nutrient management plan identifying nutrient management practices for agricultural operations on a selected site in which nutrients are applied to the land and/or animal waste or other bio-nutrients are handled.

### CROSS REFERENCE TO RELATED APPLICATION

This application claims subject matter disclosed in copending provisional patent application serial No. 60/387,112 filed Jun. 7, 2002, entitled Agricultural Resource Management Planning.

### STATEMENT OF RIGHTS TO INVENTIONS MADE UNDER FEDERALLY FUNDED RESEARCH AND DEVELOPMENT

Part of the work performed during the development of the Idaho OnePlan™ was funded by the United States Department of Agriculture CSREES under contract no. EWQI10547. The United States government may have certain rights in the invention.

### FIELD OF THE INVENTION

The present invention is directed generally to resource management planning.

### BACKGROUND

Farmers, ranchers and other agricultural producers manage the agricultural resources important to their crops, livestock or other products. Farmers, for example, evaluate field soil conditions to determine which crops are best suited for different fields and to optimize crop rotation and fertilization. Ranchers assess managed lands for livestock carrying capacity and necessary conservation practices. Milk producers seek to off-set disposal costs for huge volumes of animal waste against the value of this natural fertilizer.

Producers also must comply with laws and regulations enacted to conserve limited natural resources and to protect people and the environment from potentially damaging agricultural activities. Water quality standards adopted under the Clean Water Act, for example, may impact the application of fertilizer by a farmer, whether a farm uses flood or sprinkler irrigation, and how a dairy producer disposes of animal waste. In view of the increasing complexity and sophistication of modern agriculture, both in terms of production and regulation, it is essential that producers plan important resource management activities to help optimize production and profit as well as ensure regulatory compliance.

Since 1930, the U.S. Department of Agriculture Natural Resource Conservation Service (NRCS) has been charged with conserving agricultural lands, especially private lands, in the United States. Through the years, the NRCS developed a thorough conservation planning process, called the 9 Step Planning Process, which incorporates a grassroots approach for developing and delivering conservation through local conservation districts. The 9 Step Planning Process is described in detail in the NRCS National Planning Procedures Handbook. This process is complex and relies heavily on numerous time consuming manual tools used by professional agency planners. The substantial human resources necessary to implement this complex manual planning process limits the effectiveness of the process and, indeed, has prevented widespread application of the process to help agricultural producers develop conservation plans and then implement those plans on the ground.

The computer based techniques described below were developed by interested regulatory, service and educational agencies to overcome some of the problems associated with existing conservation and resource management planning processes. Agencies participating in the development include the U.S. Environmental Protection Agency, the U.S. Department of Agriculture Natural Resources Conservation Service, the U.S. Department of Agriculture Agricultural Research Service, the Idaho Department of Agriculture, the Idaho Soil Conservation Commission and the University of Idaho College of Agriculture and Cooperative Extension Office. Some of the new planning techniques are embodied in a computer program package currently available under the name Idaho OnePlan™. The Idaho OnePlan™ is a work in progress developed to provide agricultural producers with an easily accessible user-friendly tool for managing soil and water conservation activities according to information, guidelines and regulations from all interested local, state and federal agencies. The ultimate goal for the Idaho OnePlan™ is to allow producers to prepare one plan that addresses all resource conservation and environmental requirements for all agencies for his or her operation. The Idaho OnePlan™ currently helps producers prepare a Nutrient Management Plan that complies with all local, state and federal agency requirements. Methodology for a conservation planning module has been developed but not yet implemented in the Idaho OnePlan™ program package. Continuing efforts are directed to improving the Idaho OnePlan™ Nutrient Management module while also implementing the conservation planning methodology and developing pest, grazing and habitat management modules.

### BRIEF DESCRIPTION OF THE DRAWINGS

FIG. 1 illustrates a method used to develop a comprehensive computer based resource management planning tool.

FIG. 2 illustrates a method for creating and implementing a resource management plan in which an independent planner certifies completion of the plan and an independent professional monitors implementation of the plan.

FIG. 3 illustrates a method for creating and implementing a resource management plan in which an agricultural producer creates the plan, self-certifies it, and then notifies the designated agency that the plan has been completed.

FIG. 4A illustrates an Internet accessible mapping module and a PC based decision support program module for a resource management planning computer program package.

FIG. 4B illustrates a mapping module and a decision support program module residing on a web server.

FIG. 5 illustrates an opening screen that may be displayed when the computer program package of FIG. 4A is launched at the user's PC.

FIGS. 6-8 illustrate screens that may be displayed through the mapping module of the computer program package of FIG. 4A.

FIGS. 9-11 illustrate screens that may be displayed through the PC based decision support program module of FIG. 4A when the user is prompted to define farm or ranch fields or other planning units.

FIGS. 12-19 illustrate screens that may be displayed through the PC based decision support program module of FIG. 4A when the user is prompted to identify characteristics of the planning units.

FIGS. 20A-20C illustrate a directory and navigation tree for one embodiment of the PC based decision support program module of FIG. 4A.

FIG. 21 illustrates a conservation module that may be used in the PC based decision support module of FIG. 4A.

FIGS. 22A-22D illustrate bio-nutrient, facilities sizing and crops sections of a nutrient management module used in the decision support module of FIG. 4A.

FIGS. 23A-23G illustrate the irrigation section of a nutrient management module used in the decision support module of FIG. 4A.

FIGS. 24A-24F illustrate the resource concerns section of a nutrient management module used in the decision support module of FIG. 4A.

FIGS. 25A-25I illustrate the application section of a nutrient management module used in the decision support module of FIG. 4A.

FIGS. 26-28 illustrate screens that may be displayed as part of the introduction and livestock sections of a nutrient management module used in the decision support module of FIG. 4A.

FIGS. 29-30 illustrate screens that may be displayed as part of the bio-nutrients section of a nutrient management module used in the decision support module of FIG. 4A.

FIGS. 31-41 illustrate screens that may be displayed as part of the facilities sizing section of a nutrient management module used in the decision support module of FIG. 4A.

FIGS. 42-46 illustrate screens that may be displayed as part of the crops section of a nutrient management module used in the decision support module of FIG. 4A.

FIGS. 47-57 illustrate screens that may be displayed as part of the irrigation section of a nutrient management module used in the decision support module of FIG. 4A.

FIGS. 58-66 illustrate screens that may be displayed as part of the resource concerns section of a nutrient management module used in the decision support module of FIG. 4A.

FIGS. 67-72 illustrate screens that may be displayed as part of the application section of a nutrient management module used in the decision support module of FIG. 4A.

FIGS. 73-74 illustrate screens that may be displayed as part of the nutrient risks section of a nutrient management module used in the decision support module of FIG. 4A.

FIGS. 75A-75C illustrate the records section of a nutrient management module used in the decision support module of FIG. 4A.

### DESCRIPTION OF EXEMPLARY EMBODIMENTS

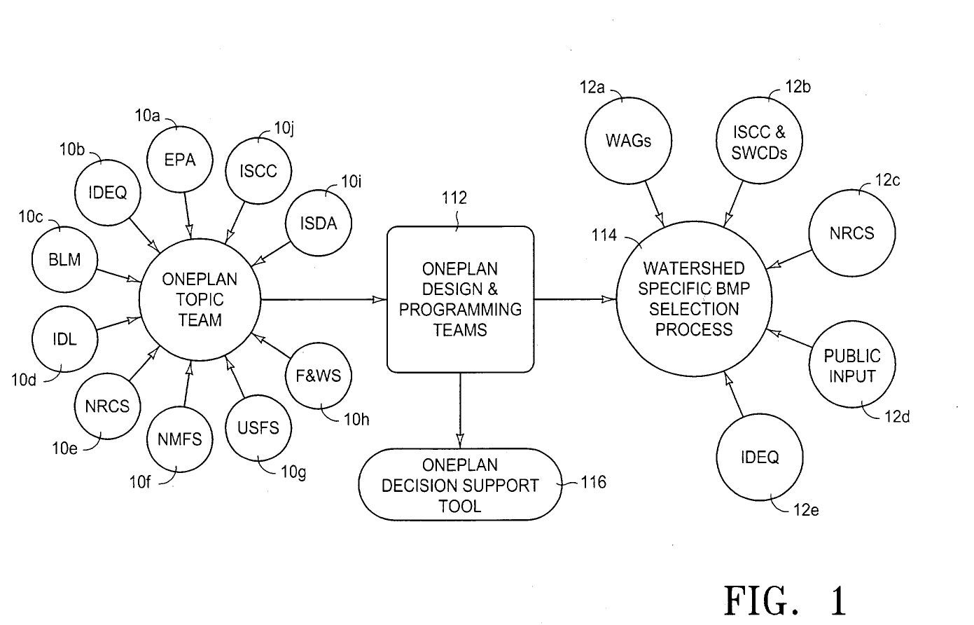

Overall Methodology For The Idaho OnePlan™. FIG. 1 illustrates the overall methodology used to develop a comprehensive resource management planning tool, which is also referred to as the decision support tool. In the implementation of this methodology described below, the decision support tool is the Idaho OnePlan™. Referring to FIG. 1, representatives from local, state and federal agencies 10a-10j having regulatory authority over agricultural producers for soil and water conservation activities convened as a topic team (step 110). Agencies identified by acronym in FIG. 1 are listed below.

EPA=U.S. Environmental Protection Agency

IDEQ=Idaho Department of Environment Quality

BLM=U.S. Bureau of Land Management

IDL=Idaho Department of Lands

NRCS=Natural Resource Conservation Service

NMFS=National Marine Fisheries Service

USFS=U.S. Forest Service

F&WS=U.S. Fish and Wildlife Service

ISDA=Idaho Department of Agriculture

ISCC=Idaho Soil Conservation Commission

WAG=Watershed Advisory Group

SWCD=Soil and Water Conservation District

The topic teams were tasked with identifying topics that must be addressed in any resource management plan if that plan is to address all applicable regulatory requirements. “All” regulatory requirements applicable to a resource, as that term is used in this document, means those requirements imposed by federal and state regulatory agencies that a resource producer must meet to be deemed in full compliance by each regulatory agency having an interest in any of the requirements.

While the NRCS 9 Step Planning Process is widely recognized and accepted among government agencies as the national standard for conservation planning on private lands, no attempt had ever been made to ensure the 9 Step Process met all regulatory requirements. In fact, the cumbersome nature of the 9 Step Process made any such comprehensive regulatory compliance all but impossible.

In theory, the topic team task is simple—compile all applicable regulatory requirements and identify the resource conditions necessary to satisfy those requirements. In practice, however, this task was anything but simple. First, the many regulations from many different agencies made charting the myriad regulating requirements alone a challenging task. Second, getting the regulatory agencies to agree to the notion of developing computer based rules that, by definition, address these requirements such that the agencies are committed up front to approve all plans created with these rules was, well, a very difficult task. Nevertheless, the team overcame these challenges and sent the requirements on to the design and programming teams (step 112).

Step 114 represents the development of watershed specific Best Management Practices (BMPs) by agencies and advisory groups 12a-12e required to implement the requirements of the Clean Water Act and other laws designed to protect the environment. Because these BMPs define on-the-ground resource management activities deemed sufficient to satisfy many regulatory requirements, they were used by the design and programming teams to define acceptable practices in the Idaho OnePlan™. In addition to watershed specific BMPs, the design and programming teams also incorporated other on-the-ground practices deemed sufficient by the governing agencies to address the regulatory requirements. In some cases, these practices were already known and used, and in other cases, the acceptable practices were developed by the design and programming teams. All of the regulatory requirements and their practice counterparts are then incorporated into the Idaho OnePlan™ decision support tool (step 116) and the agencies 10a-10h agree that any plan created through the proper execution of the decision support tool would, by definition, address all applicable regulatory requirements from the respective agencies (step 118).

So far as Applicants are aware, the notion of providing an agricultural producer with a comprehensive list of all regulatory requirements from all agencies in advance of on-the-ground activities is not only new, but revolutionary. Equally new and important is the collective recognition by all interested agencies that the Idaho OnePlan™ decision support tool, when properly executed, produces a plan that meets all applicable regulatory requirements. The producer is thereafter required only to implement the plan to achieve full regulatory compliance.

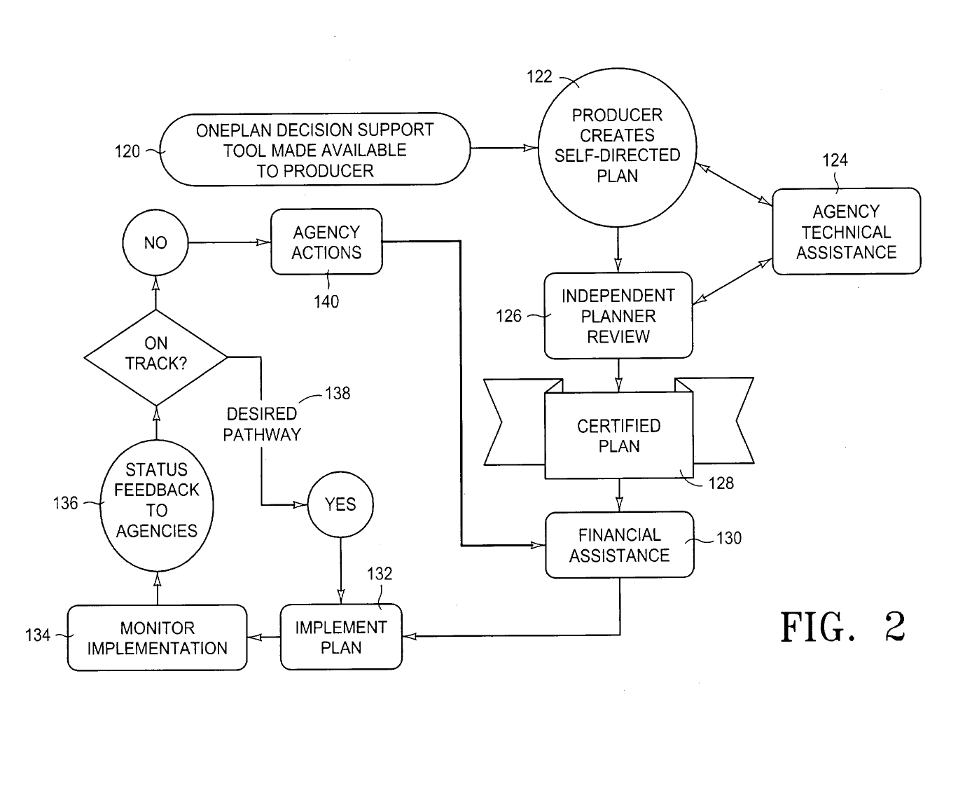

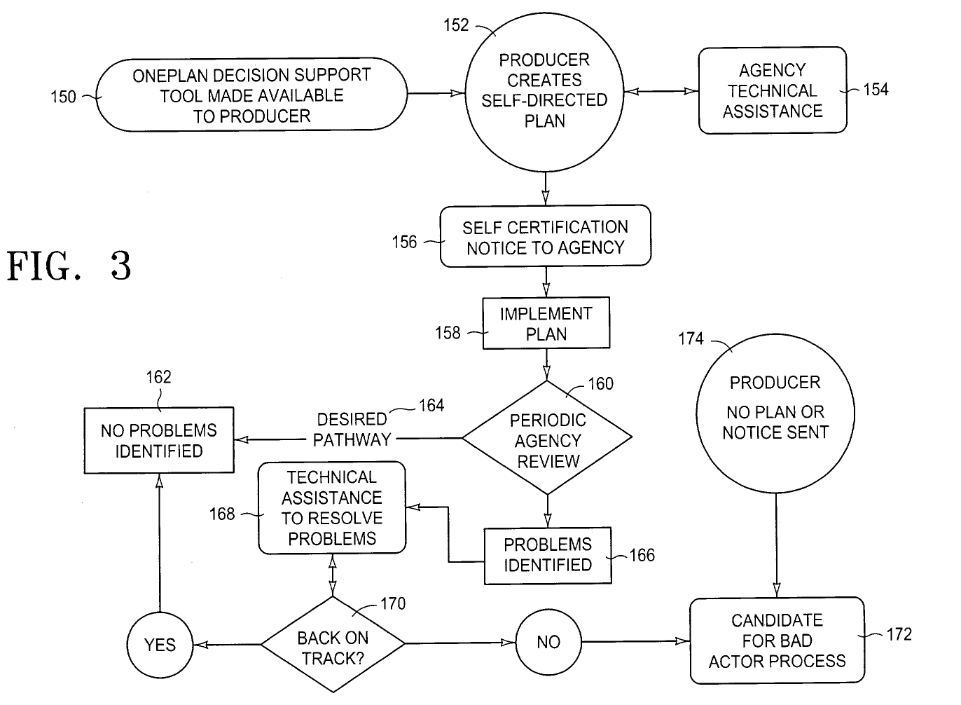

Producer Options For Regulatory Compliance. FIGS. 2 and 3 illustrate two options a producer may choose from for regulatory compliance. FIG. 2 illustrates a method for creating and implementing a resource management plan in which an independent certified planner may, if necessary, help the producer create the plan and an independent professional follows implementation of the plan. FIG. 3 illustrates a more streamlined method in which the producer creates the plan, self-certifies the plan and then notifies the designated agency, typically the local Soil and Water Conservation District, that the plan has been completed. This “self-certified” plan as well as implementation of the plan is subject to periodic agency review.

Referring first to FIG. 2, a decision support tool, the Idaho OnePlan™ in this example, is made available to the producer (step 120). In a preferred version of the Idaho OnePlan™ described below, the Idaho OnePlan™ computer program package is made available to producers in two parts. For one part of the package, the producer downloads geospatial information for her operation over the Internet from a designated web service. For the second part of the package, executable planning software is loaded on the producer's computer—this part of the package operates on the geospatial information downloaded from the web service to produce a resource management plan. The producer creates a resource management plan (step 122). Preferably, the plan is “self-directed” as noted in FIG. 2 in the sense that the planning software prompts the producer for the information necessary to determine management practices that must be implemented to comply with applicable regulatory requirements—management practices that are documented in the resource management plan created with the Idaho OnePlan™ decision support tool. The planning process is complex. It is expected, therefore, that in many instances, the local Soil and Water Conservation District or other appropriate agency will assist the producer in preparing and finalizing the plan as indicated in step 124.

The plan is reviewed by a certified planner (step 126). While producer creation in step 122 and planner review in step 126 may occur sequentially, more likely they will occur together. That is to say, that the certified planner will undertake review of the plan while the producer is developing the plan, all in connection with technical assistance from the local Soil and Water Conservation District. It is expected that this combined approach will help the producer reach plan certification as quickly and cost effectively as possible. Once the certified planner is satisfied the Idaho OnePlan™ decision making program has been properly executed against the relevant geospatial data, the plan is certified as addressing applicable regulatory requirements (step 128).

Certified planners need not be agency enforcement personnel knowledgeable in all phases of resource management—the certification process is not a re-hash of all that went into the development of the Idaho OnePlan™ decision support tool. Rather, certification represents the planner's judgment that the Idaho OnePlan™ program has been properly executed against relevant geospatial data. Therefore, the plan may be certified as addressing applicable regulatory requirements because all such requirements are, by definition, addressed by the Idaho OnePlan™ decision making program. Moreover, in the preferred embodiment in which each agency agrees to recognize certified plans as addressing all regulatory requirements, the producer can rely on certification as binding all such agencies. Two very significant advantages are realized from this methodology. First, the many individual agencies regulating producers don't have to send enforcers out to check on producers—the agencies can collectively monitor implementation of the plan without worrying about whether or not the plan itself adequately addresses individual agency requirements. Second, producers don't have to worry about piece-meal enforcement in which compliance with one agency requirement is often rewarded with a visit from another agency enforcer.

In an optional step 130, financial assistance is made available to the producer to off-set planning, certification and implementation costs. From an agency standpoint, there is greater regulatory certainty and likely lower agency costs associated with the certified plan option of FIG. 2 over the un-certified plan option of FIG. 3. Hence, it may be desirable to encourage producers to use the certified plan option through financial assistance, as reflected in step 130.

Following certification, the plan is implemented (step 132). Implementation is monitored by an independent certifying or other implementation agent (step 134). The monitoring agent reports the degree of compliance or non-compliance with the plan to the appropriate agencies (step 136). If the plan is being properly implemented and the producer is on track (the desired path 138), then no further action is required. If not, then agency action may be required to help the producer get back on track (step 140).

In the plan development and implementation option illustrated in FIG. 3, the decision making tool is made available to the producer (step 150) and the producer creates a plan with any technical agency assistance that might be necessary (steps 152 and 154). Once the plan is completed, the producer notifies the local Soil and Water Conservation District or other appropriate agency that the plan has been completed (step 156). Notice may be made by submitting a copy of the plan, or by a short form notice that the plan has been completed. In either event, the plan is then implemented (step 158) subject to periodic agency review to monitor compliance with the plan (step 160). If no problems are identified (step 162) and the producer is on track (the desired path 164), then no action is required. If problems are identified (step 166), technical assistance is offered to resolve the problems (step 168) to get the producer back on track (step 170). If the producer is unable or unwilling to get back on track, then she becomes a candidate for the bad actor process (step 172). Of course, if a producer refuses to submit a plan in the first place (step 174), she immediately becomes a candidate for the bad actor process.

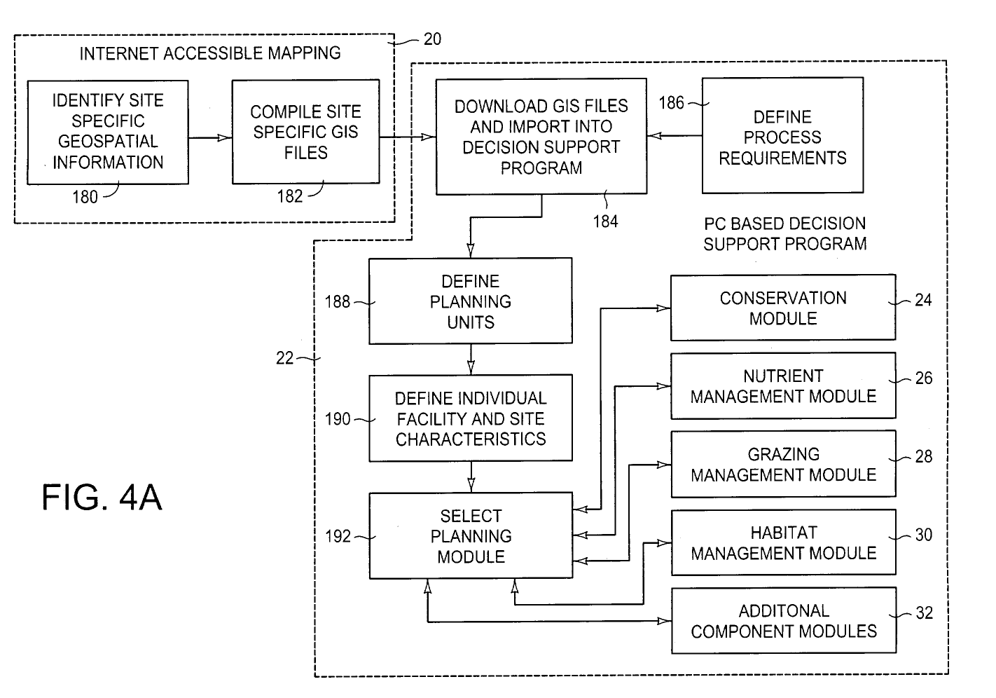

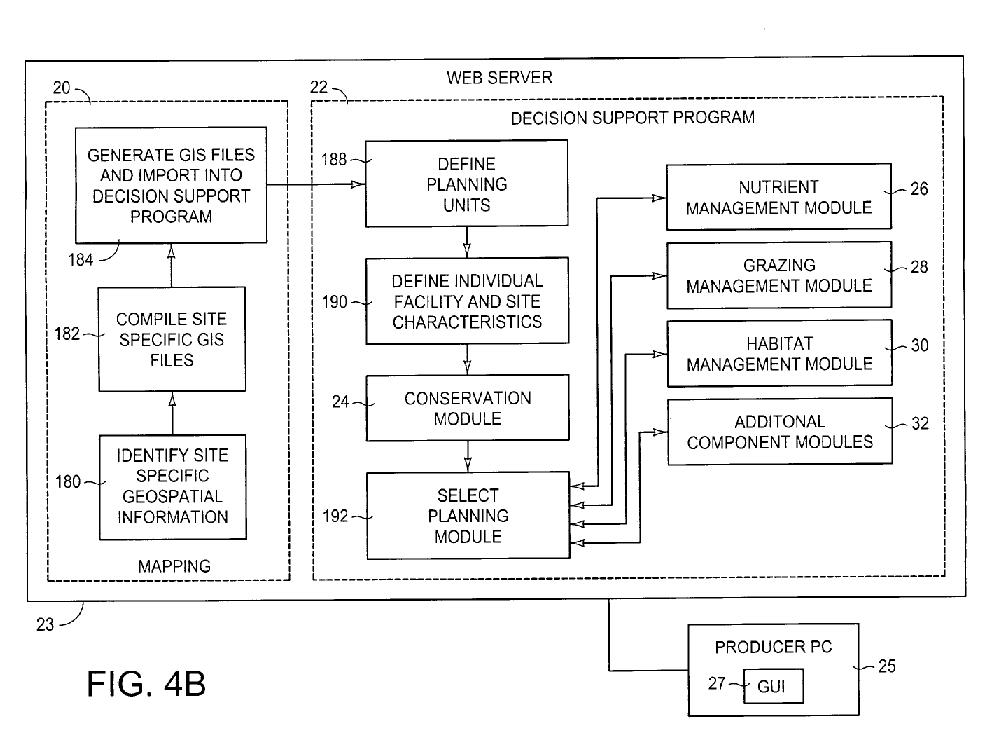

Internet Accessible Mapping. In one version of the Idaho OnePlan™ computer program package, the package is made available to producers in two parts, as illustrated in FIG. 4A—Internet accessible mapping module 20 and a PC based decision support program module 22. Mapping module 20 is maintained by a web service hosted by a web server accessible through the Internet. A “web server” as that term is used herein means any server that implements HTTP (Hypertext Transport Protocol). A web server can host a web site or a web service. A web site provides a user interface by supplying web pages to a requesting client, typically a web browser. Web pages can be delivered in a number of formats including, but not limited to, HTML (Hyper-Text Markup Language) and XML (eXtensible Markup Language). Web pages may be generated on demand using server and client side scripting technologies including, but not limited to, ASP (Active Server Pages) and JSP (Java Server Pages) and JavaScript. A web page is typically accessed through a network address. The network address can take the form of an URL (Uniform Resource Locator), IP (Internet Protocol) address, or any other unique addressing mechanism.

The web service provides access to web based decision support applications, mapping, aerial photography and geospatial data relevant to agricultural resource management for agricultural areas mapped and photographed. Geospatial data typically includes, for example, common resource areas, USDA-NRCS SSURGO certified soils data along with slope, composition and layer data needed to for nutrient management planning; climatic data; stream and waterway data; streams listed in Section 303(d) of the Clean Water Act that may be adversely impacted by contaminants transported from target farm fields; Universal Soil Loss Equation (USLE) C factor used in the Revised Universal Soil Loss Equation (RUSLE); Soil and Water Conservation District; fourth field hydrologic unit/watersheds; groundwater quality zone for nitrate contamination; range, township and section; aquifers; and other geospatial data as necessary. Although the geospatial data available for download could be as large as the overall map coverage, currently download files are limited in the Idaho OnePlan™ to data covering a maximum 3 mile×3 mile area to make the download manageable across regular phone lines. This area is ample for farm or ranch planning activities and, hence, no substantive sacrifice need be made to accommodate this download size limitation.

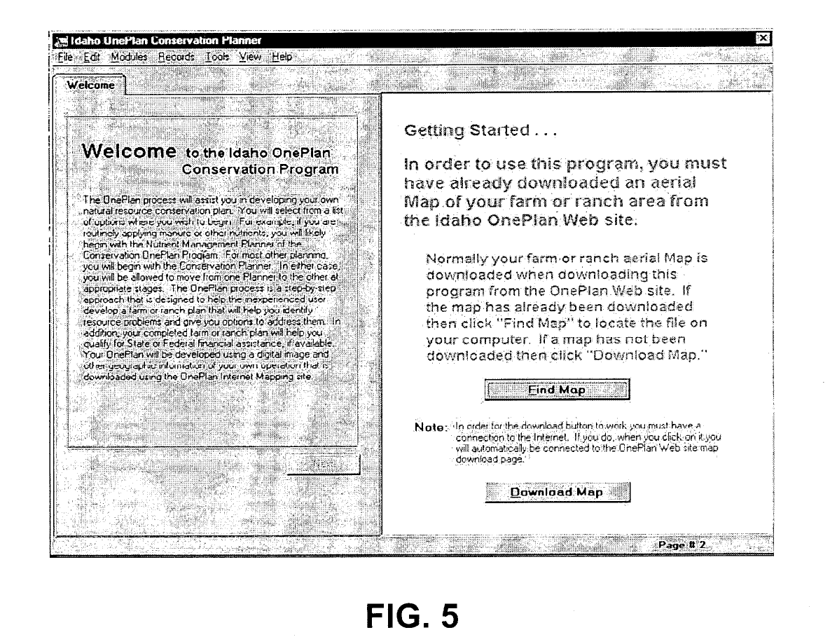

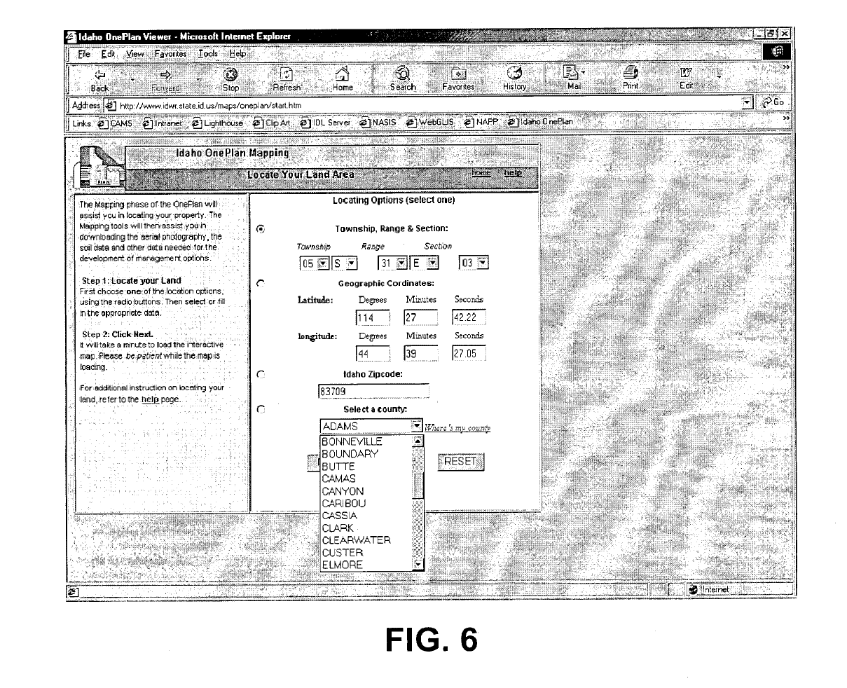

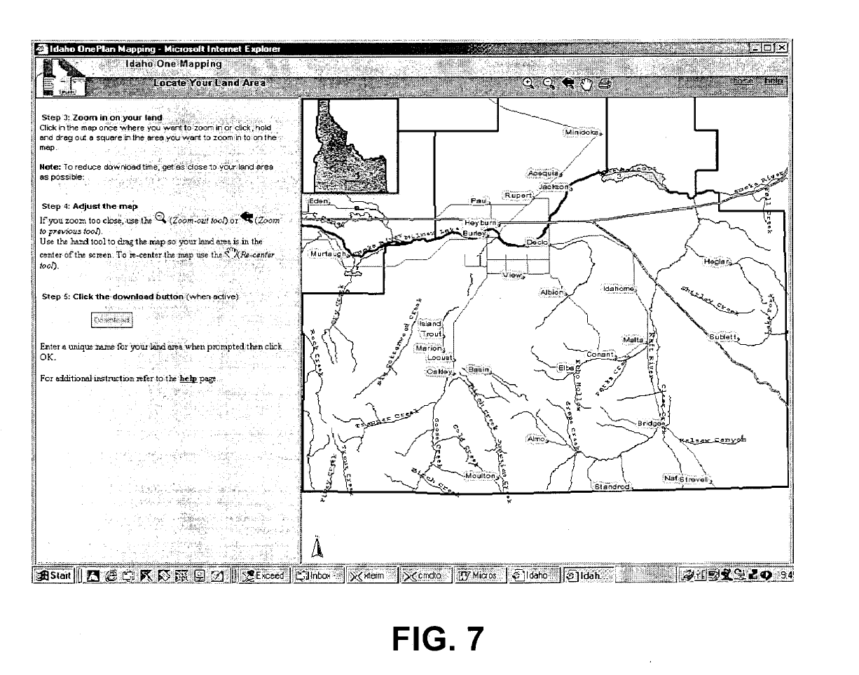

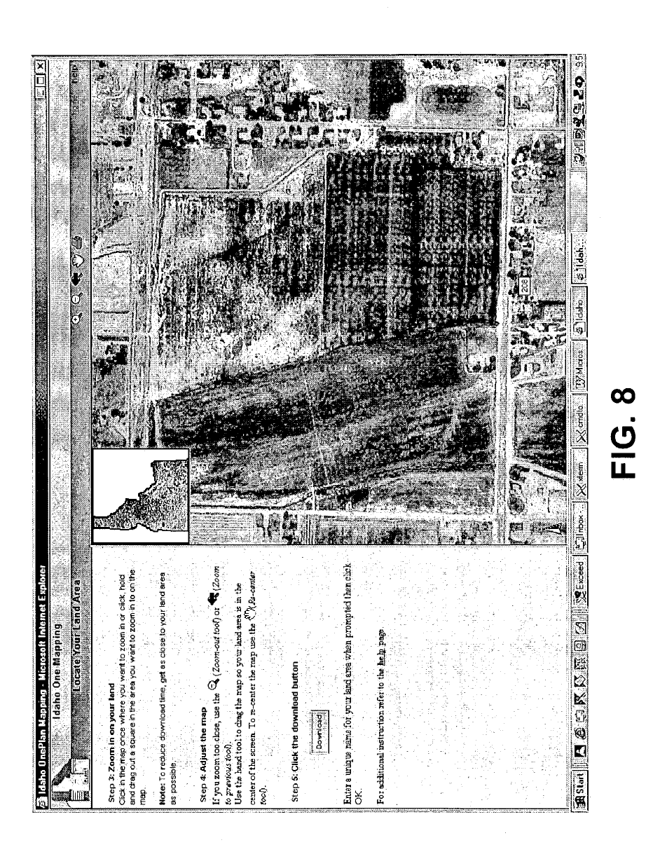

The producer or other user initiates the planning process by launching the Idaho OnePlan™ program on his personal computer. The program may be downloaded from the web service or otherwise installed on the producer's PC. Initially, the user is prompted to find an existing map or, if the site has not yet been mapped, then to download a map as indicated on the opening screen shown in FIG. 5. When the download map option is selected, the program automatically launches the user's browser to establish an on-line connection to the web service hosting the mapping program of module 20 in FIG. 4A. Mapping allows the Idaho OnePlan™ program to identify site specific geospatial information for the target farm or ranch necessary to determine appropriate resource management activities (step 180 in FIG. 4A). Once the program is initiated, the user is presented with options for locating the general area of the farm, ranch or other agricultural site, such as the four options shown in the screen of FIG. 6. The user locates the area by, for example, designating the township, range and section to locate the site, the geographical coordinates by latitude and longitude, the Zip Code, or the county, and the designated area is displayed. If the county is selected, for example, a map of the county is displayed as shown in the screen of FIG. 7. The user is prompted in this screen to click on the map near the site and then zoom in until an aerial photograph is displayed, as shown in FIG. 8. The digital image is displayed only when the viewing area is smaller than 6 miles×6 miles. The user is prompted to center the target site on the area displayed and then initiate the download by selecting the download button, which is currently only activated when the selected area is 3 miles×3 miles or smaller.

When the download button is selected, the program automatically identifies the geospatial information associated with the imaged area (step 180 in FIG. 4A) and compiles that data into a download file or group of files containing the geospatial data (step 182 in FIG. 4A). All of the data in the download files is, preferably, compiled into a format compatible with Geologic Information System (GIS) applications. Geospatial data is associated with the digital imagery of the aerial photographs, and compiled into GIS files, using ArcIMS® mapping software commercially available from ESRI of Redlands, Calif. Image data, for example, is downloaded as a georeferenced JPG format file, geospatial coverage of various thematic layers such as soils, water quality, and watersheds, in ESRI shapefile format, and corresponding data in dBase (.dbf) database format.

In the Idaho OnePlan™, all of the geospatial data available at the web service for the 3 mile×3 mile target area is automatically sent to the user when the download button is selected and the user follows the download process. In an optional feature, the user may be presented with a list of the geospatial data that may be selectively downloaded separately, or not at all. While this option may be desirable for more sophisticated users or where the available data is to voluminous to handle efficiently, automatically downloading all available data simplifies the process and is adequate for most users in most areas.

PC Based Decision Support Program. Referring to FIG. 4A, when the GIS files are downloaded, they are automatically imported into the PC based decision support program 22 running on the user's PC (step 184). Step 186 reflects the incorporation into PC program module 22 of process requirements necessary to produce a plan that addresses applicable regulatory requirements. These process requirements were determined by the design teams in step 112 of the overall program development methodology illustrated in FIG. 1.

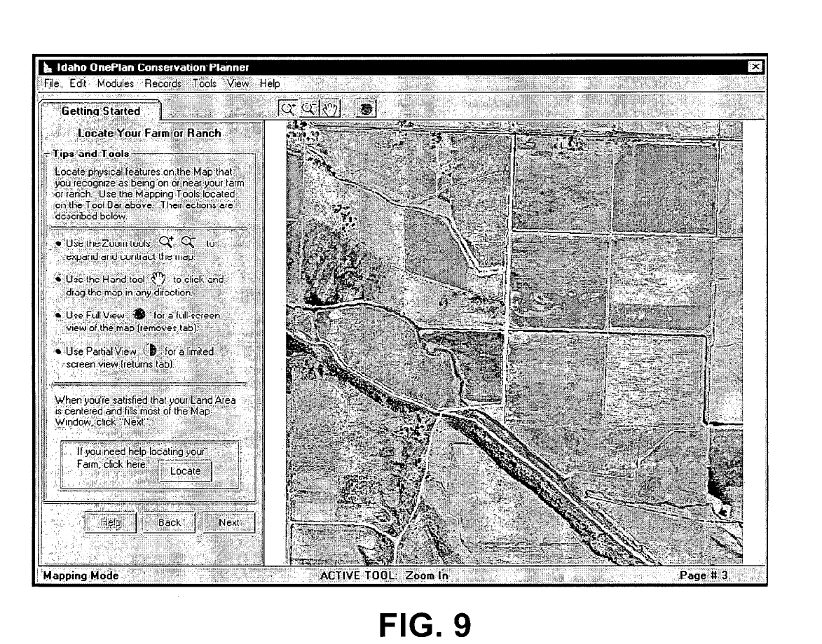

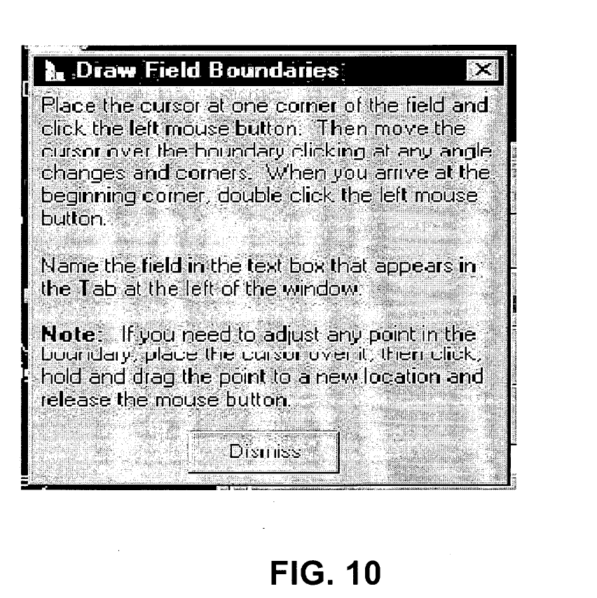

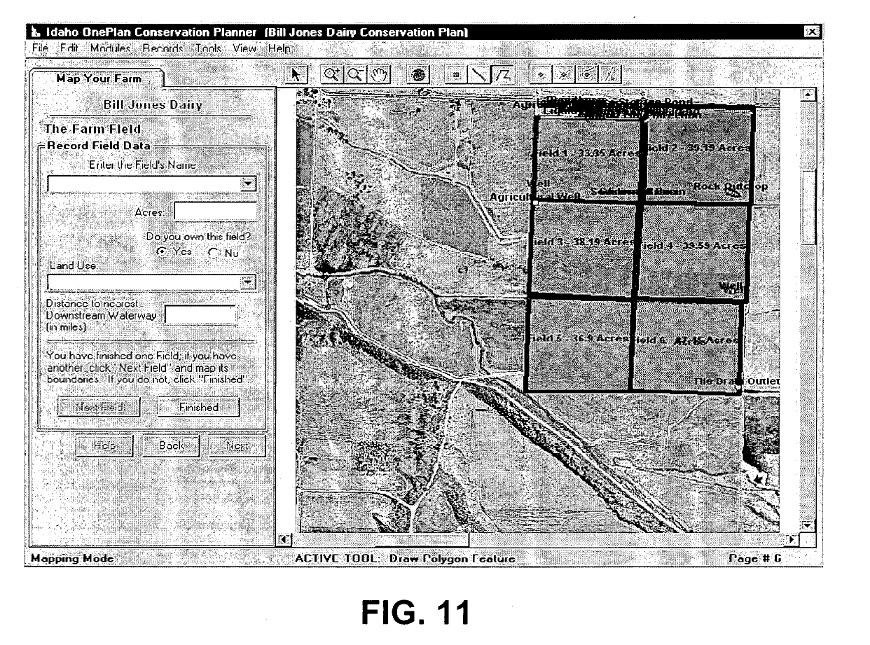

The digital image reflected in one of the GIS files downloaded from the web service is displayed to the user, as shown in the screen of FIG. 9. Next, and referring again to FIG. 4A, the farm or ranch fields or other planning units are now defined (step 188) along with site or facility specific characteristics for each planning unit (step 190). In the example illustrated in the figures, the user is prompted to outline and identify his farm fields as shown in the screens of FIGS. 10 and 11. The user is also asked to specify ownership and the current use of the land. The land area of each field is automatically calculated and reported in acres. In the screen of FIG. 11, for example, Field 1 is 33.25 acres, field 2 is 39.19 acres and so on for each field outlined and identified by the user.

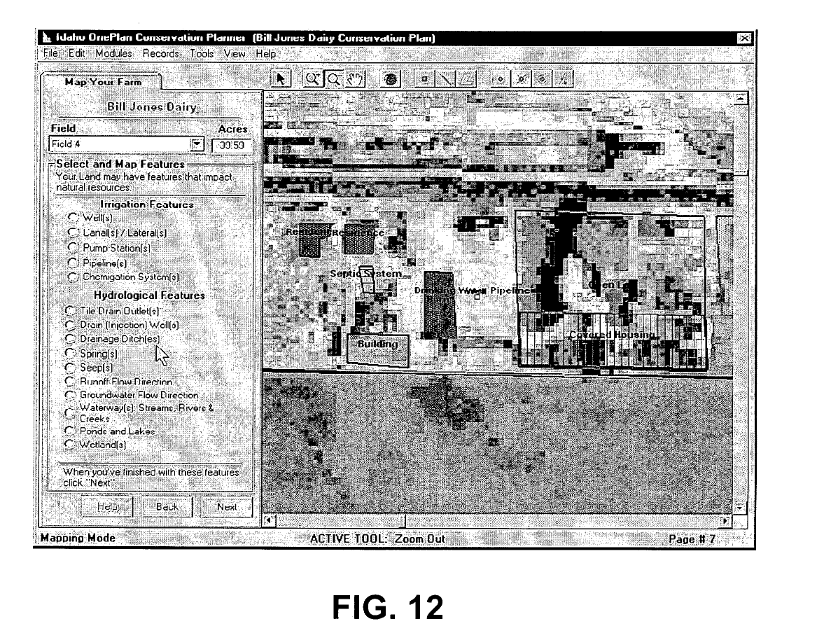

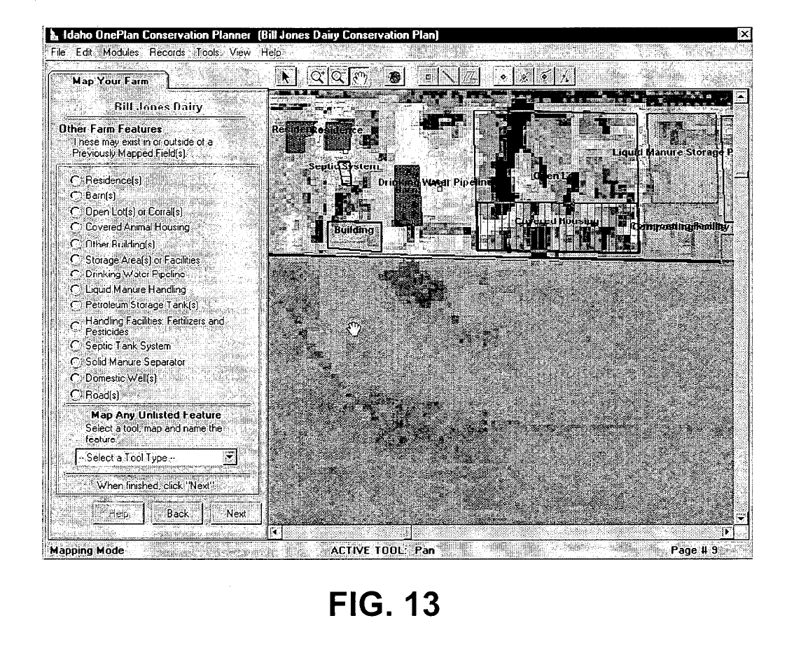

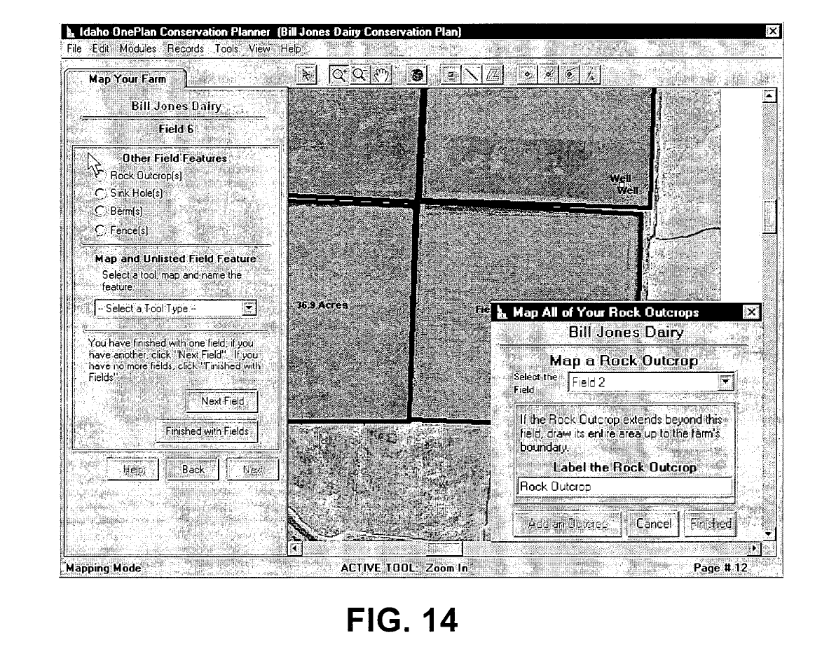

Once the fields have been outlined and identified (step 188), numerous site specific soil calculations are made using the soil geospatial coverage that will be used to characterize the planning area. The user is prompted to identify characteristics of the fields that might not be part of the geospatial data downloaded from the web service (step 190). For example, the user may identify irrigation and hydrological features as shown in the screen of FIG. 12. Irrigation features include wells, canals, pump stations, pipelines and chemigation systems. Hydrological features include drain outlets, drain wells, drainage ditches, springs, seeps, runoff flow direction, groundwater flow direction, and streams, river, ponds, lakes and other wetlands. The user is also prompted to identify farm features, as shown in the screens of FIGS. 13 and 14, including: buildings, open lots and corrals, storage areas and facilities, drinking water pipelines, liquid manure handling facilities, petroleum storage facilities, chemical handling facilities, septic systems, solid manure separators, domestic wells and roads (FIG. 13); rock outcrops, sink holes, berms and fences (FIG. 14); along with any significant site features not listed.

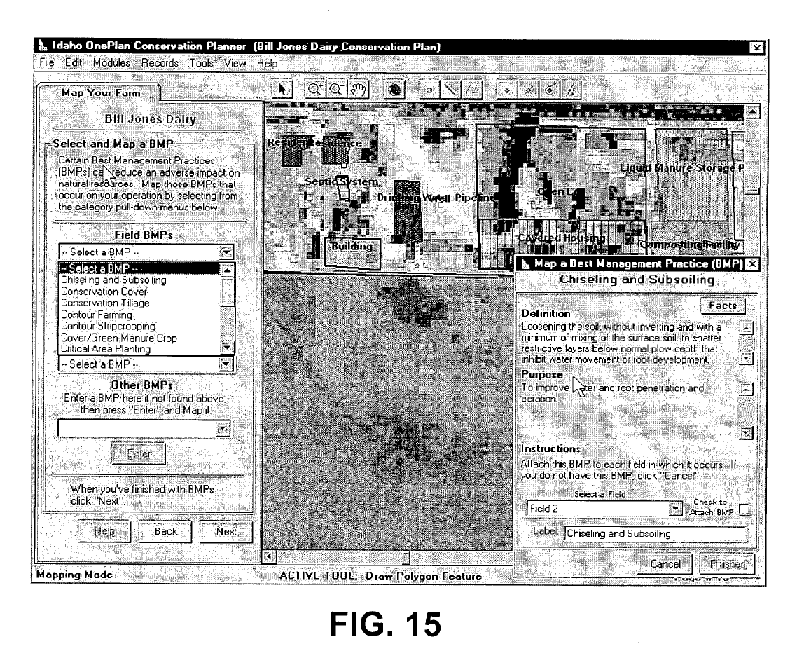

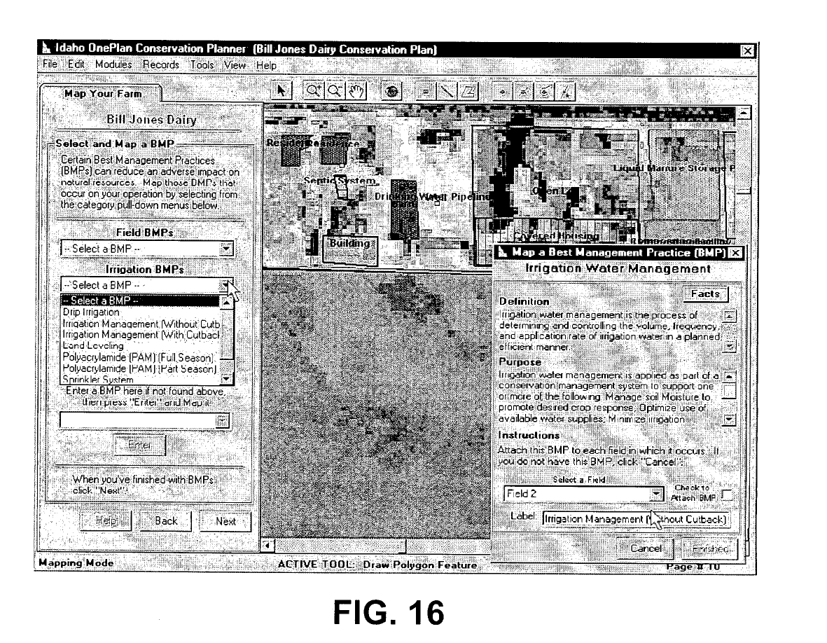

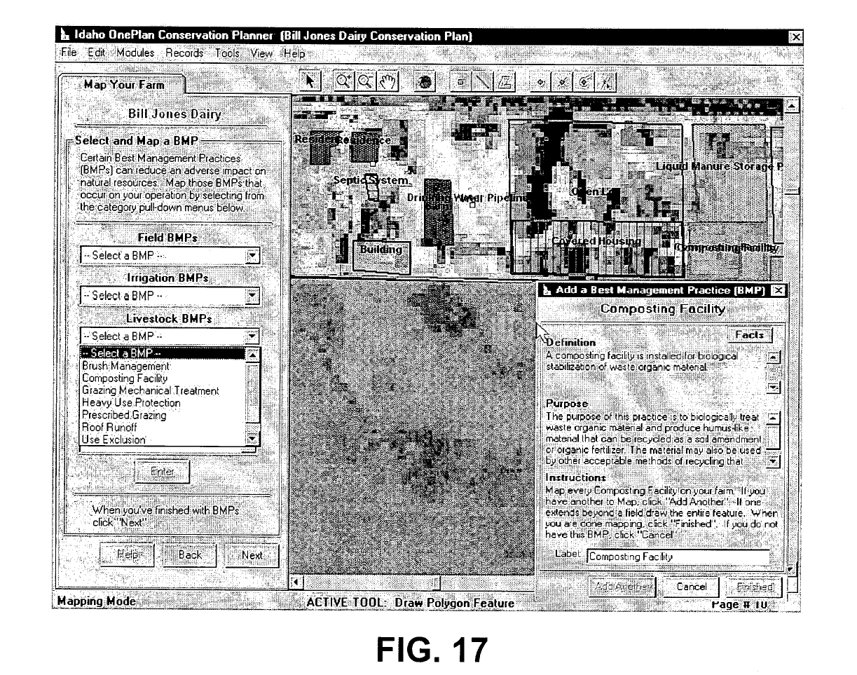

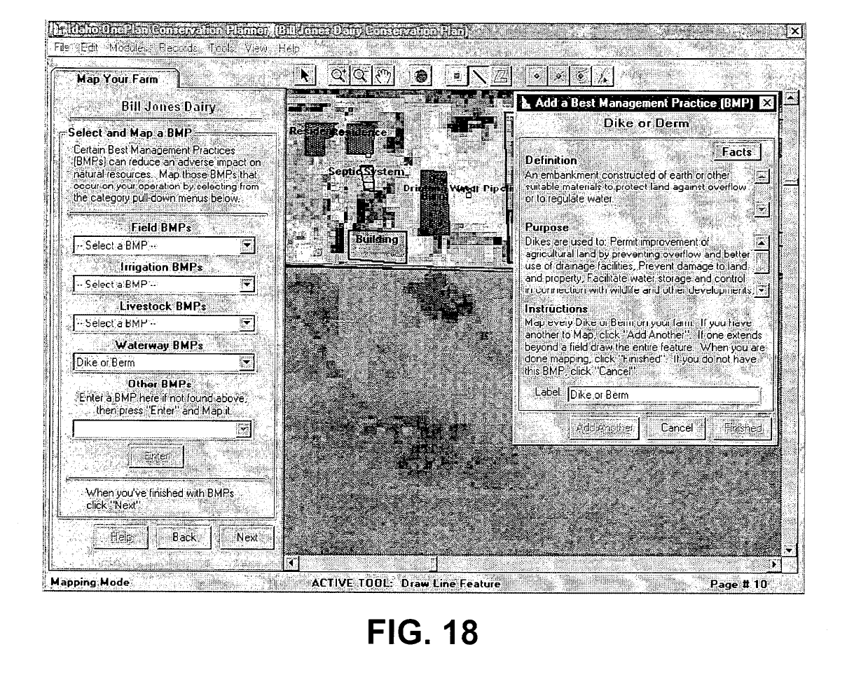

Next, the user is prompted to identify Best Management Practices (BMPs) that are already being implemented in each field or other planning unit, as illustrated in the screens of FIGS. 15-18. The user may identify these BMPs from a drop down menu of Field BMPs (FIG. 15), Irrigation BMPs (FIG. 16), Livestock BMPs (FIG. 17), Waterway BMPs (FIG. 18), and the user may identify any BMPs not listed in the drop down menus (FIGS. 15, 16 and 18).

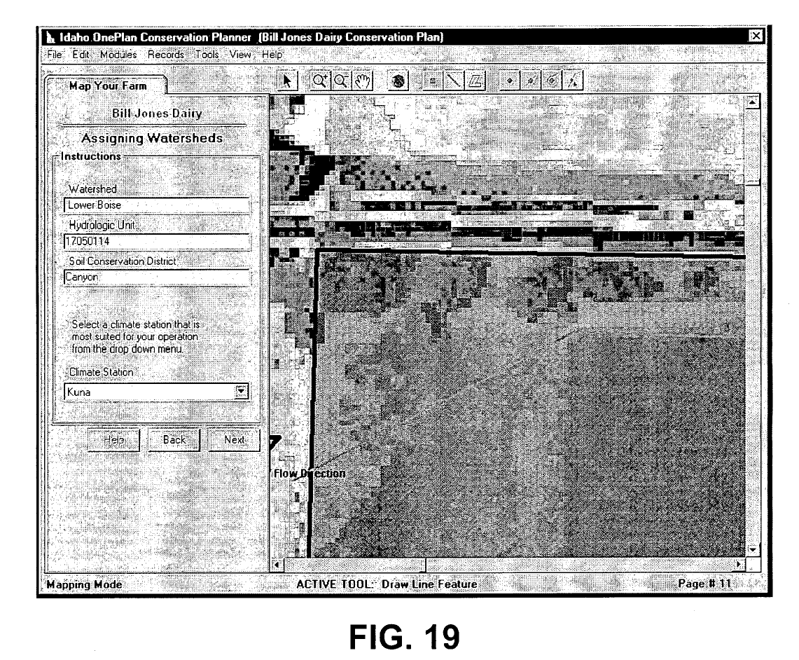

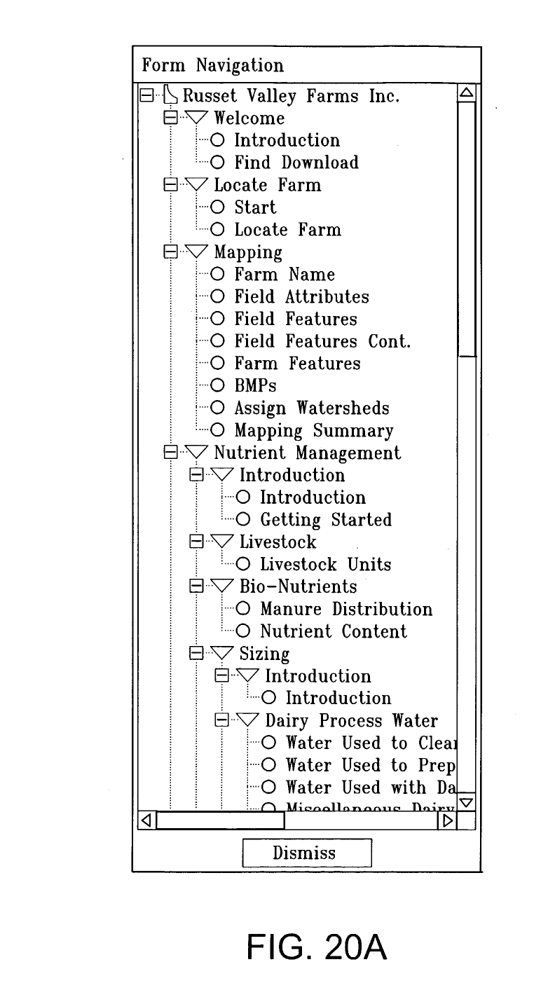

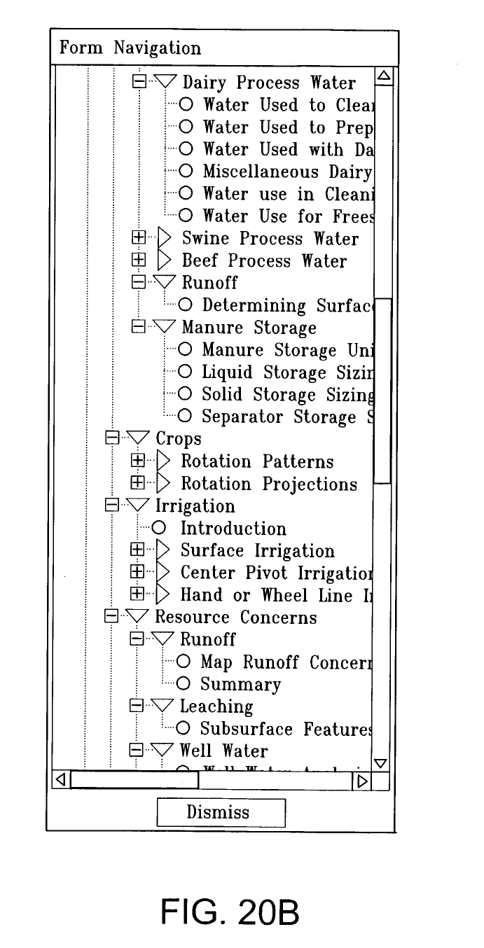

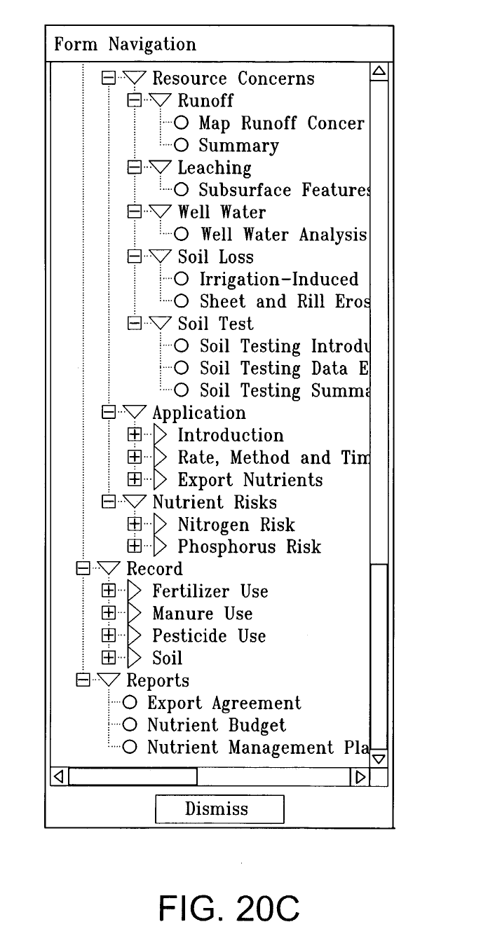

As a last step in the process of defining facility and site characteristics, the program populates watershed, hydrologic unit and Soil and Water Conservation District cells with data from GIS files downloaded from the web service, and prompts the user to identify the site climate station or a station that most closely resembles the climatic conditions at the site, all as shown in the screen of FIG. 19.

Referring again to FIG. 4A, the user is now ready to select the desired planning module (step 192). Planning modules may include, for example, conservation, nutrient management, grazing management and habitat management modules 24-30 or any other modules 32 deemed necessary or desirable for a particular area.

Web Server With Mapping And Decision Support Program. In another version, illustrated in FIG. 4B, both the mapping module 20 and the decision support module reside on a web server 23. In this version, the producer or other user initiates the planning process by browsing to web server 23 to launch the planning program—the user does not need any specialty programming loaded on his computer. The programming residing on web server 23 transfers the necessary information to the user's PC 25 and displays that information as a graphical user interface 27.

As with the first version described above with regard to FIG. 4A, once the program is initiated, the user is presented with options for locating the general area of the farm, ranch or other agricultural site, such as the four options shown in the screen of FIG. 6. The user locates the area by, for example, designating the township, range and section to locate the site, the geographical coordinates by latitude and longitude, the Zip Code, or the county, and the designated area is displayed. If the county is selected, for example, a map of the county is displayed as shown in the screen of FIG. 7. The user is prompted in this screen to click on the map near the site and then zoom in until an aerial photograph is displayed, as shown in FIG. 8. The programming automatically identifies the geospatial information associated with the imaged area (step 180 in FIG. 4B), and compiles that data into a file or group of files, preferably the GIS files described above, containing the geospatial data (step 182). The GIS files are imported into the decision support programming (step 184). Step 186 reflects the incorporation into program module 22 of process requirements necessary to produce a plan that addresses applicable regulatory requirements. These process requirements were determined by the design teams in step 112 of the overall program development methodology illustrated in FIG. 1.

The digital image reflected in one of the GIS files imported into the program is displayed to the user, as shown in the screen of FIG. 9. Next, and referring again to FIG. 4B, the farm or ranch fields or other planning units are now defined (step 188) along with site or facility specific characteristics for each planning unit (step 190). In the example illustrated in the figures, the user is prompted to outline and identify his farm fields as shown in the screens of FIGS. 10 and 11. The user is also asked to specify ownership and the current use of the land. The land area of each field is automatically calculated and reported in acres. In the screen of FIG. 11, for example, Field 1 is 33.25 acres, field 2 is 39.19 acres and so on for each field outlined and identified by the user.

Once the fields have been outlined and identified, numerous site specific soil calculations are made using the soil geospatial coverage that will be used to characterize the planning area. The user is prompted to identify characteristics of the fields that might not be part of the geospatial data imported into the program. For example, the user may identify irrigation and hydrological features as shown in the screen of FIG. 12. The user is also prompted to identify farm features, as shown in the screens of FIGS. 13 and 14, including: buildings, open lots and corrals, storage areas and facilities, drinking water pipelines, liquid manure handling facilities, petroleum storage facilities, chemical handling facilities, septic systems, solid manure separators, domestic wells and roads (FIG. 13); rock outcrops, sink holes, berms and fences (FIG. 14); along with any significant site features not listed.

Next, the user is prompted to identify Best Management Practices (BMPs) that are already being implemented in each field or other planning unit, as illustrated in the screens of FIGS. 15-18. The user may identify these BMPs from a drop down menu of Field BMPs (FIG. 15), Irrigation BMPs (FIG. 16), Livestock BMPs (FIG. 17), Waterway BMPs (FIG. 18), and the user may identify any BMPs not listed in the drop down menus (FIGS. 15, 16 and 18).

As a last step in the process of defining facility and site characteristics, the program populates watershed, hydrologic unit and Soil and Water Conservation District cells with data from GIS files downloaded from the web service, and prompts the user to identify the site climate station or a station that most closely resembles the climatic conditions at the site, all as shown in the screen of FIG. 19.

In the version of the decision support program shown in FIG. 4B, the conservation planning module 24 is implemented to determine whether or not other planning modules are necessary or desirable. Hence, conservation planning module 24 is implemented after individual facility and site characteristics are defined in step 190. Conservation plans identify resource problems for farm, ranch, dairy and other agricultural operations, specify conservation practices that when implemented are expected to solve those problems, and establish a schedule for implementing the conservation practices. Once a conservation plan is developed through conservation module 24, nutrient management and/or conservation practices may be selected (step 192) and plans developed through management planning modules 26-32.

Conservation Module. Conservation plans identify resource problems for farm, ranch, dairy and other agricultural operations, specify conservation practices that when implemented are expected to solve those problems, and establish a schedule for implementing the conservation practices. In the past, a complex and laborious but thorough process was used by professional agency planners to develop comprehensive conservation plans that address soil, water, air, plant and animal resource concerns. About 1,630 plans were developed for agricultural operations in Idaho between 1997 and 2001. As part of the planning process, a resource inventory covering more than 70 potential resource concerns was completed and various assessment procedures are used to identify resource problems under the minimum criteria established by the Quality Criteria in Section III of the NRCS Field Office Technical Guide. For example, the Quality Criteria establishes that sheet and rill erosion must be estimated using the Revised Universal Soil Loss Equation (RUSLE) and it must be at or below the Tolerable Soil Loss. If the erosion estimate made during the planning process is greater than the Tolerable Soil Loss, then sheet and rill erosion is identified as a resource problem in the conservation plan. Conservation practices that reduce sheet and rill erosion to the Tolerable Soil Loss or less are identified and the effects of these practices evaluated using RUSLE. Assembling the farm data, filling in numerous forms and making numerous calculations manually takes a lot of time.

This existing conservation planning process also led to the development of Guidance Document Templates. The Guidance Document Templates characterize typical landscape settings with resource problems and the conservation practices (sometimes also called Best Management Practices) that may be used to correct resource problems identified with that landscape. Each Template is supported by a great deal of information compiled over the last 70 years and a high degree of technical expertise brought to bear on this information by agency planners, researchers and scientists. Although use of the Guidance Document Templates has helped streamline the existing conservation planning process, this process is still not widely used and is not made readily accessible to producers and landowners. Depending upon the complexity of the operation, each conservation plan requires 80-120 man hours. Once a conservation plan is developed, individual conservation practices may require substantial additional time. In Idaho, nutrient management is a required conservation practice for all conservation plans for operations in which nutrients are being applied. Again, depending upon the complexity of the operation, a nutrient management plan can require an addition 40-80 hours. There are over 20,000 agricultural operations in Idaho. The cost in man hours to complete plans for the operations in Idaho alone would be staggering.

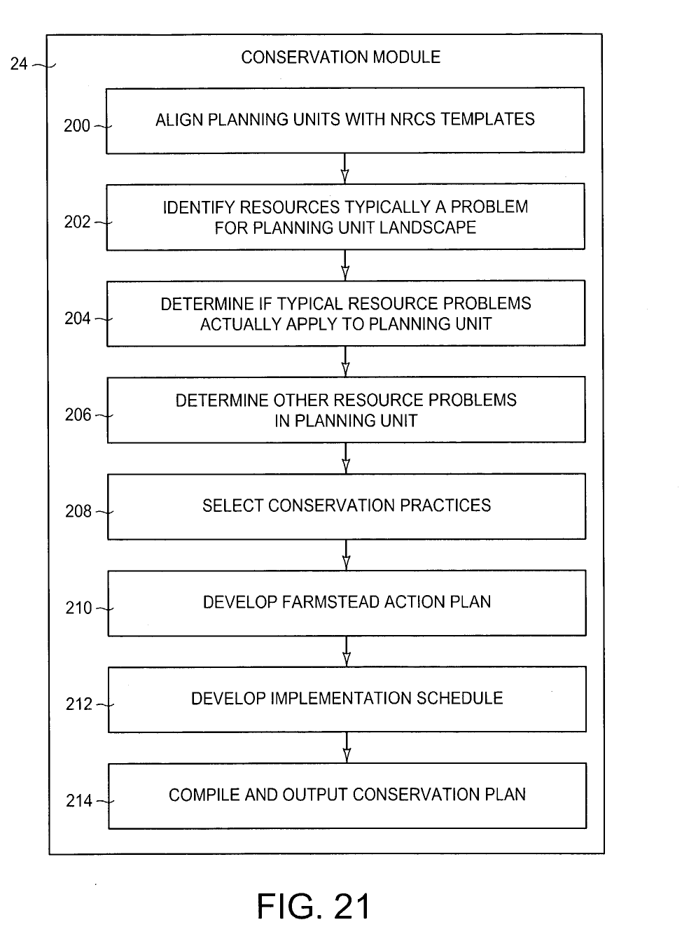

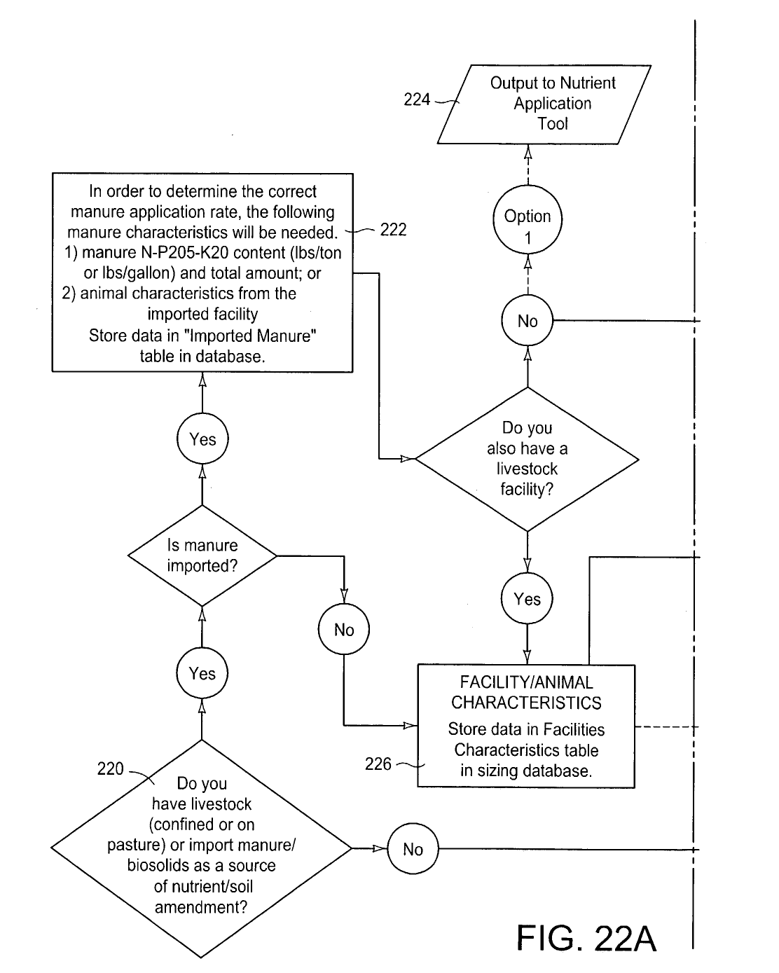

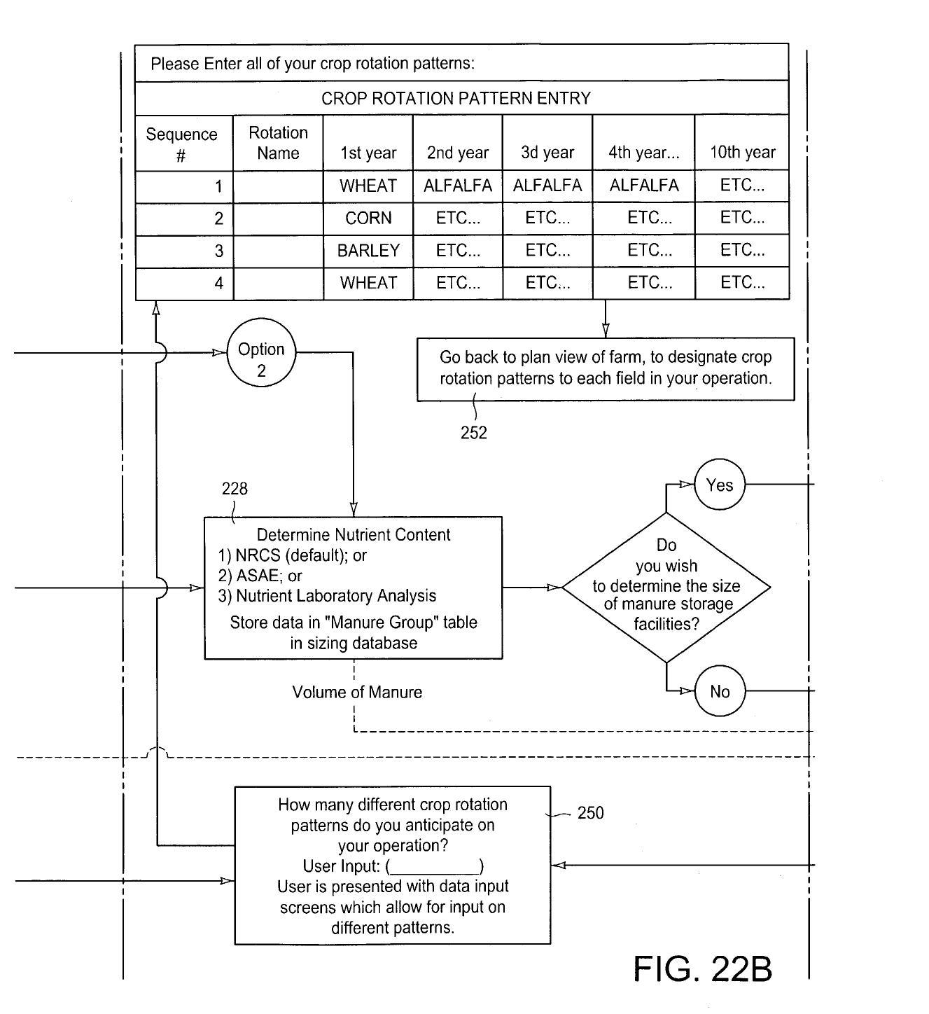

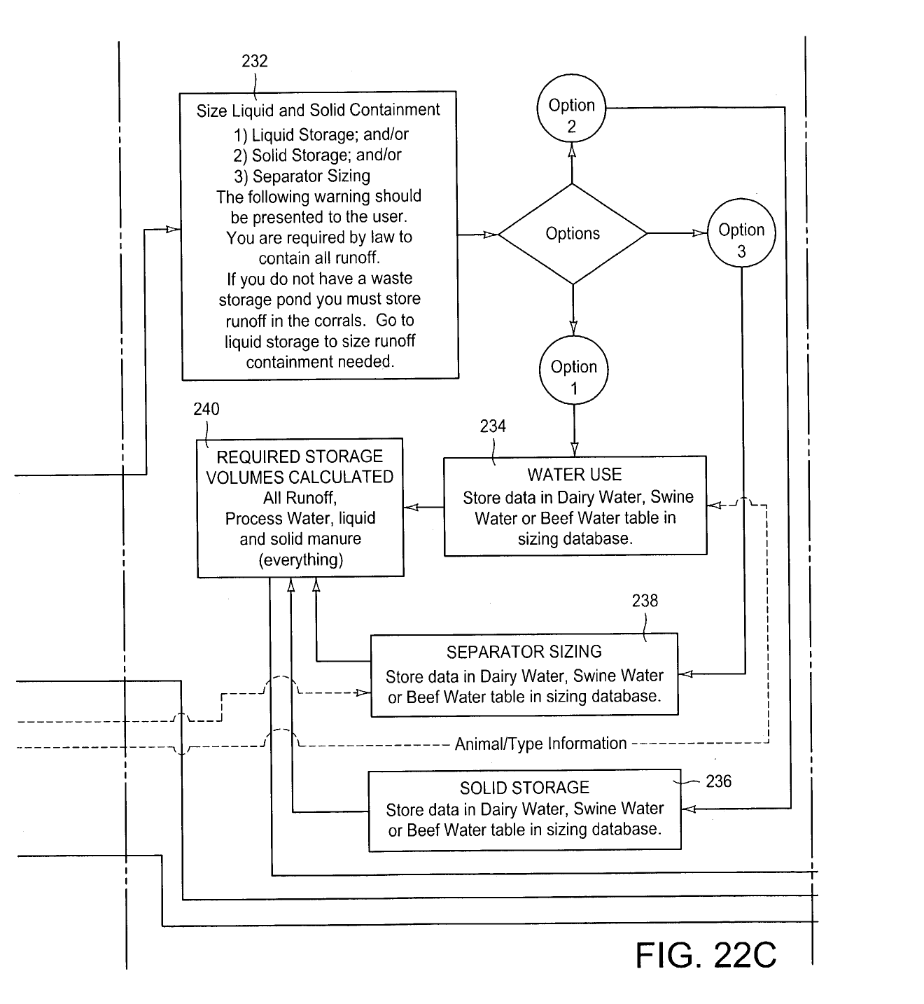

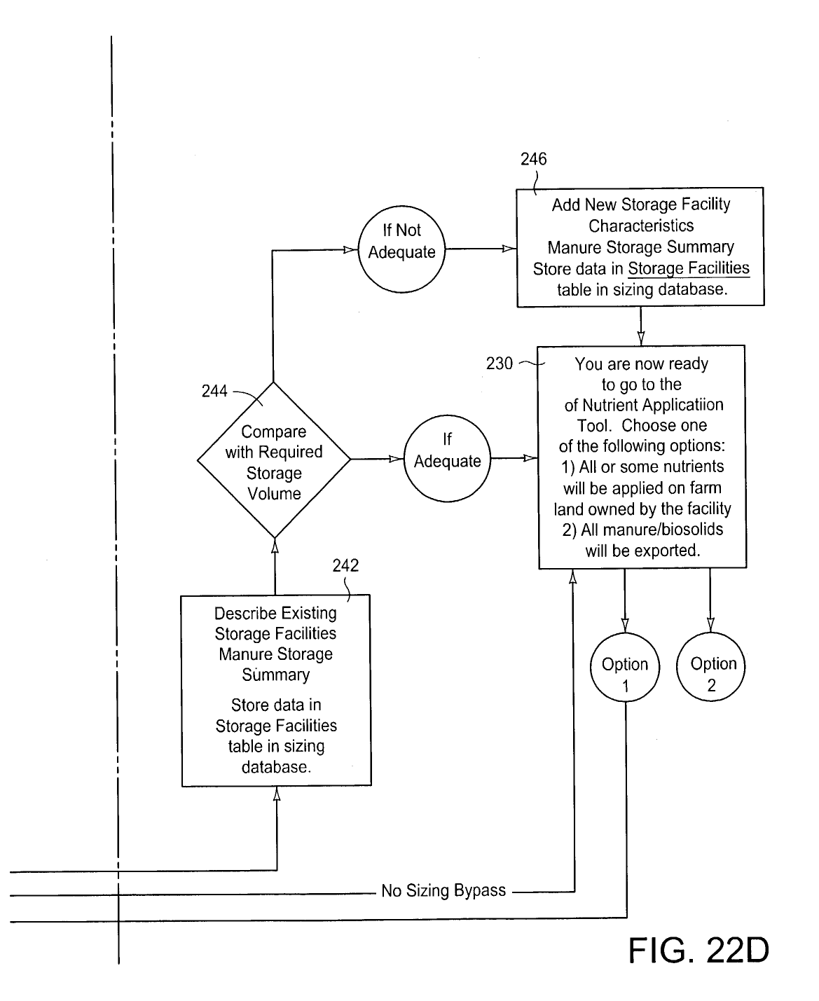

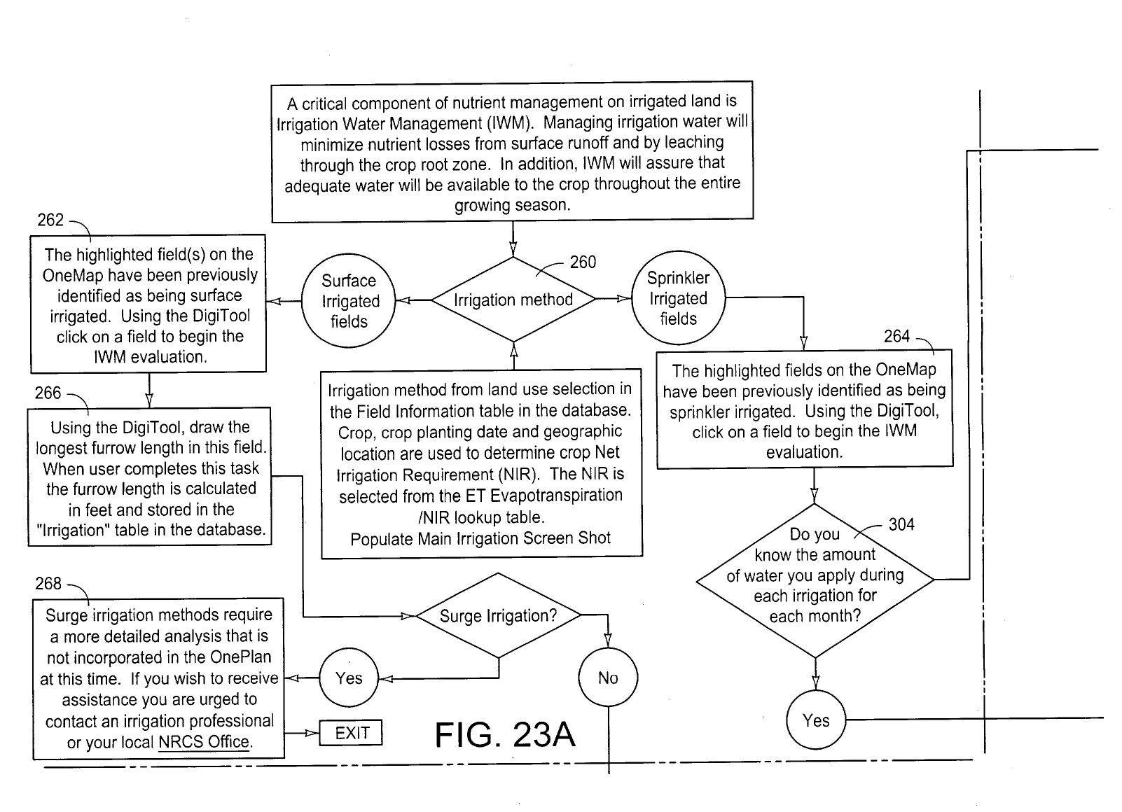

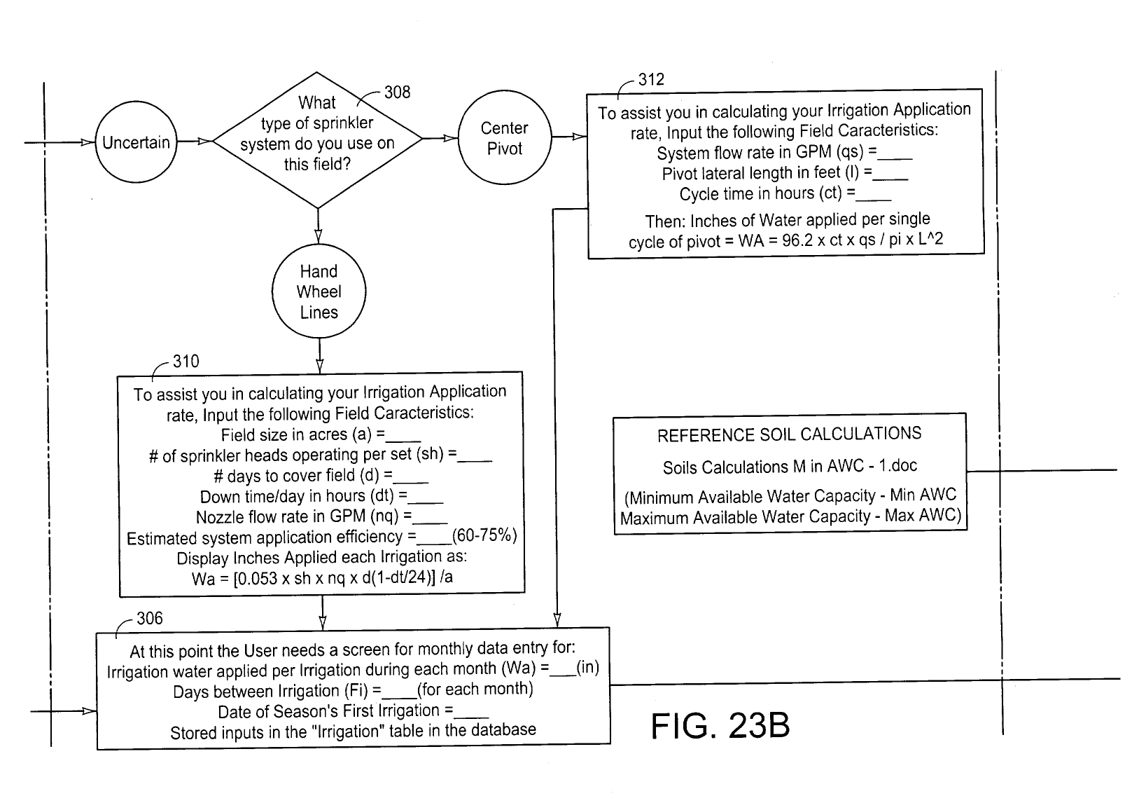

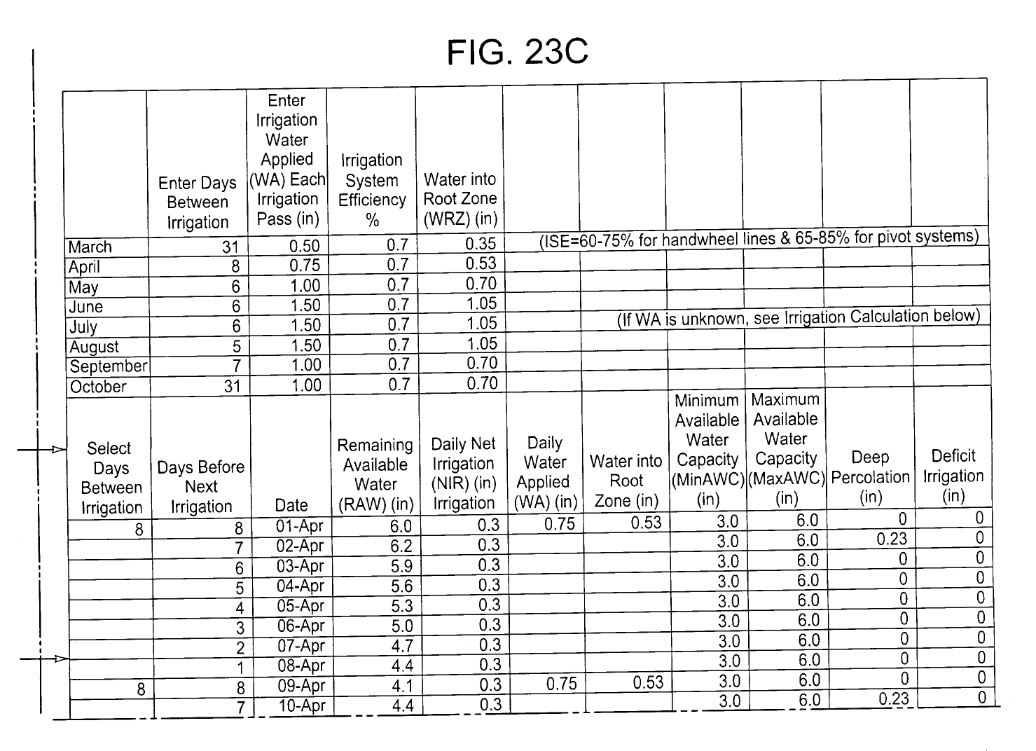

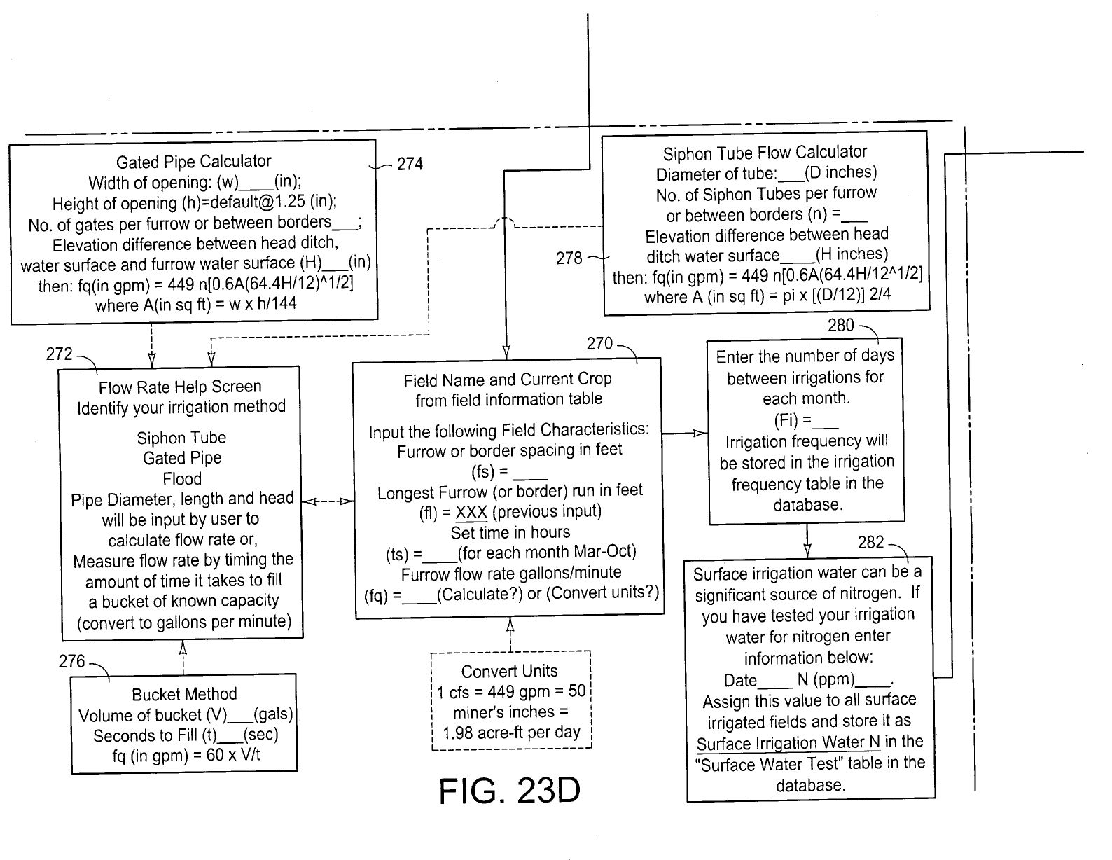

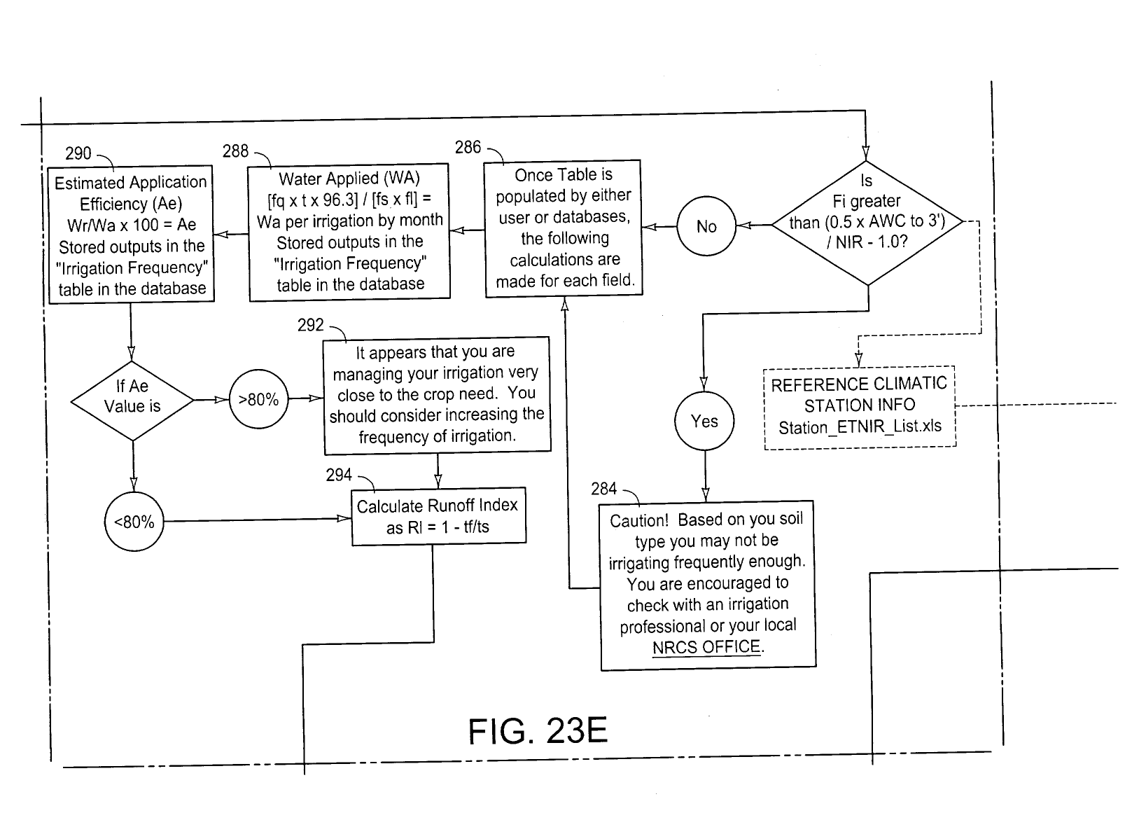

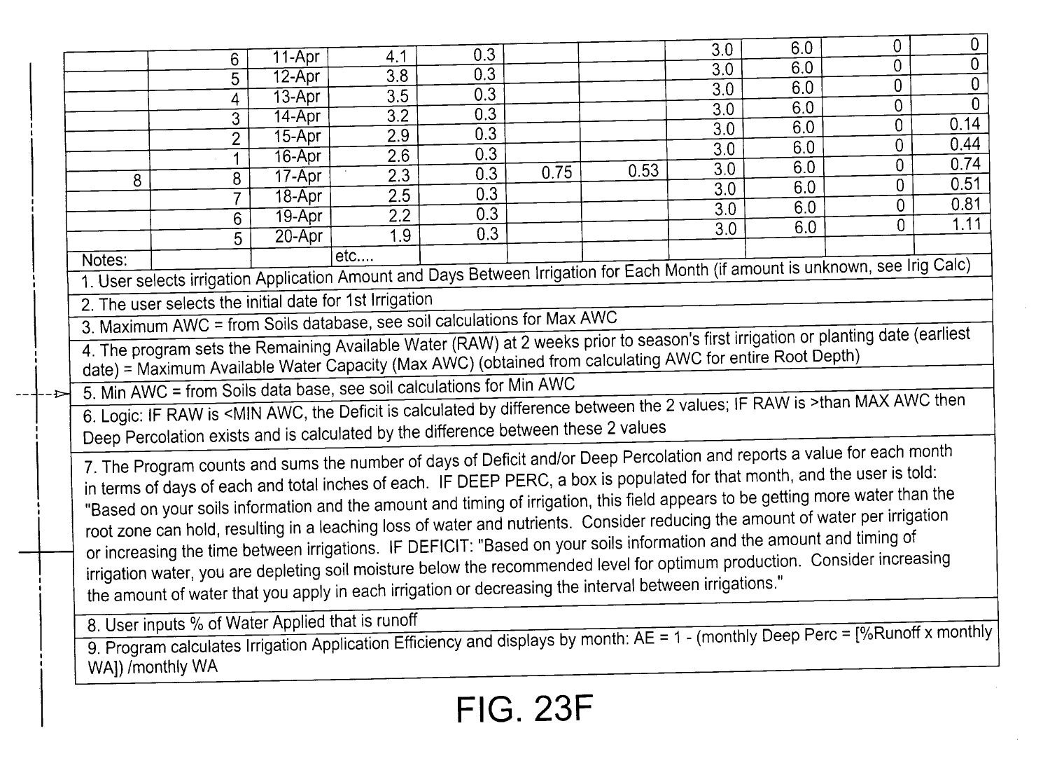

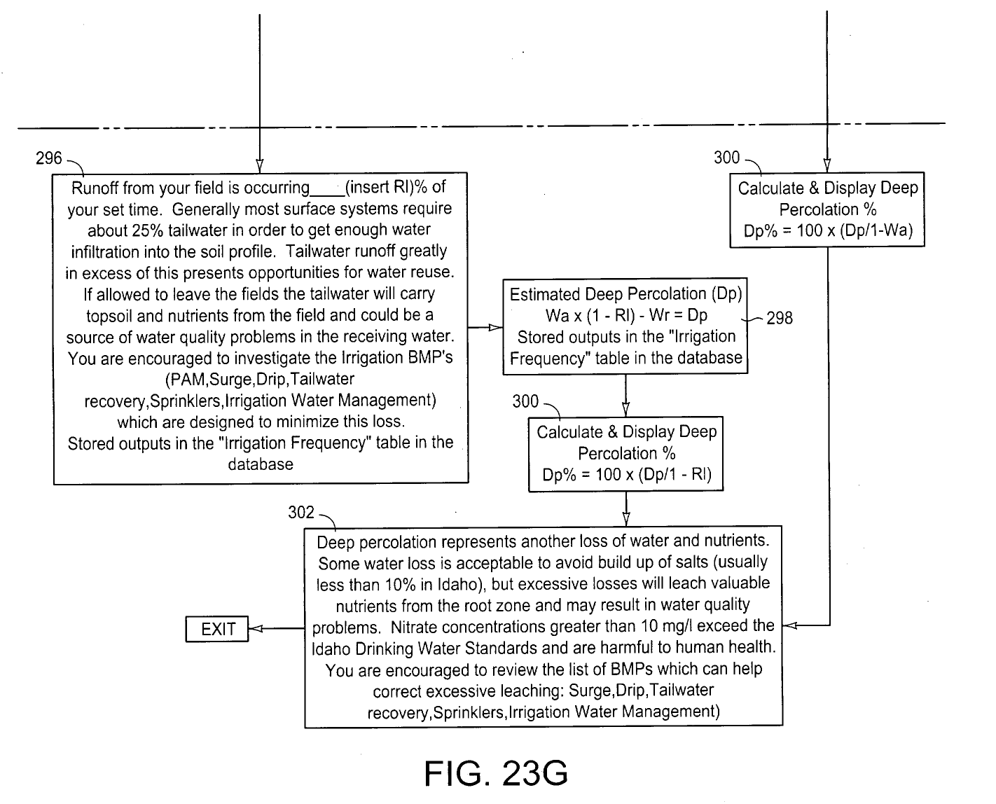

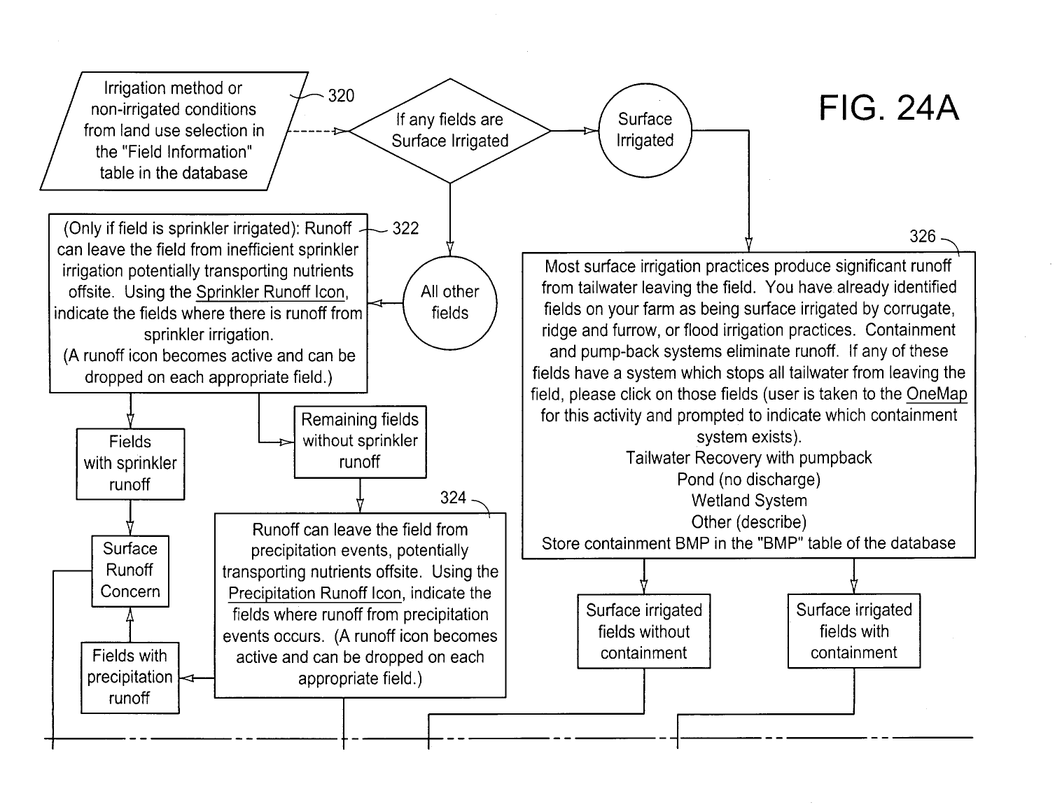

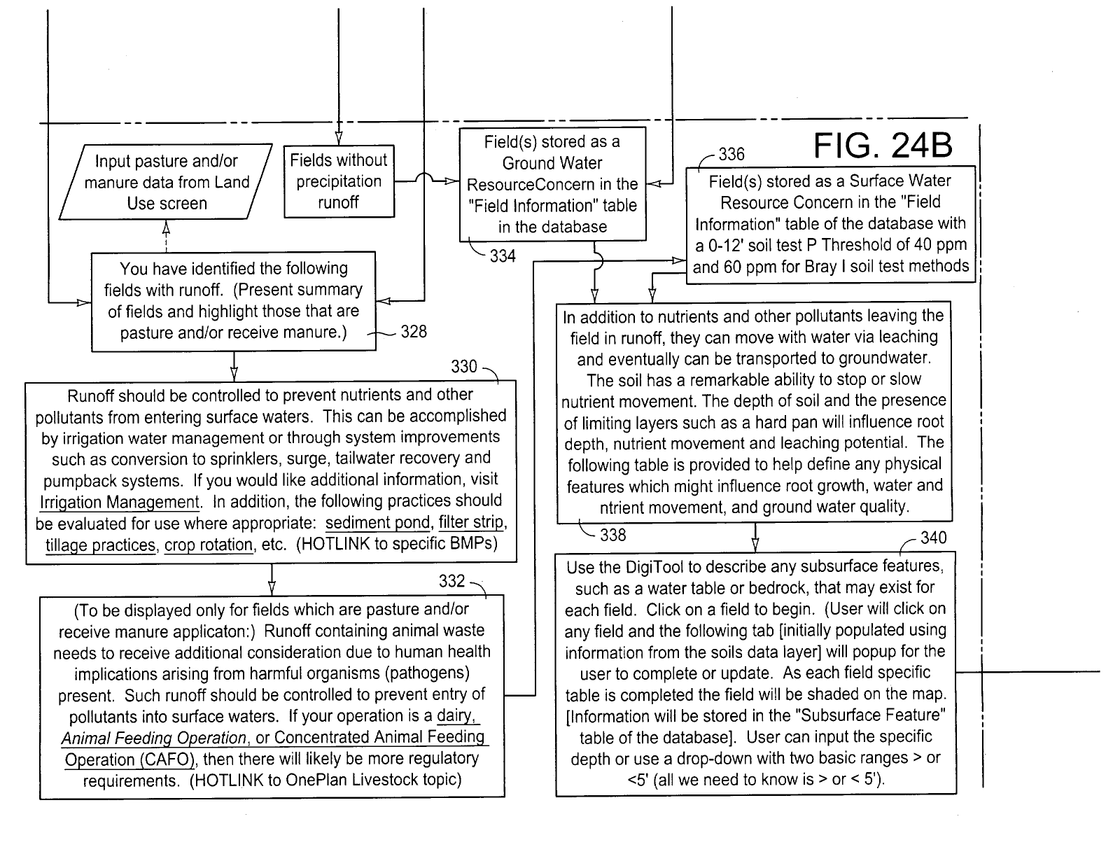

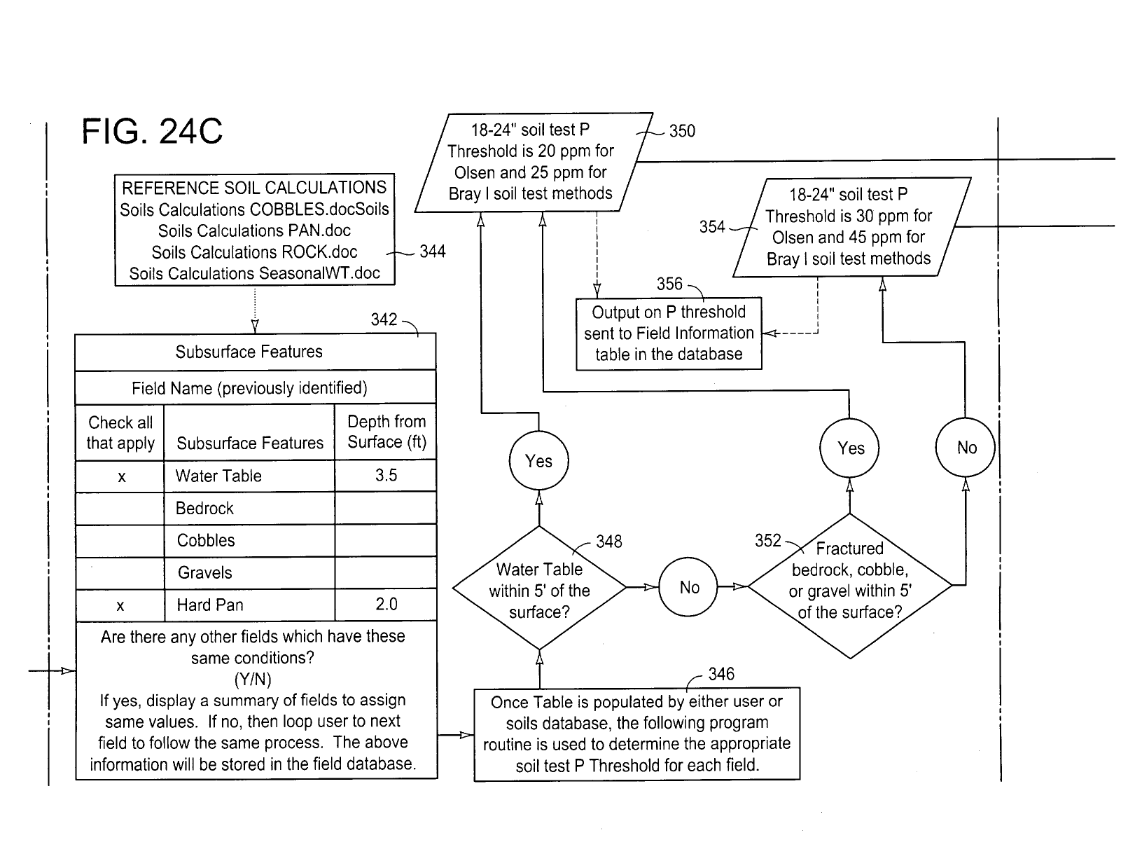

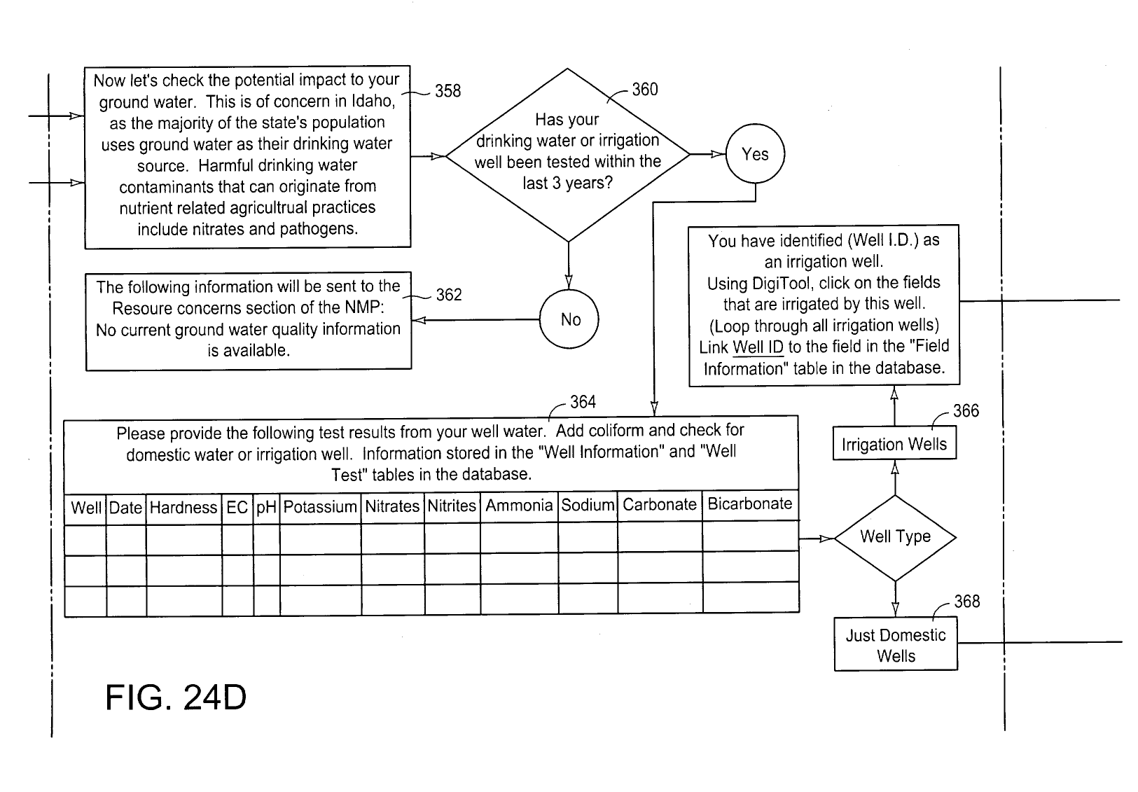

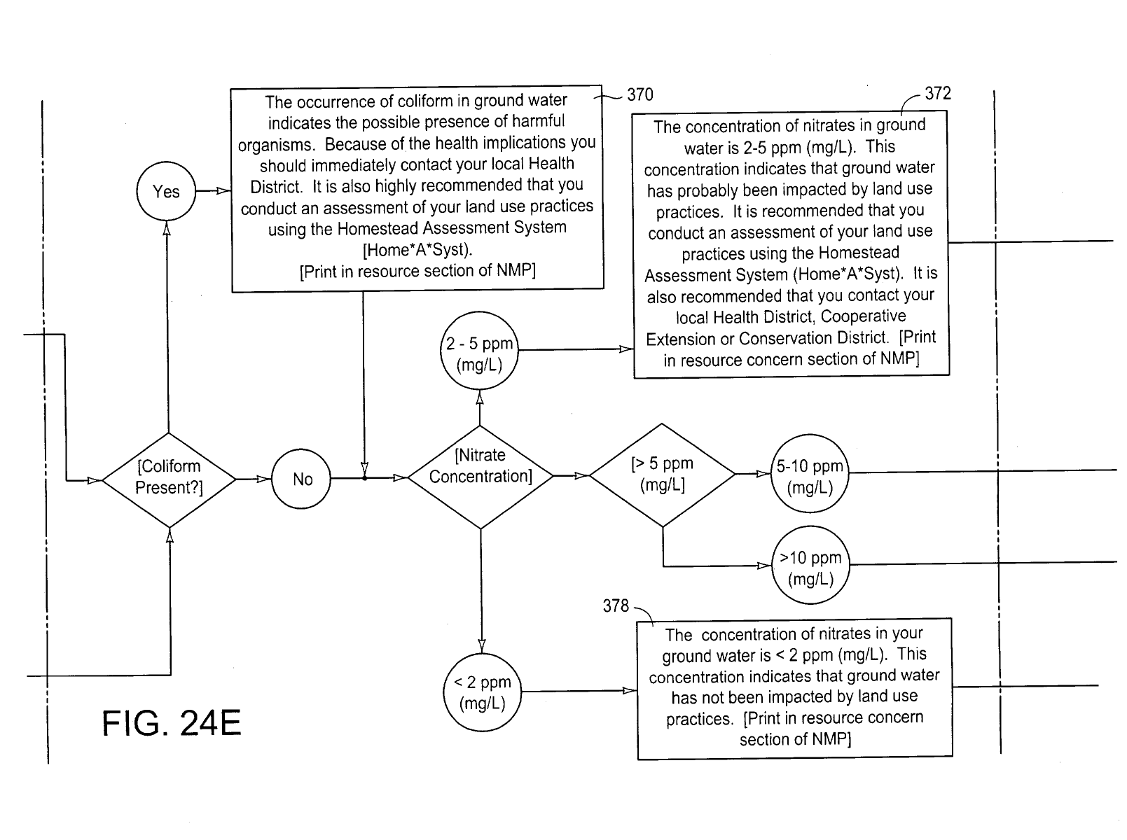

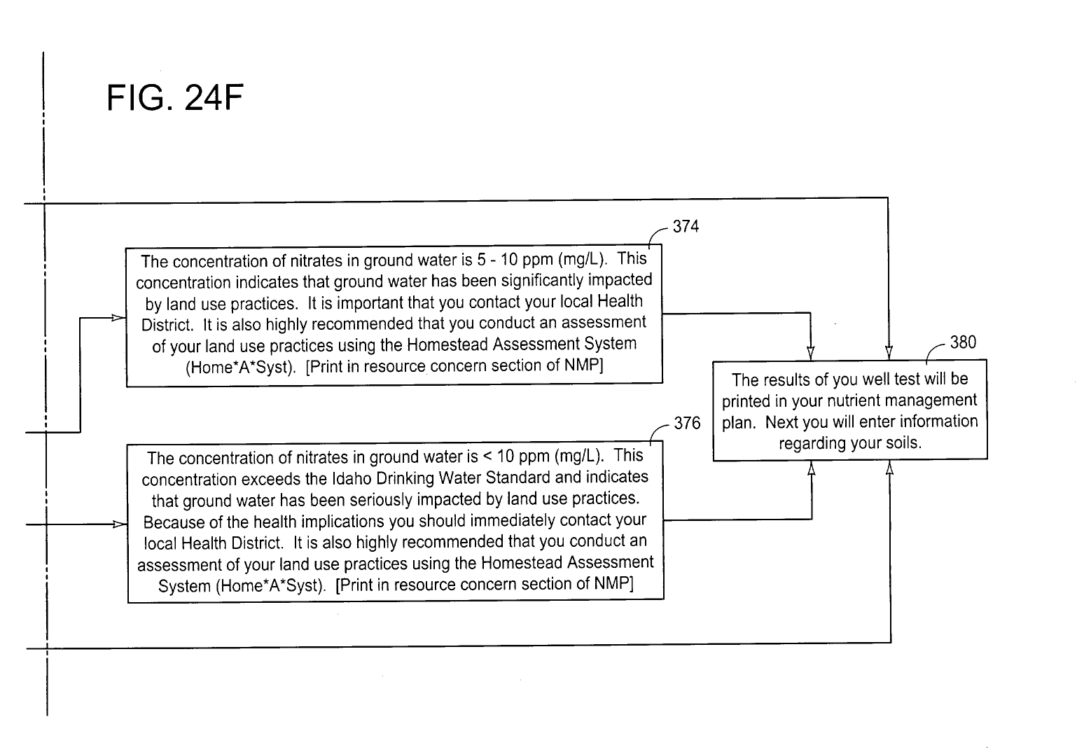

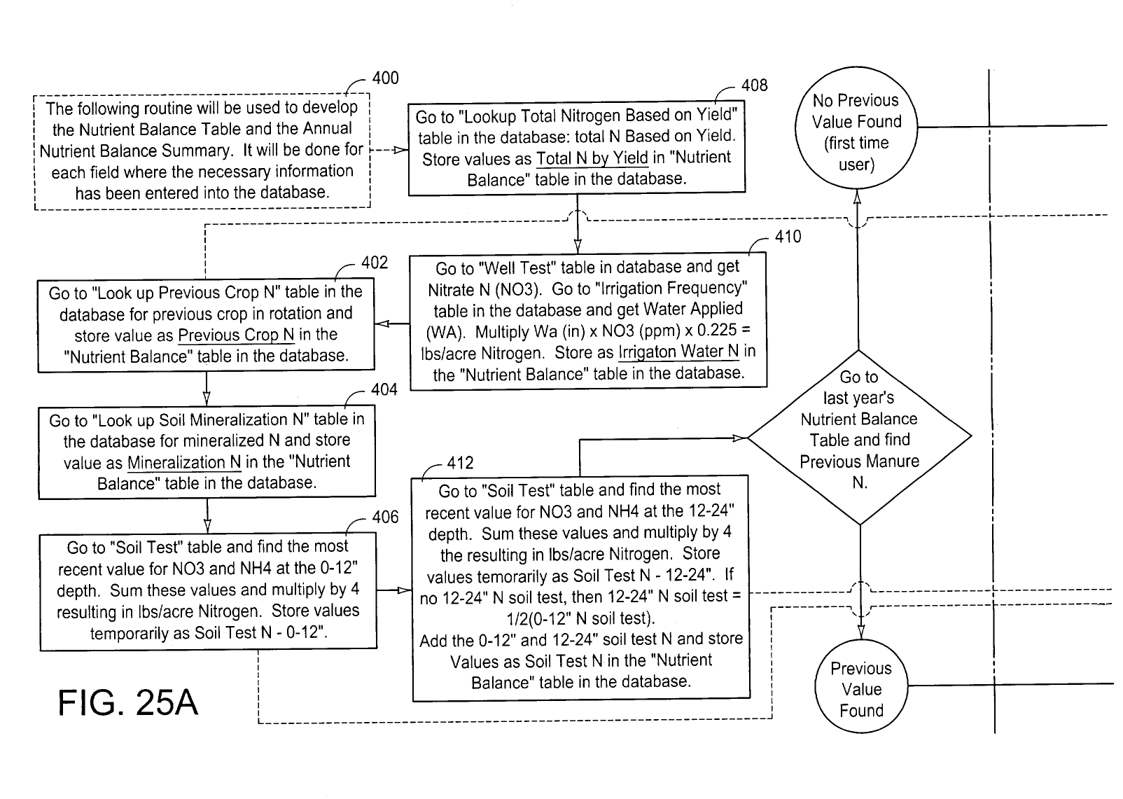

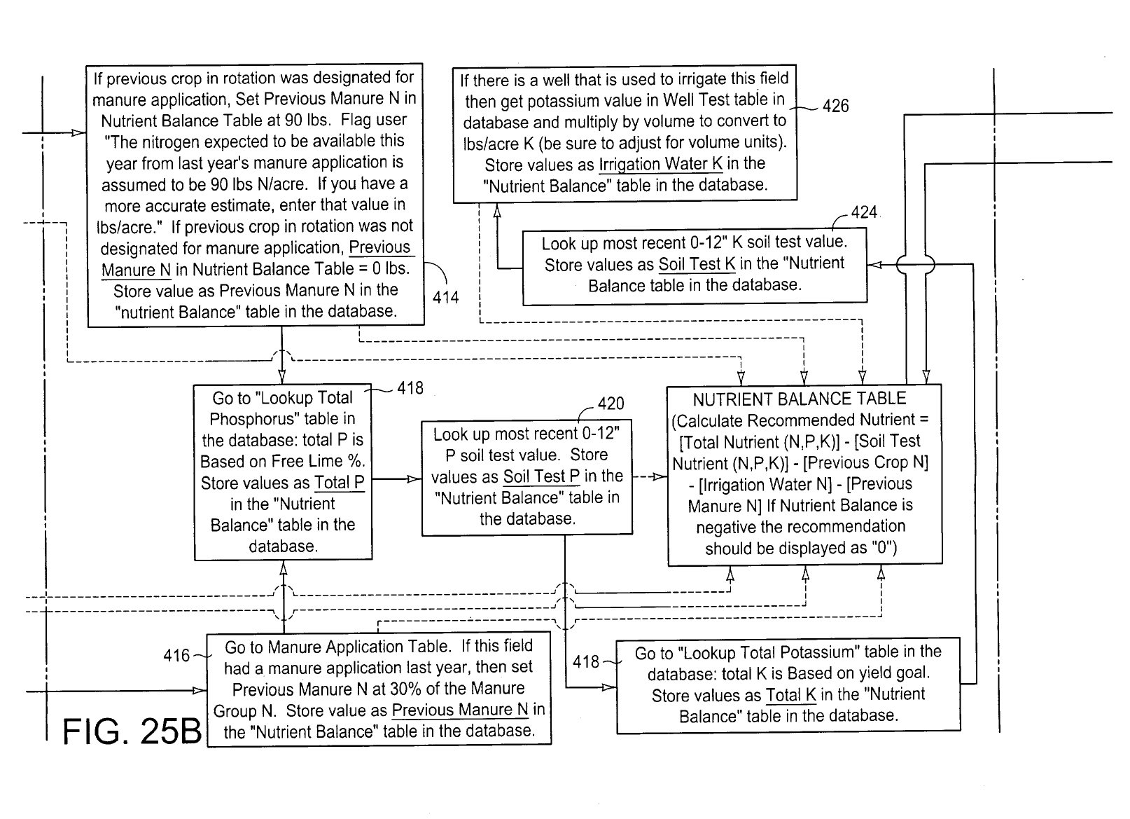

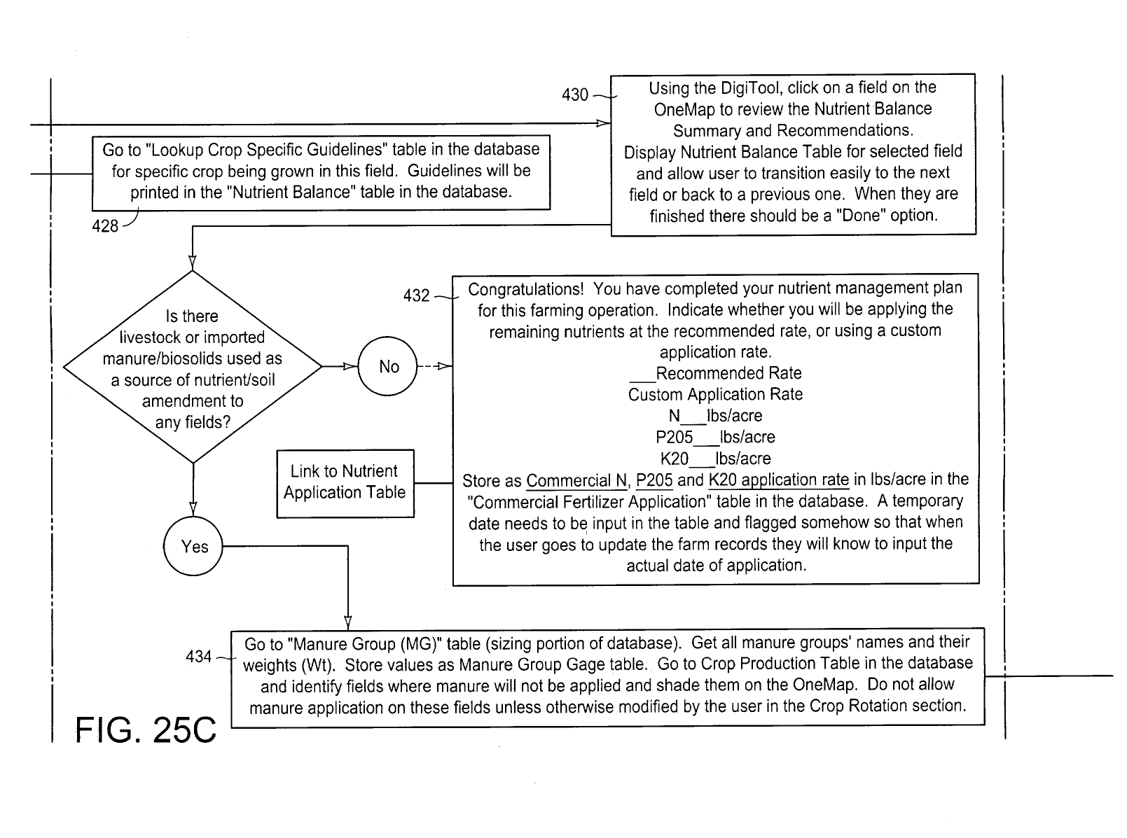

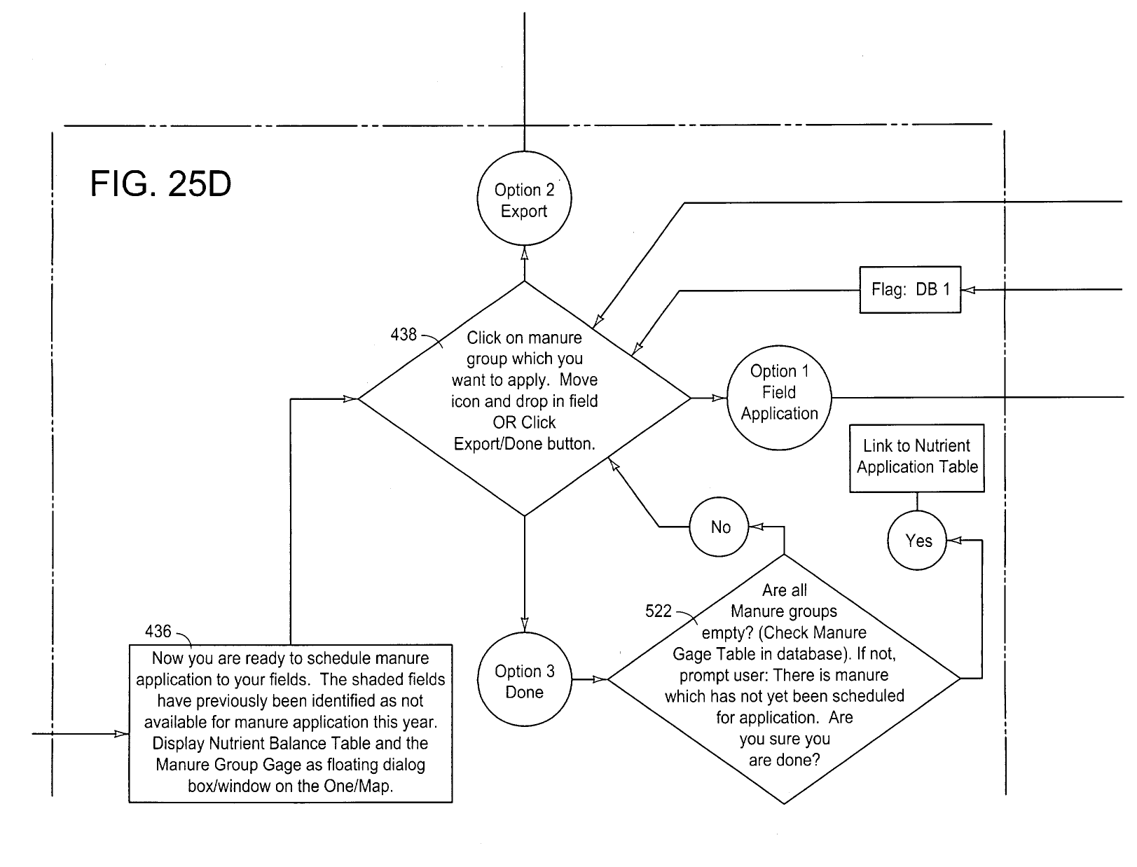

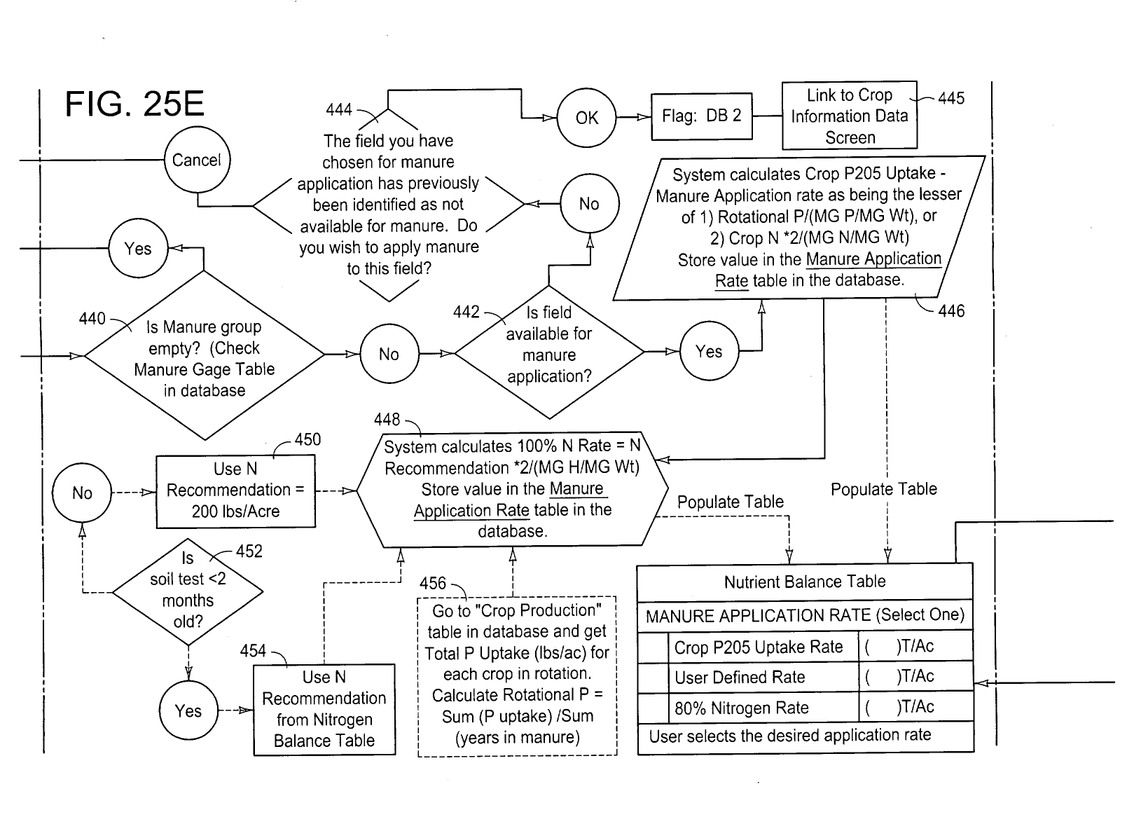

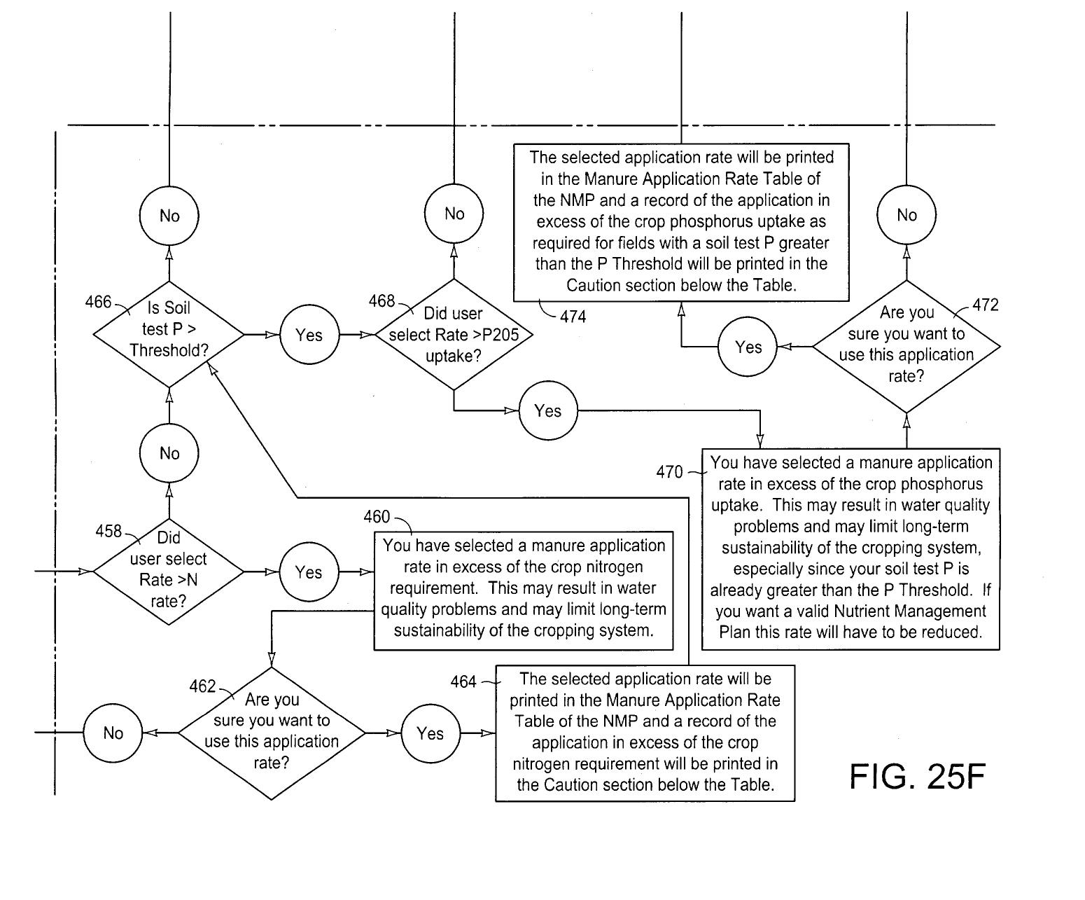

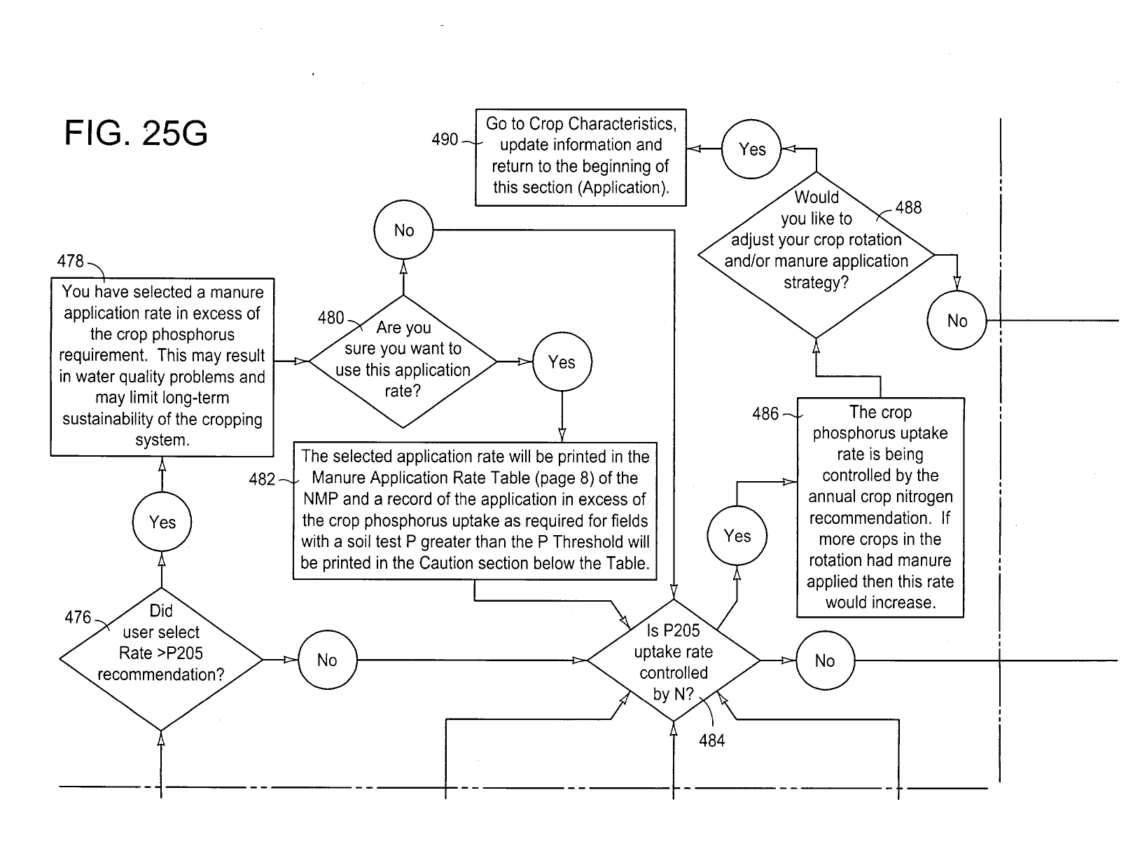

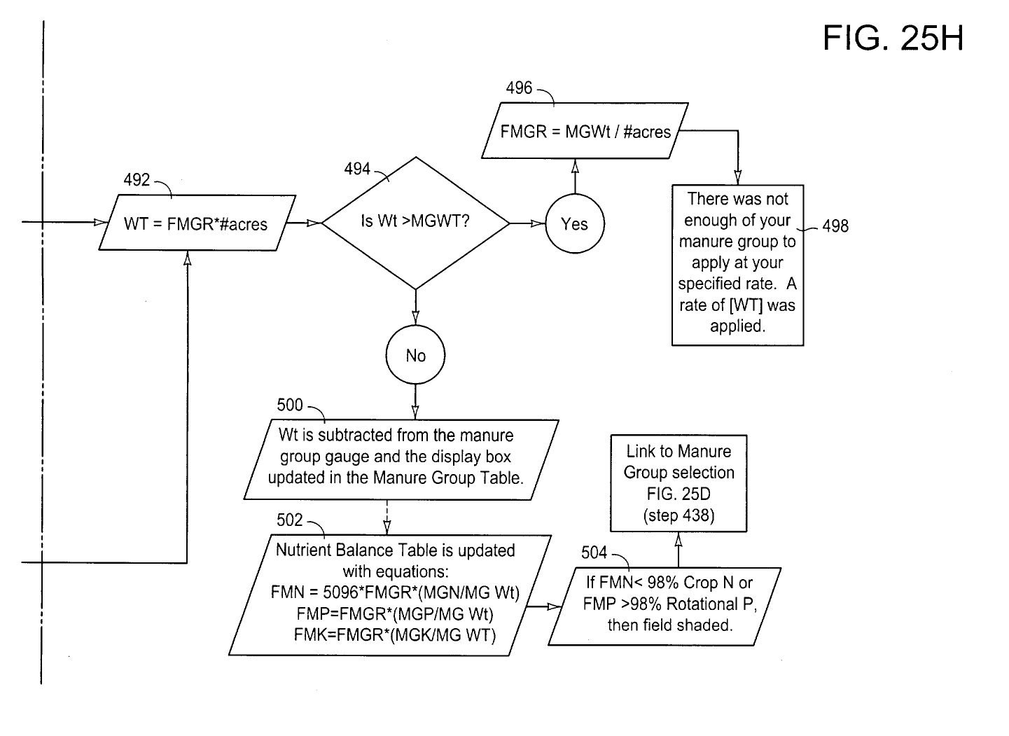

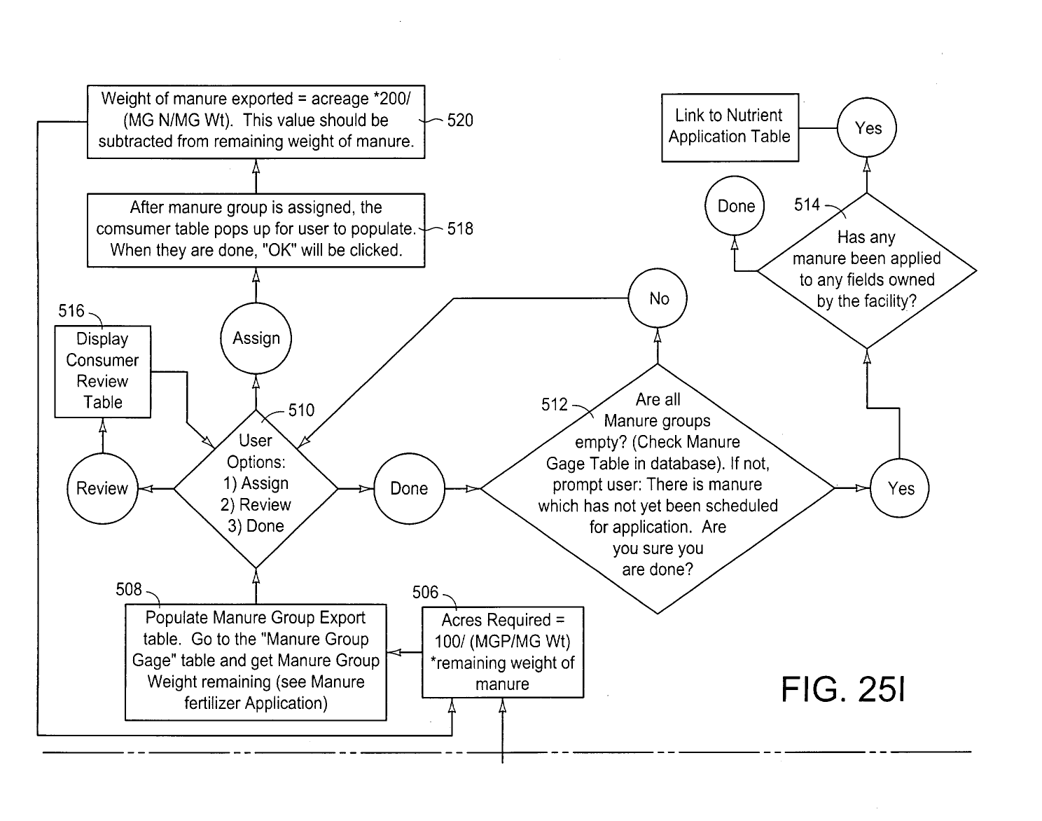

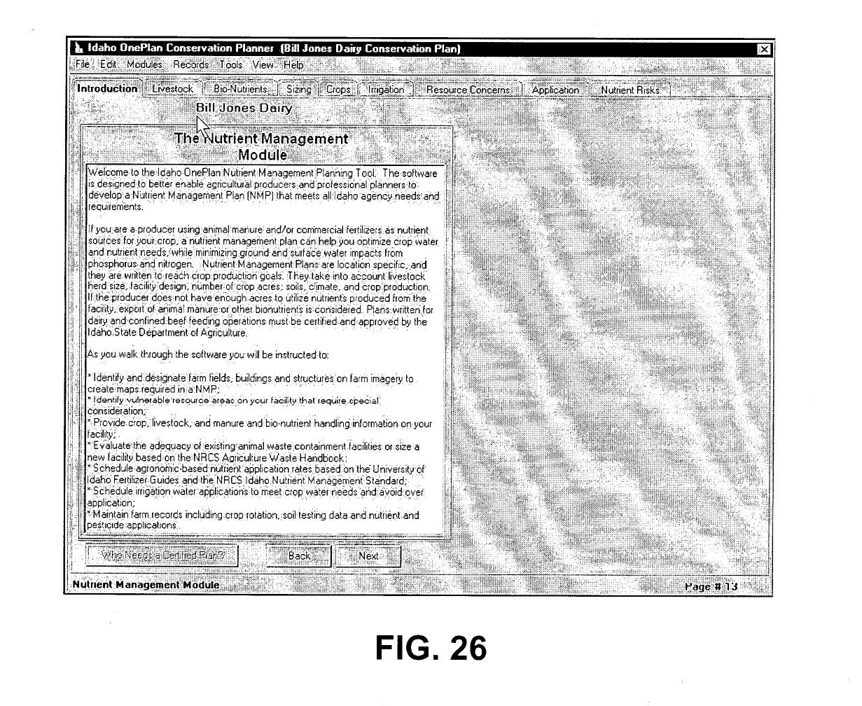

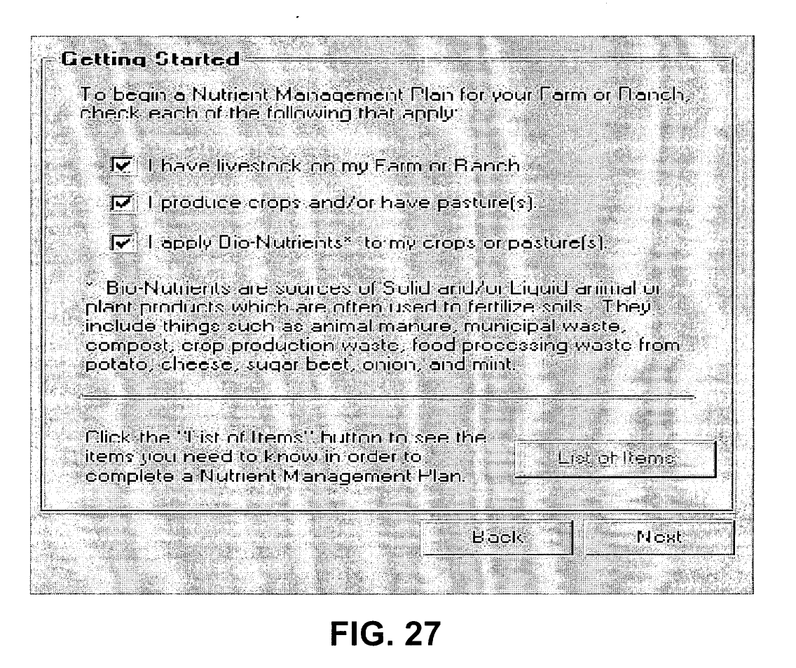

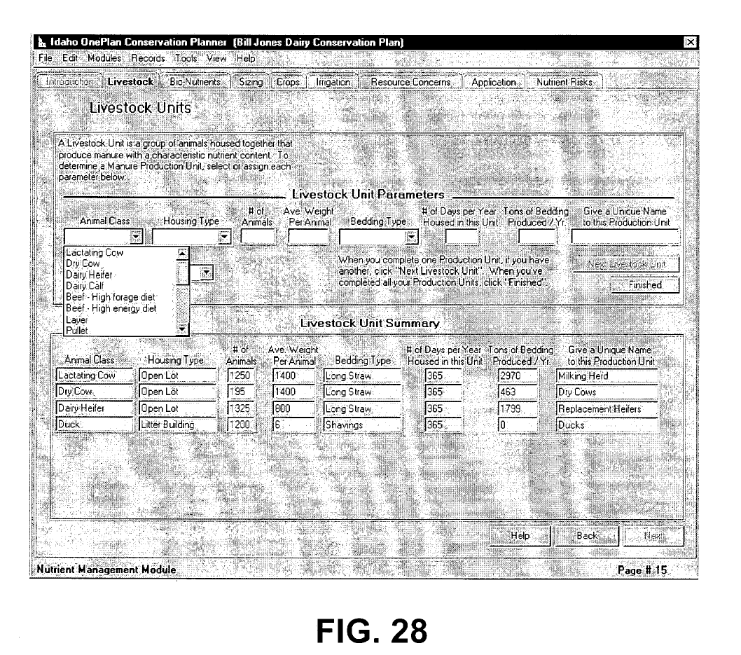

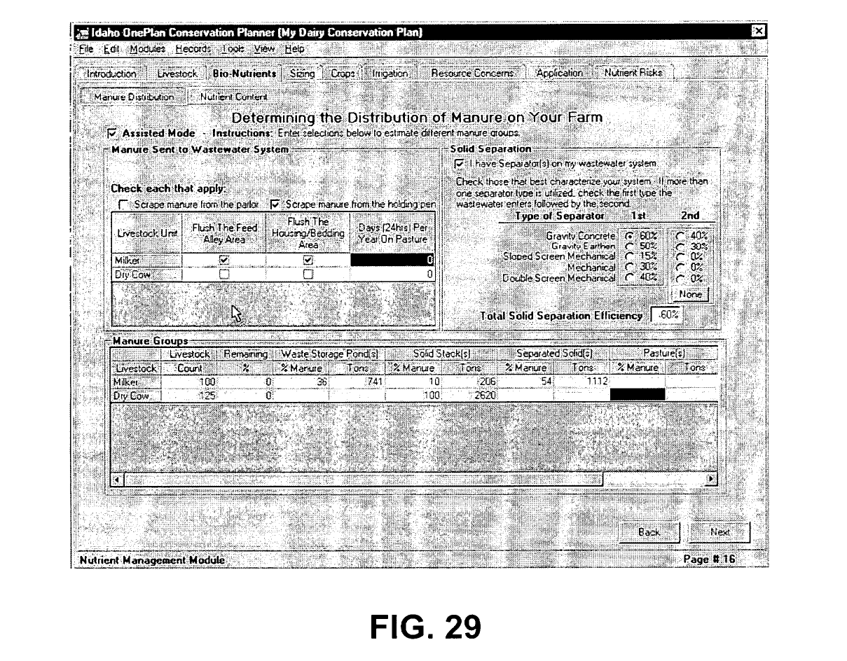

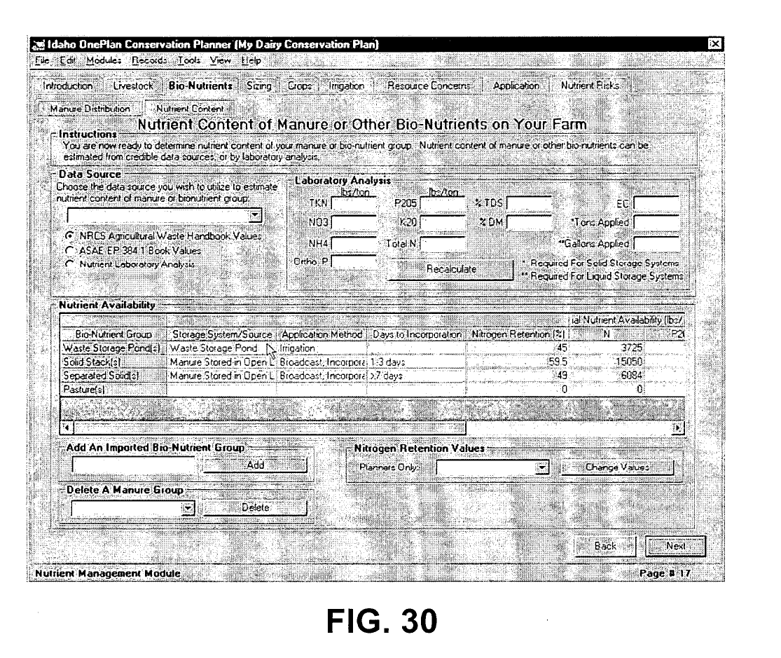

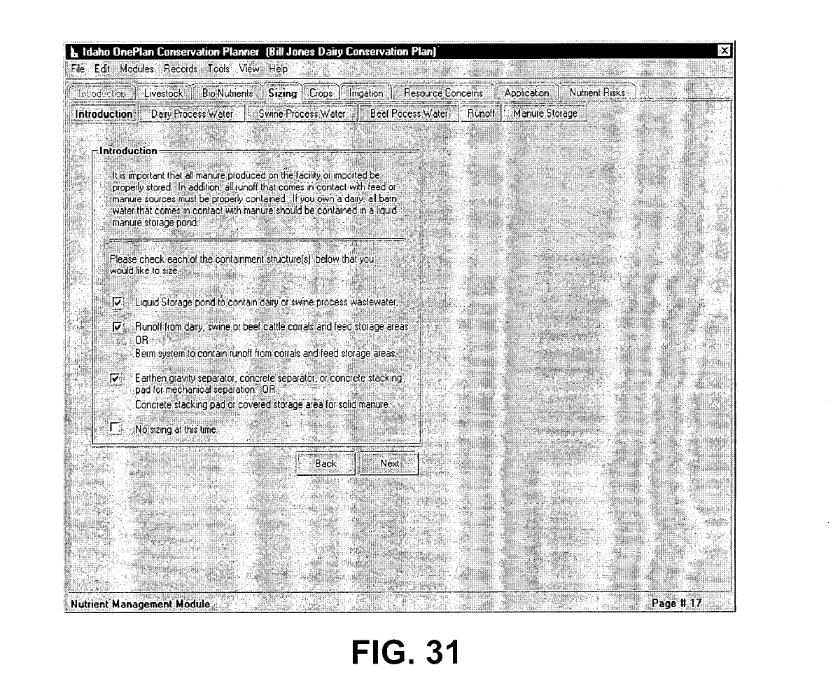

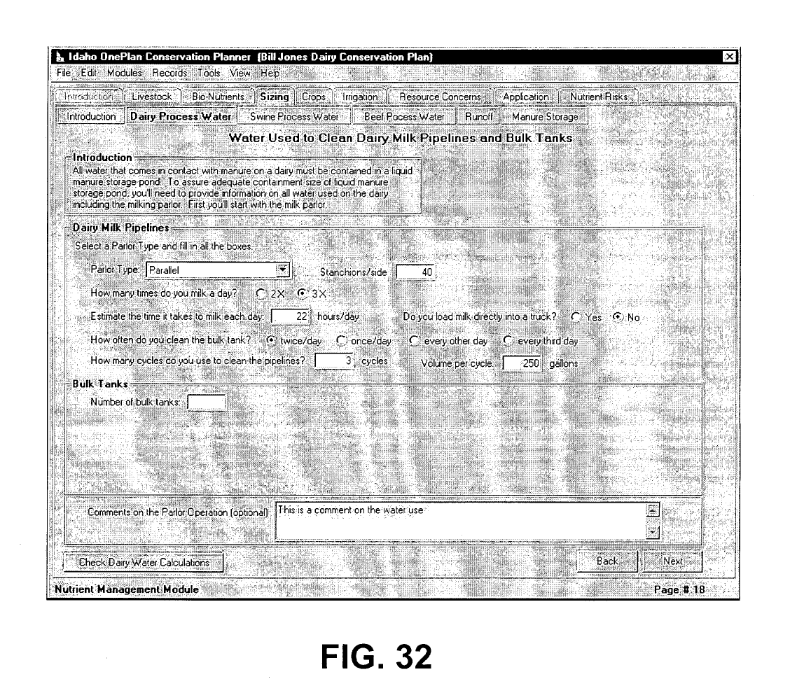

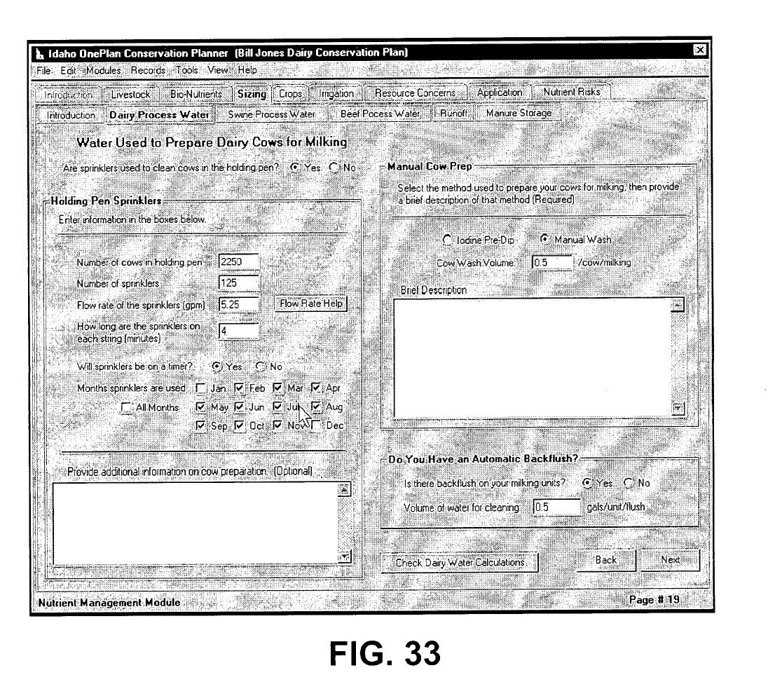

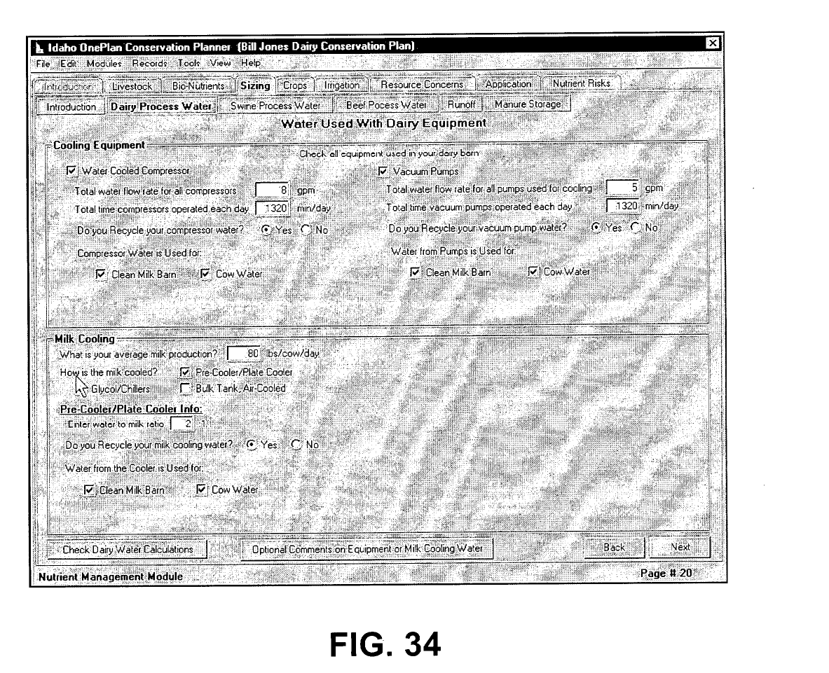

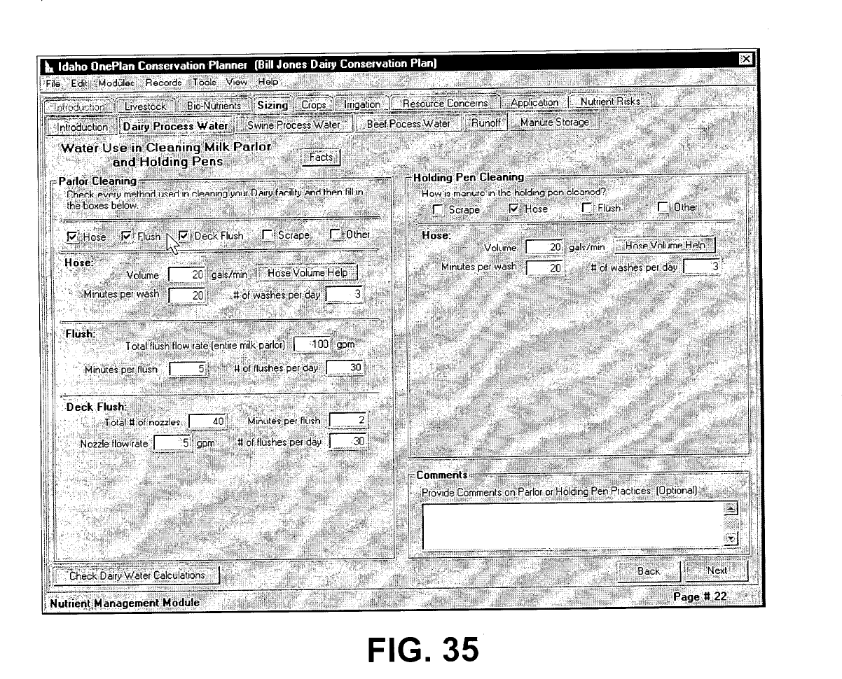

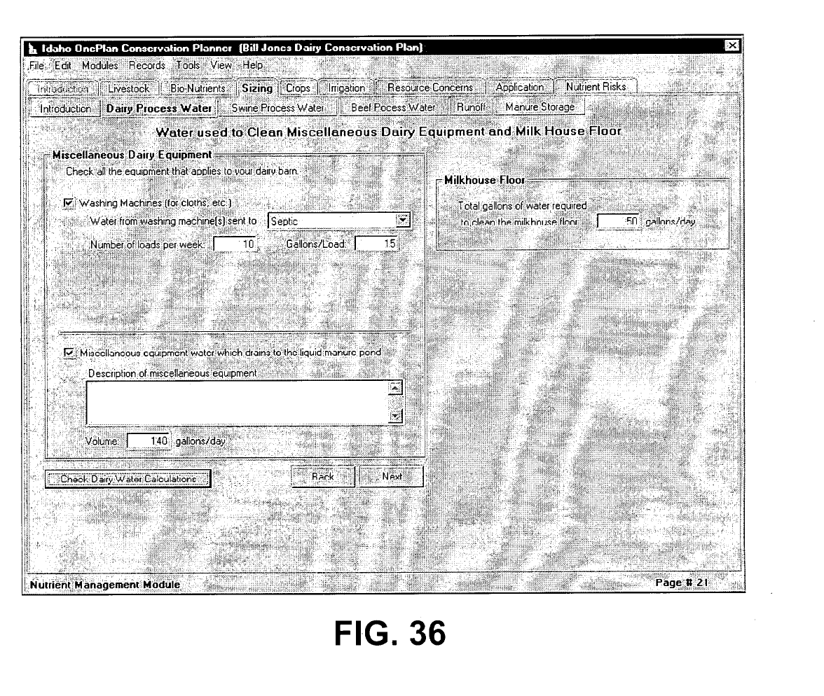

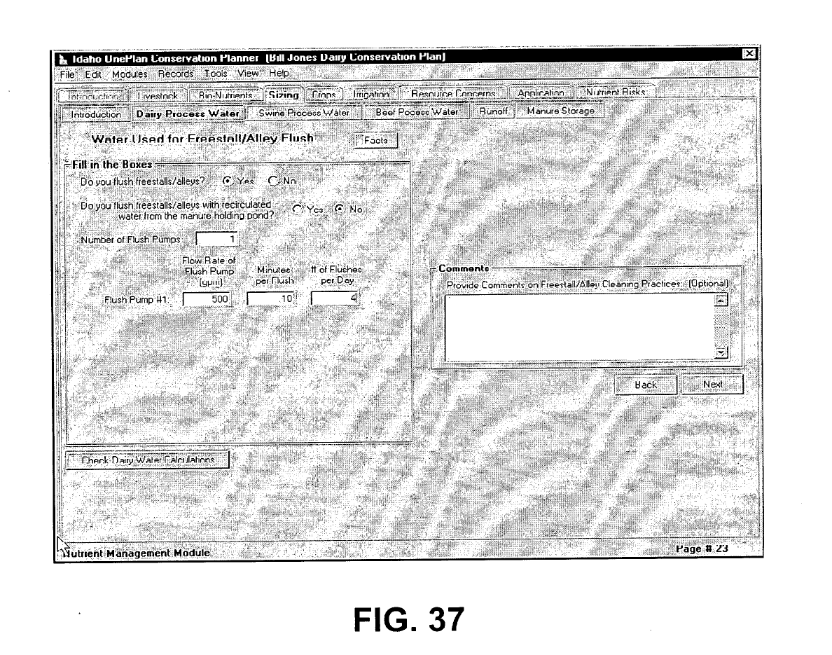

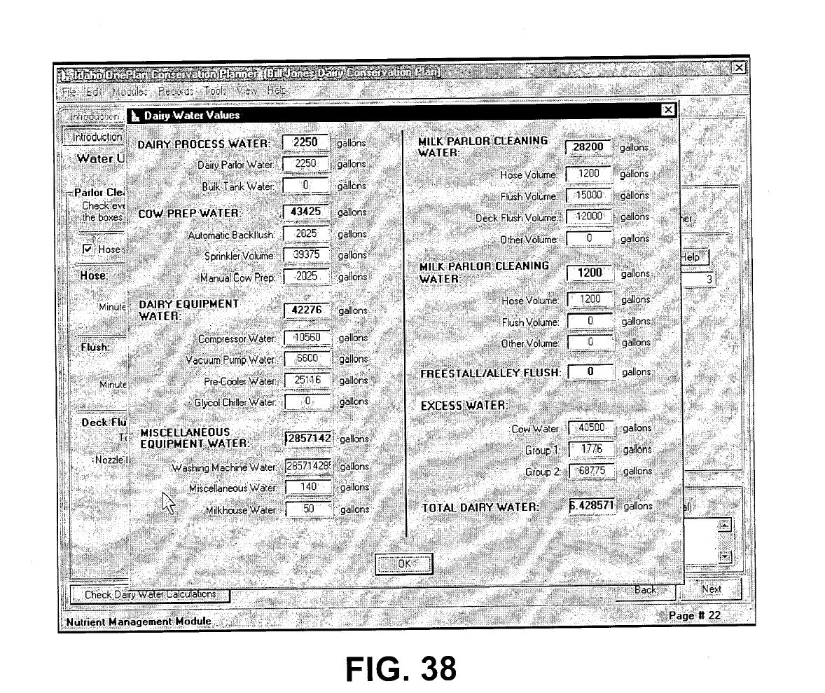

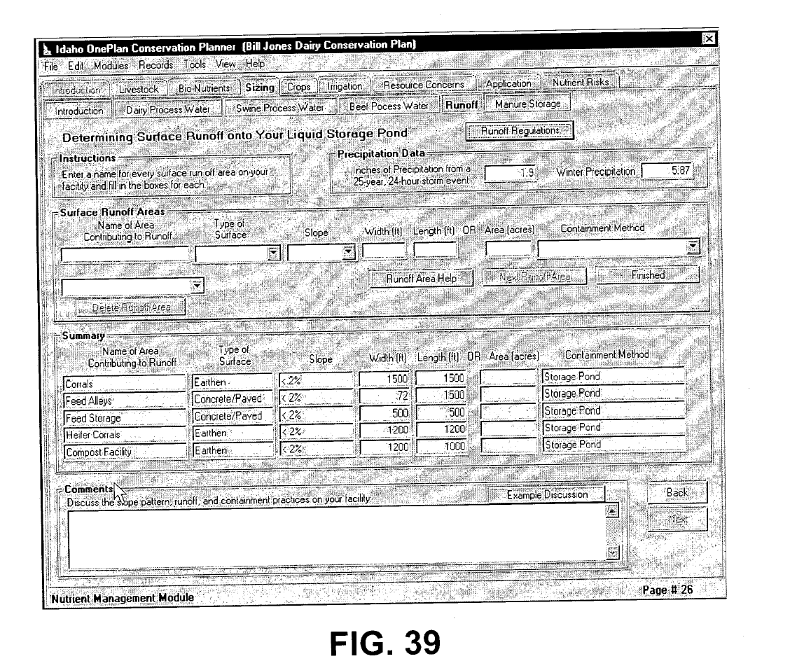

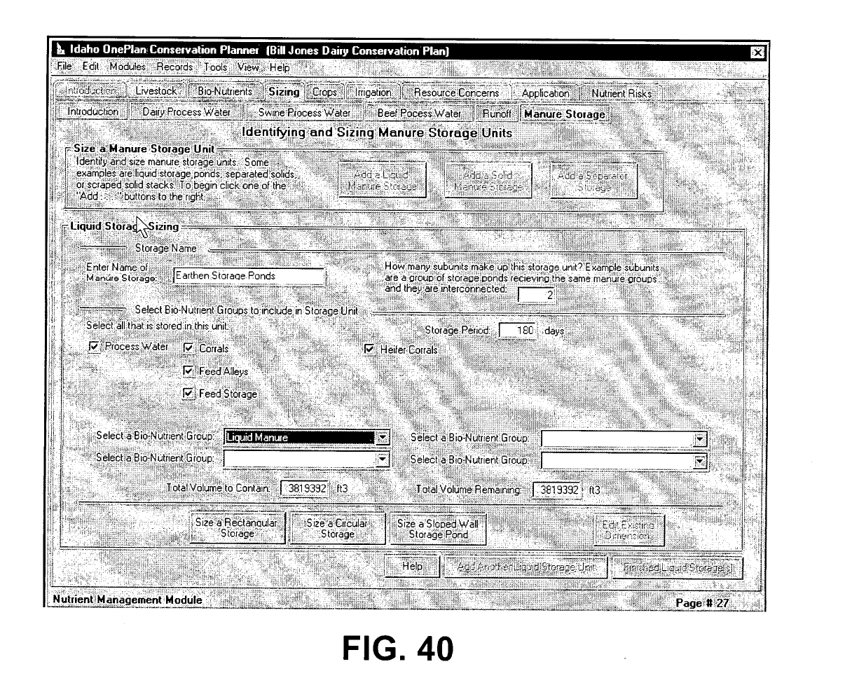

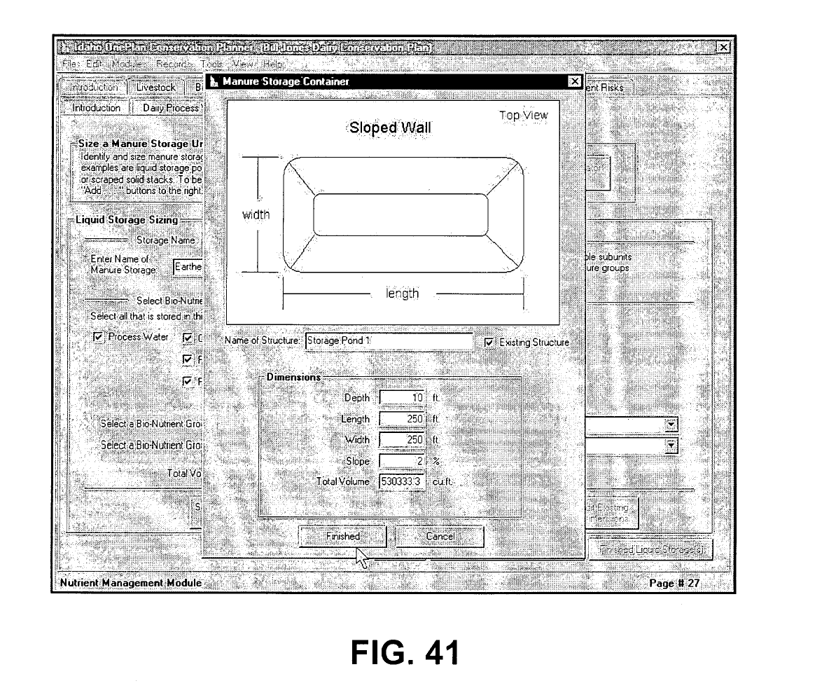

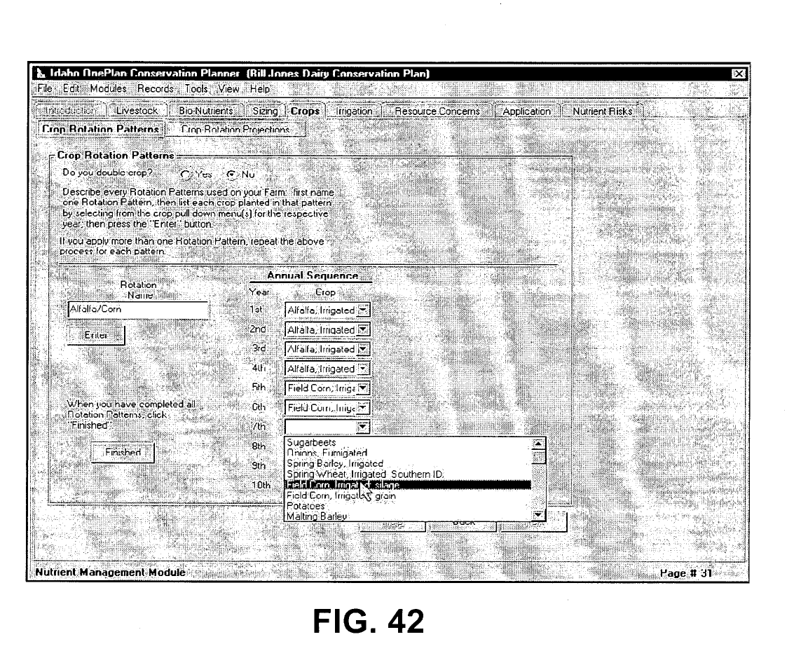

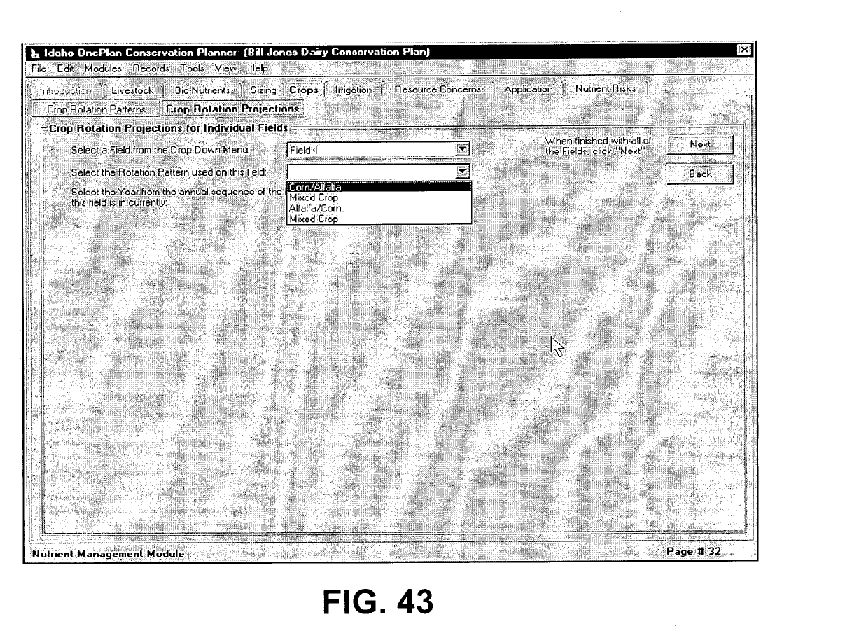

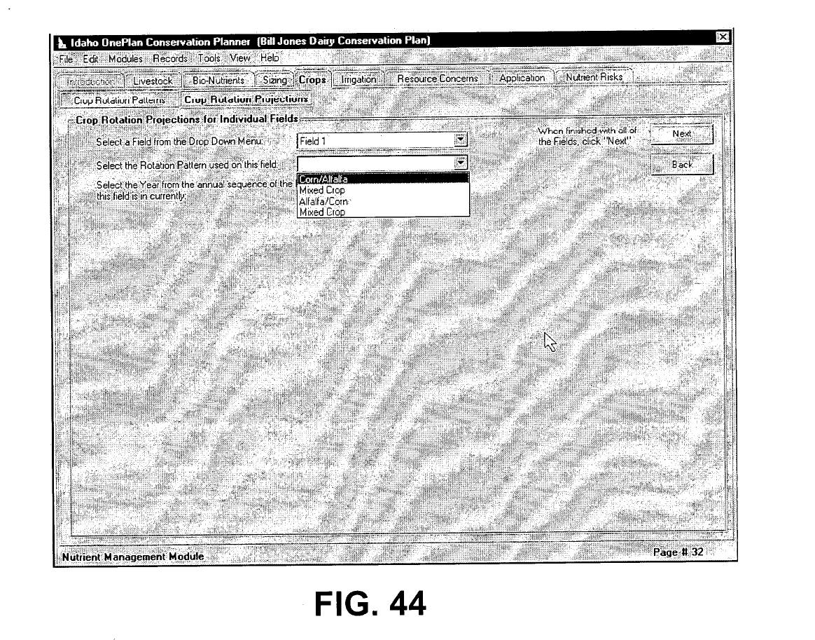

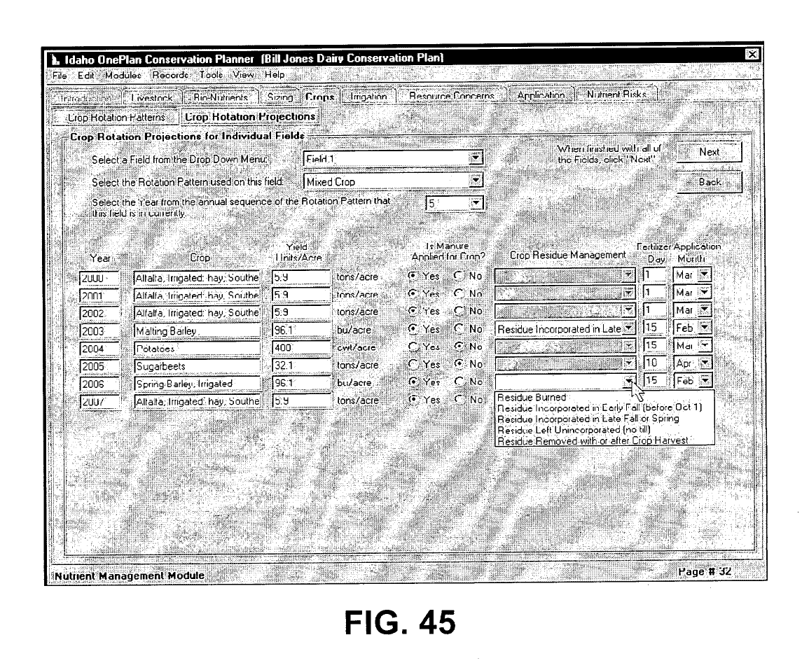

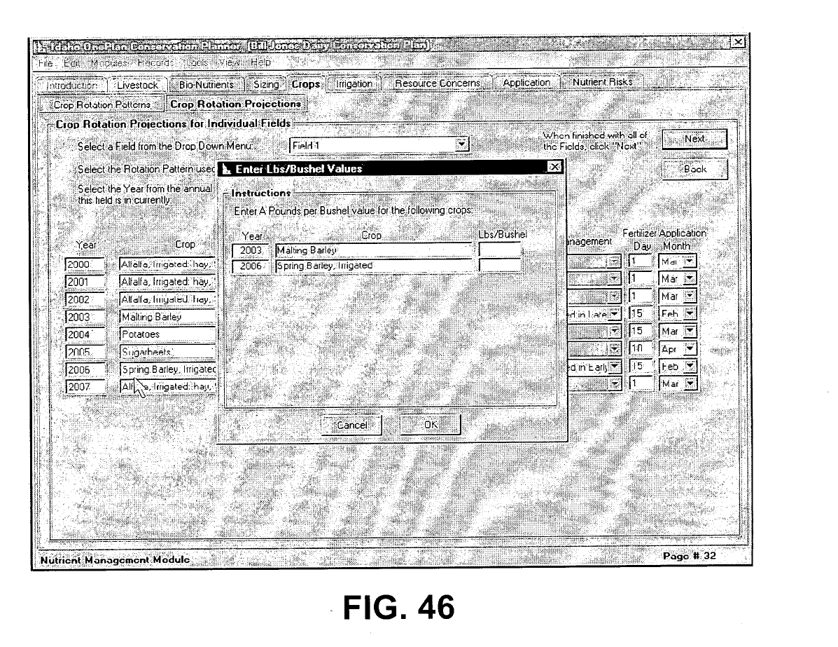

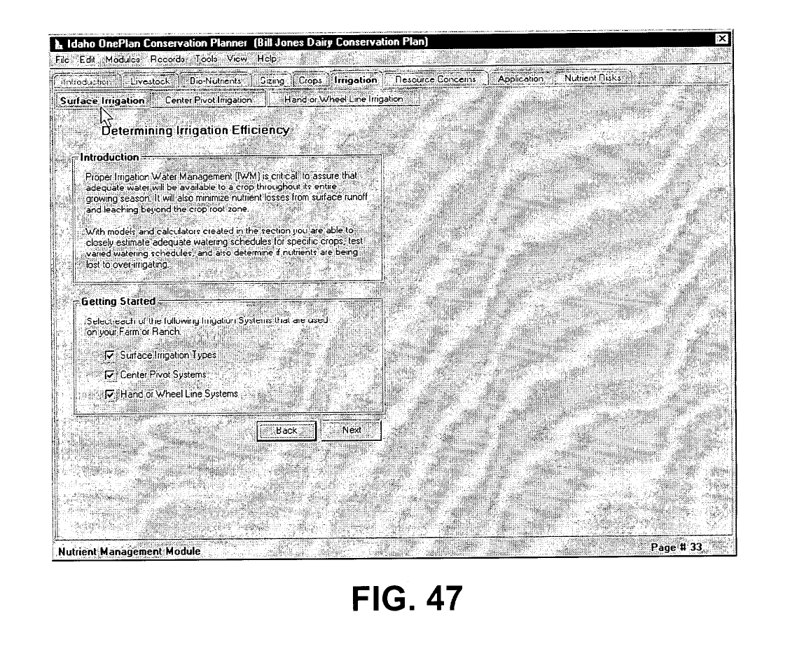

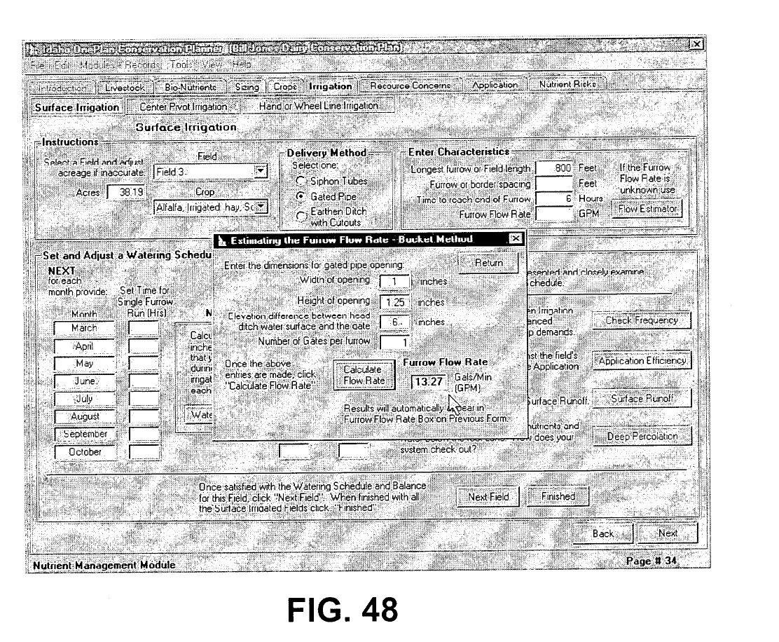

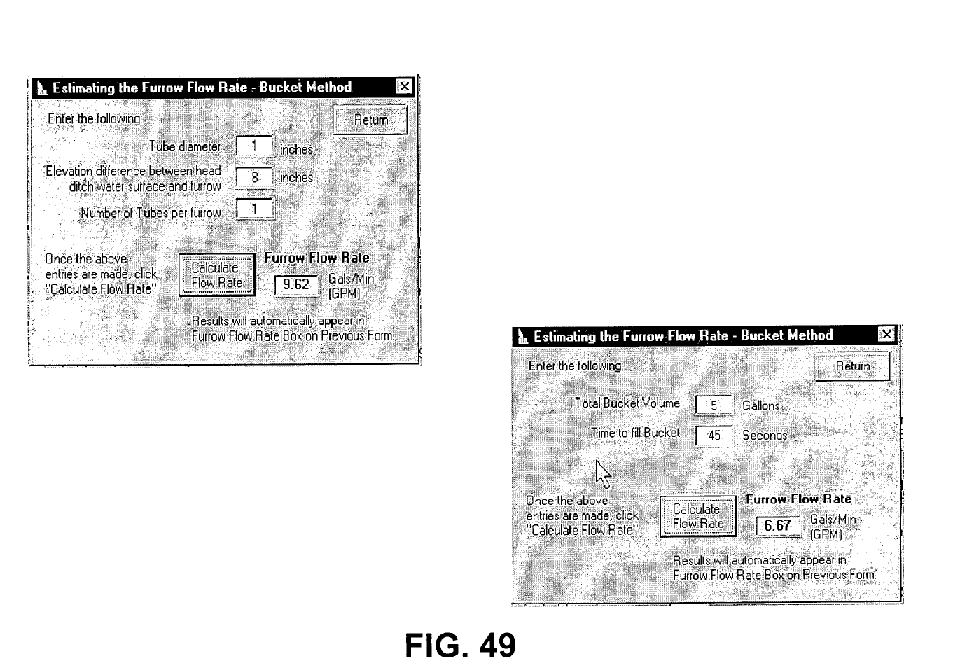

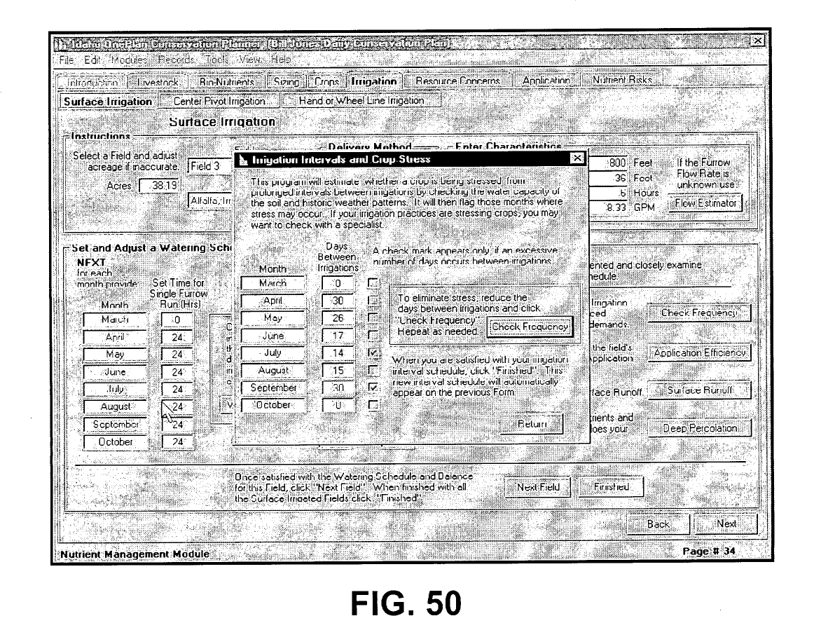

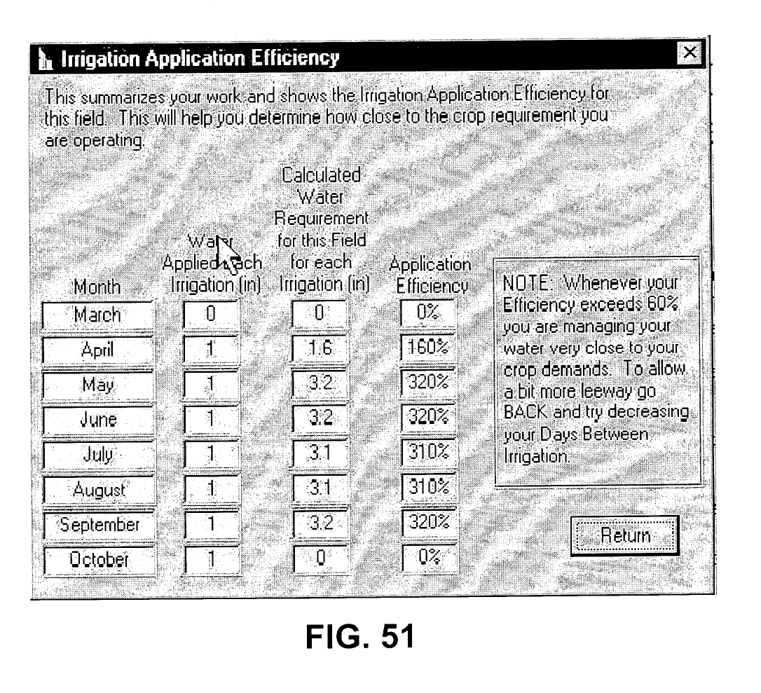

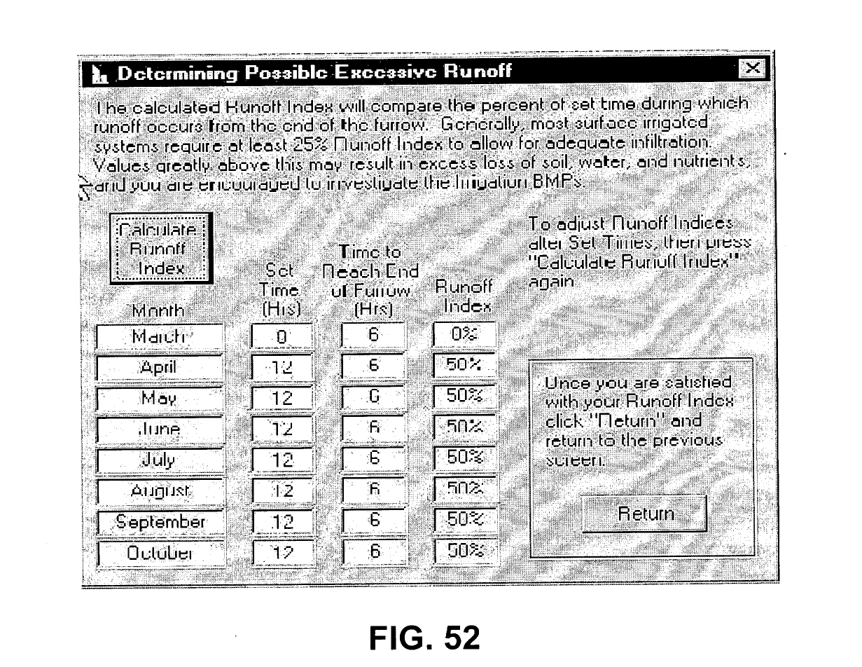

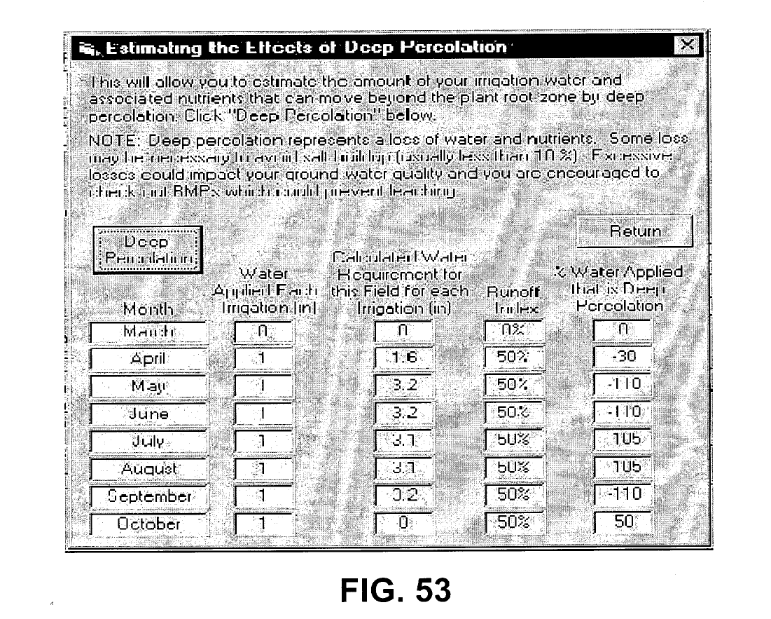

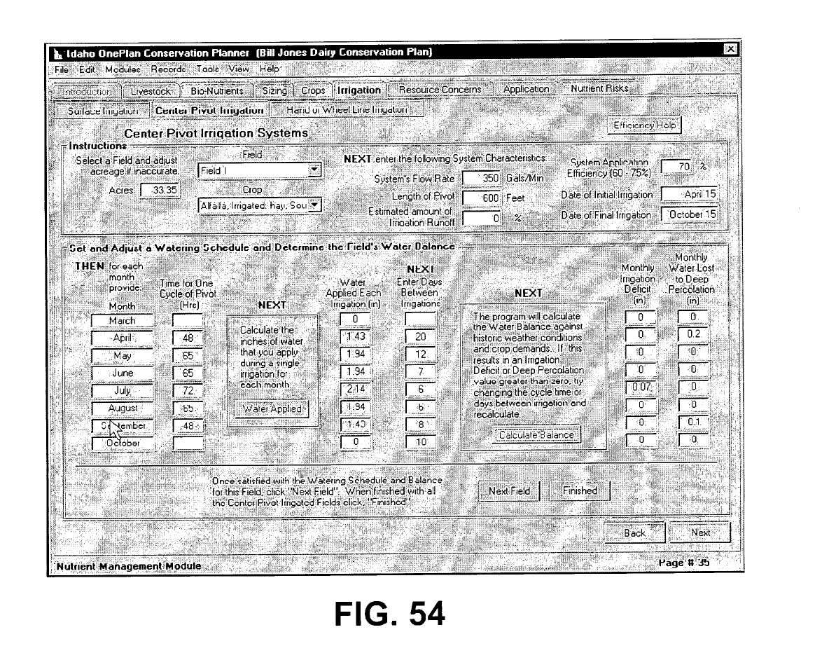

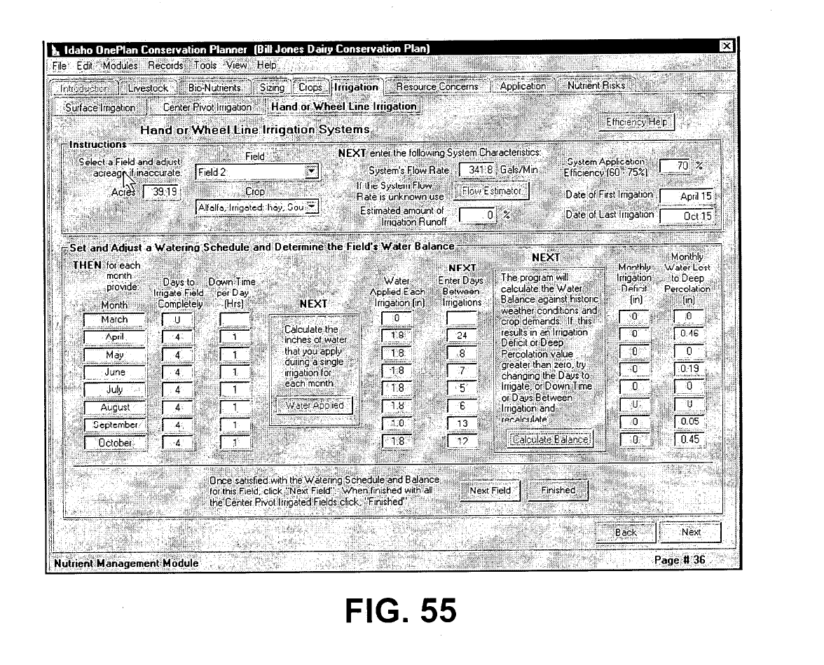

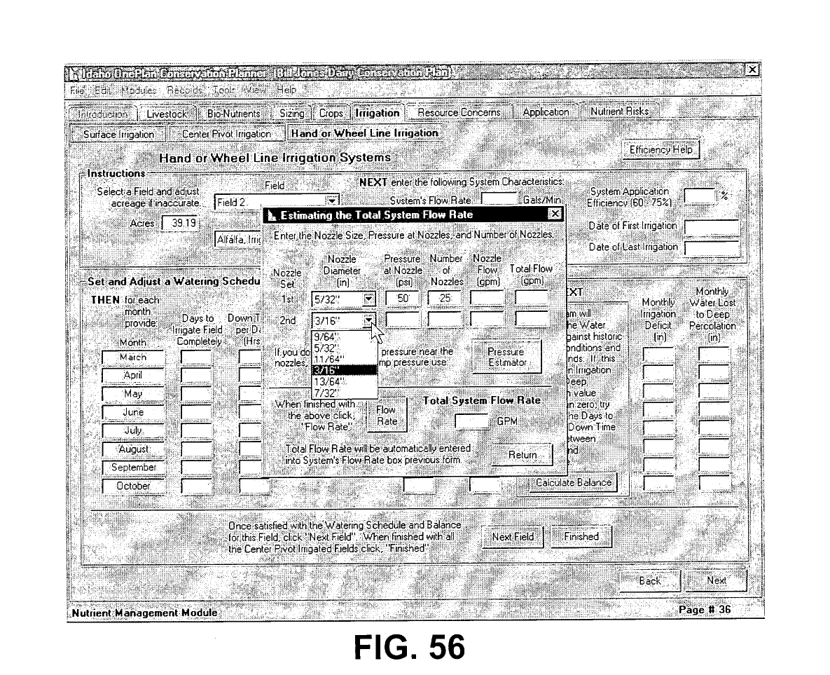

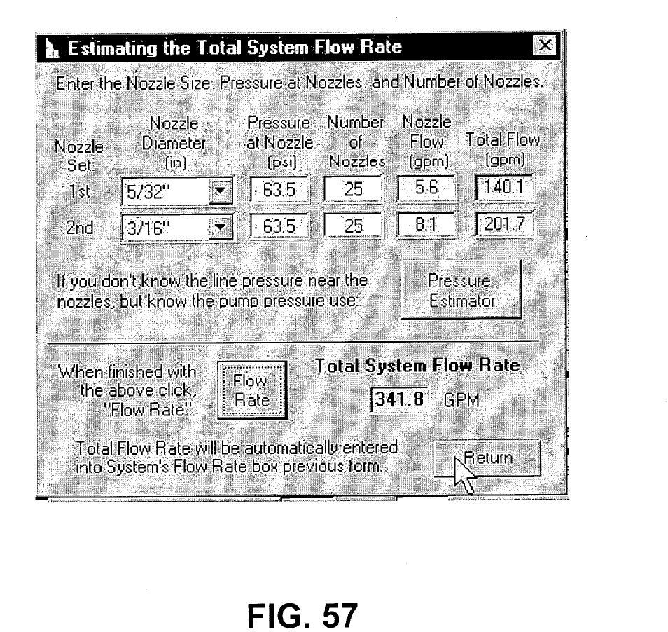

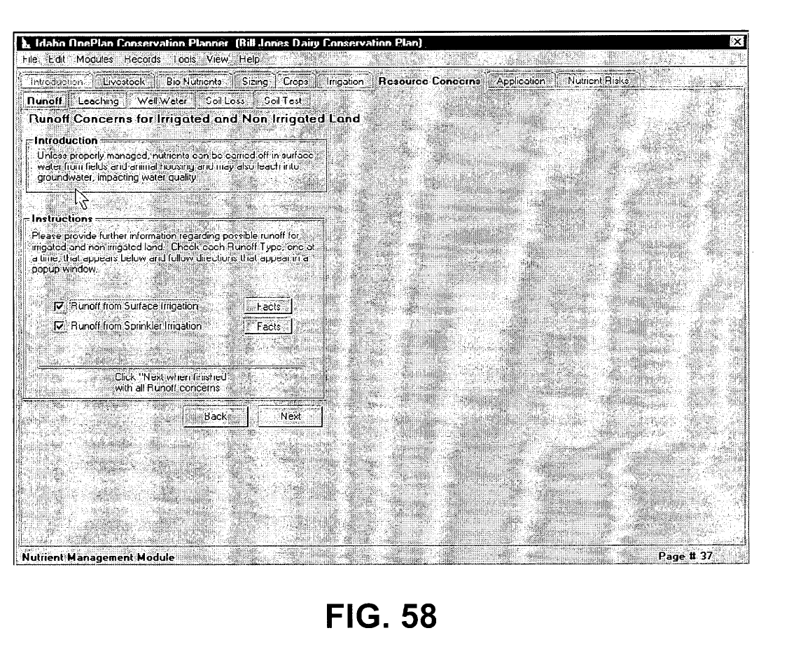

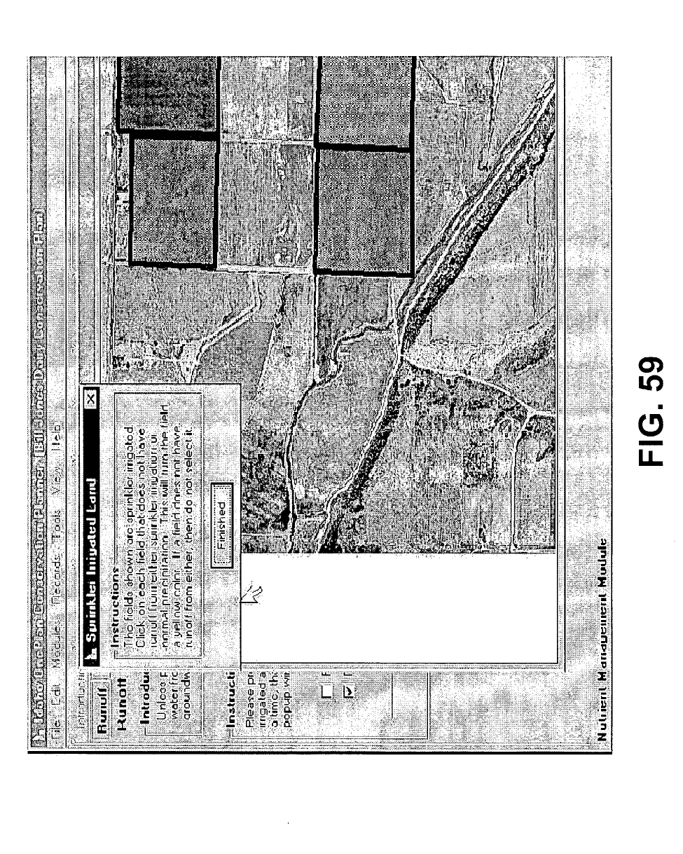

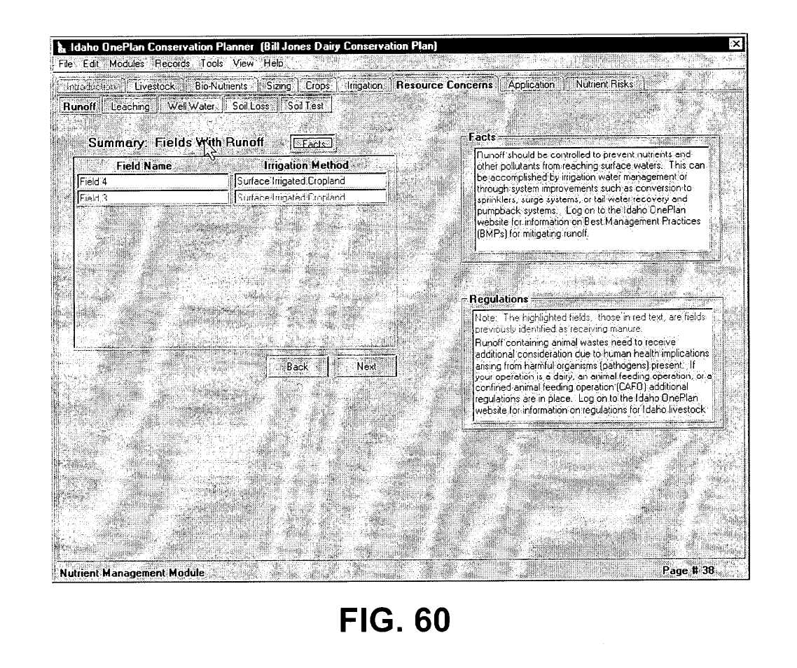

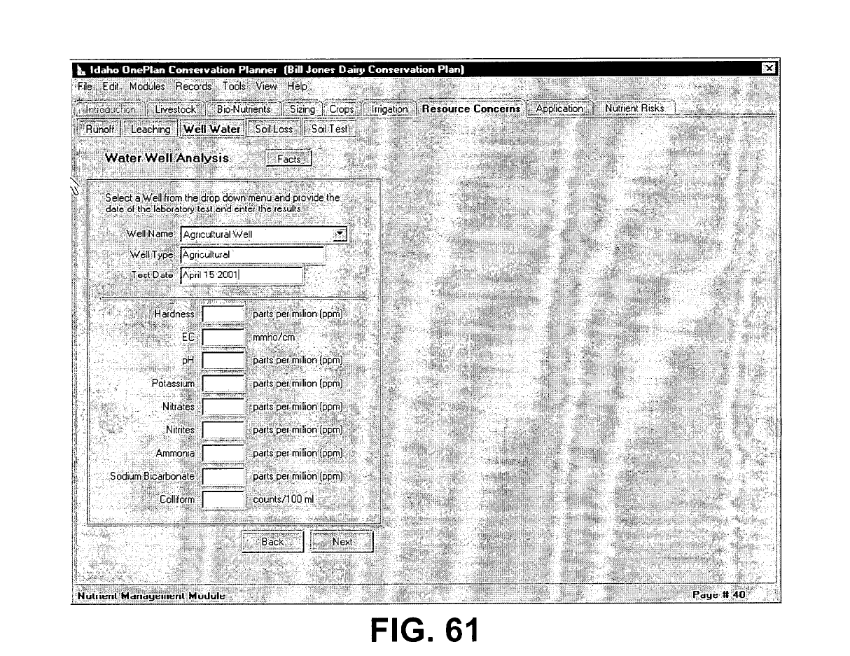

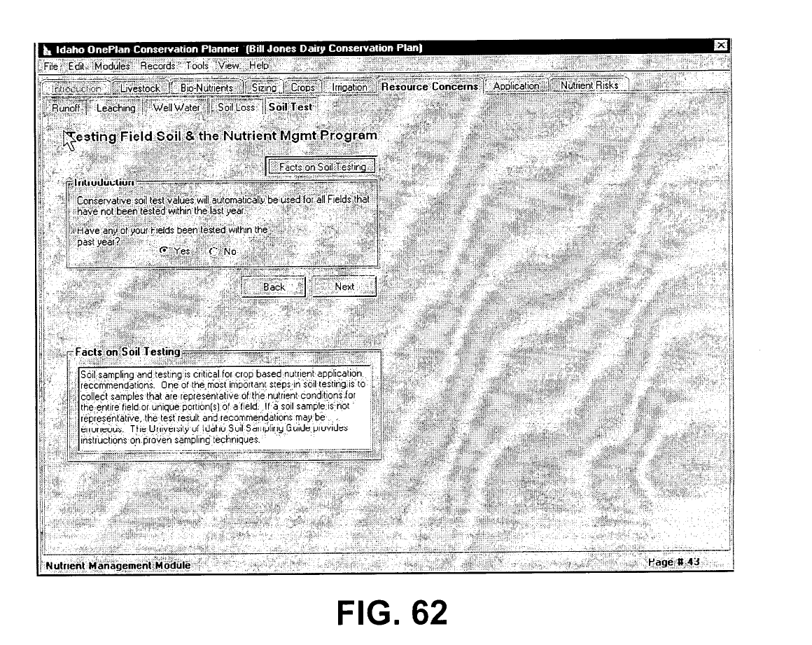

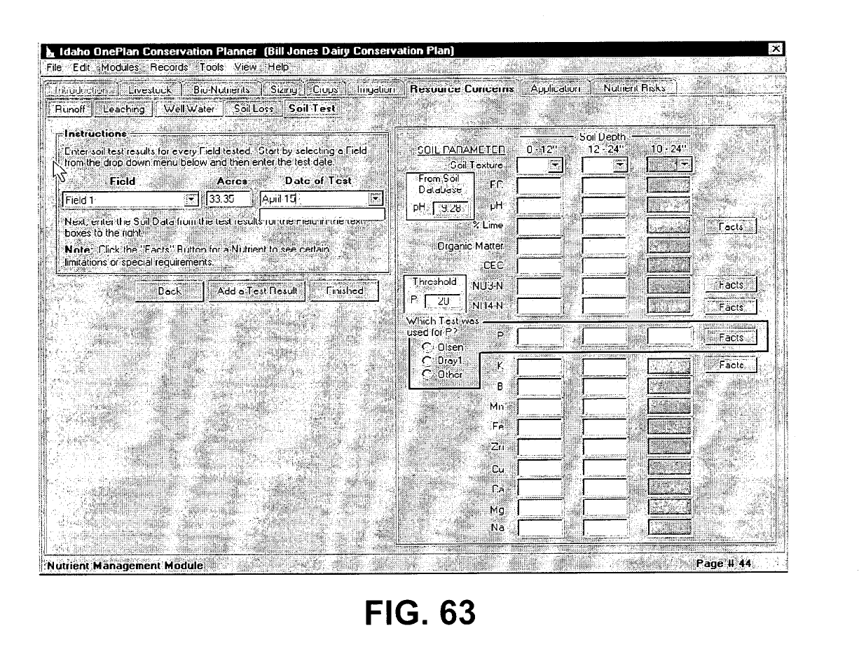

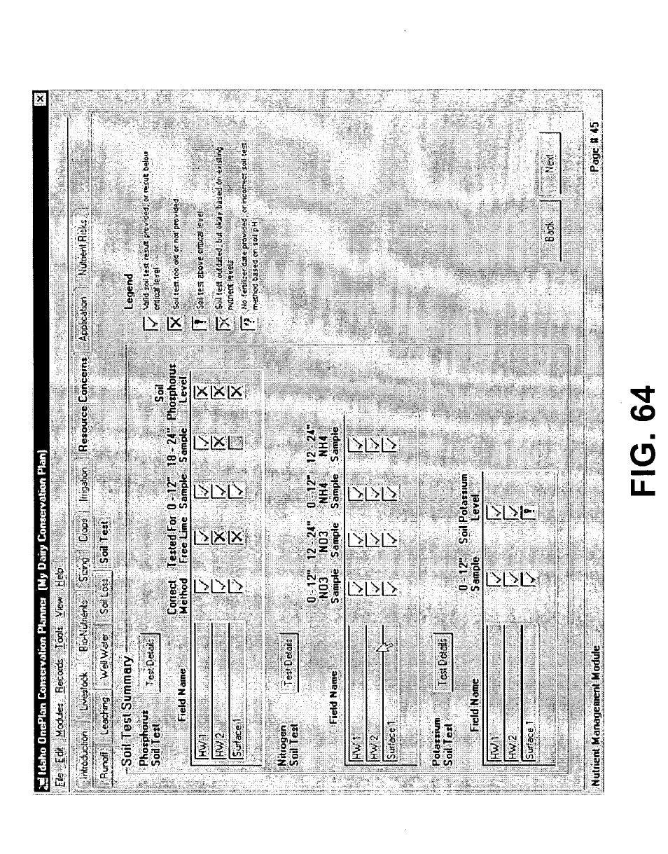

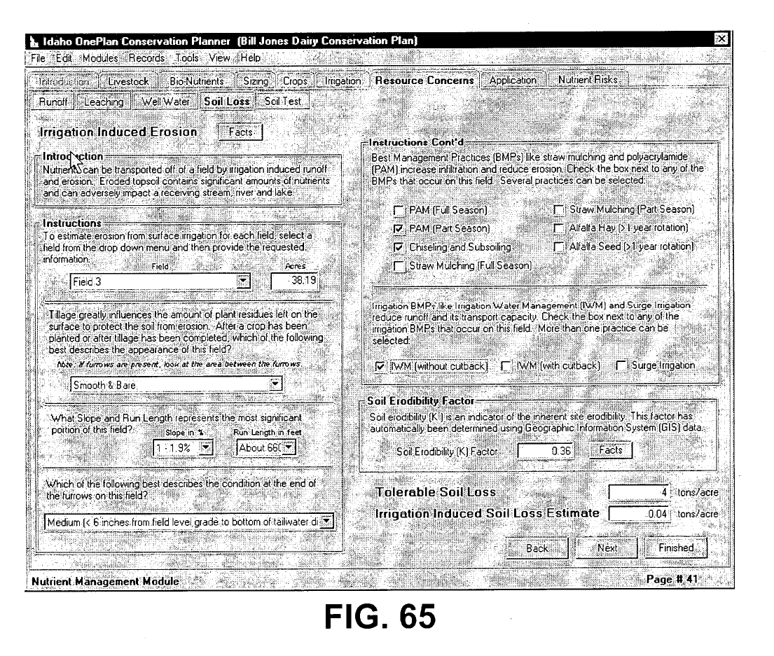

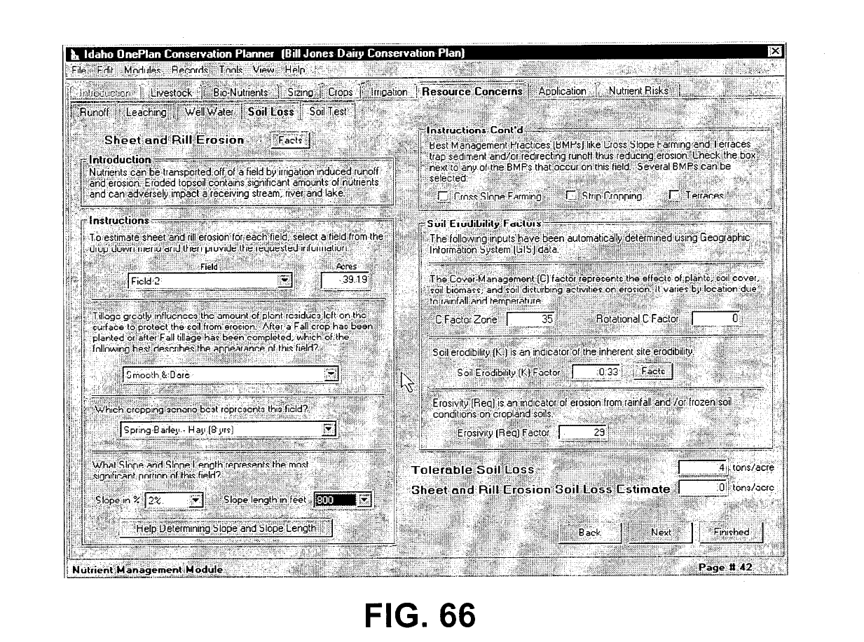

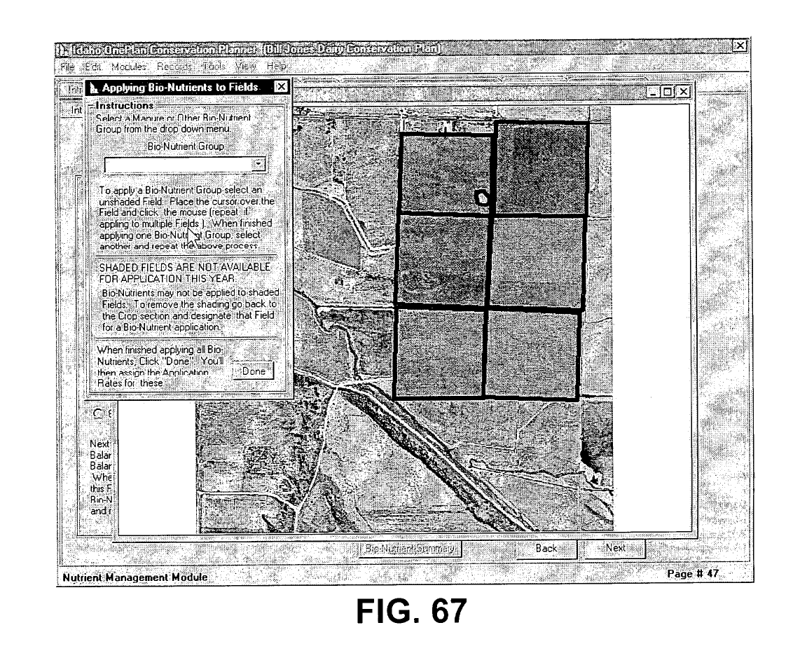

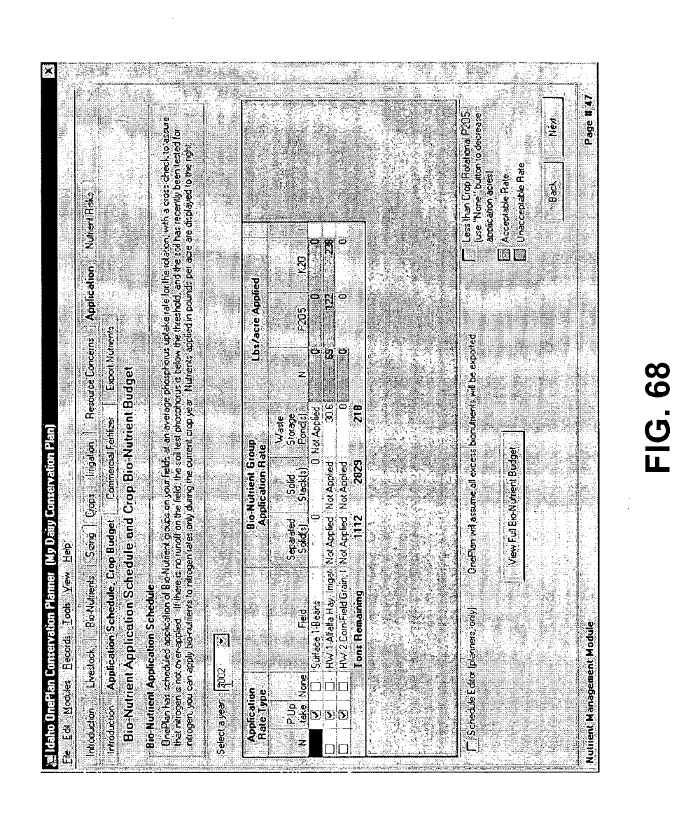

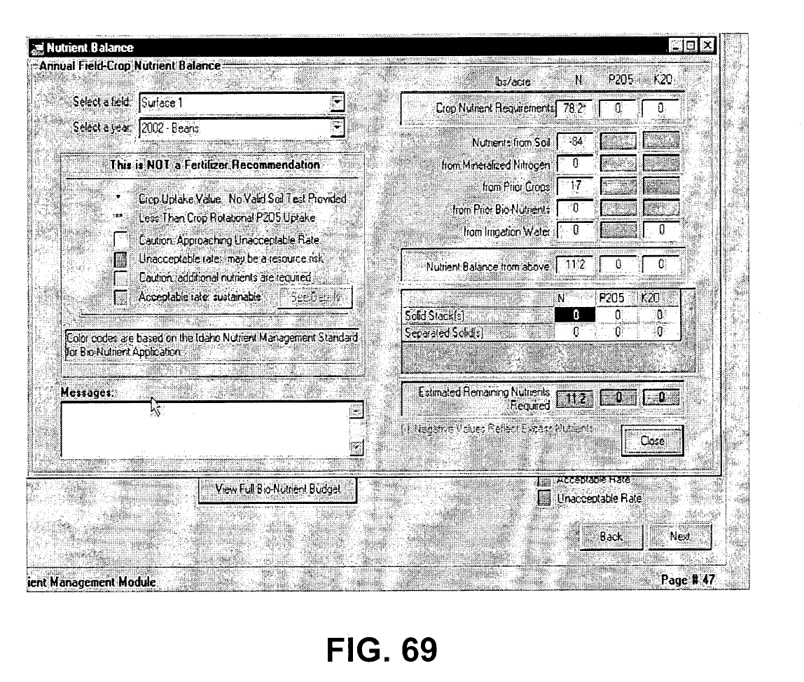

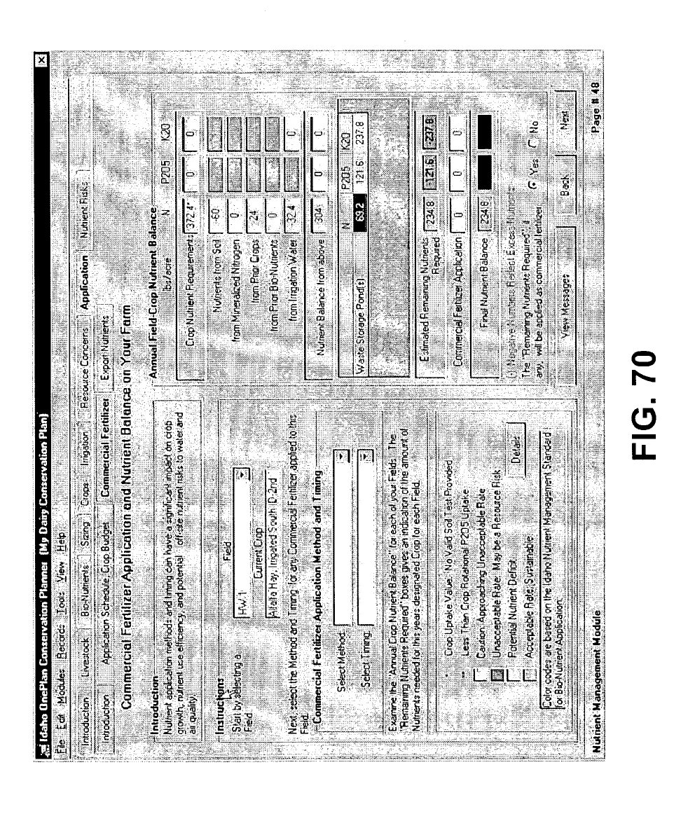

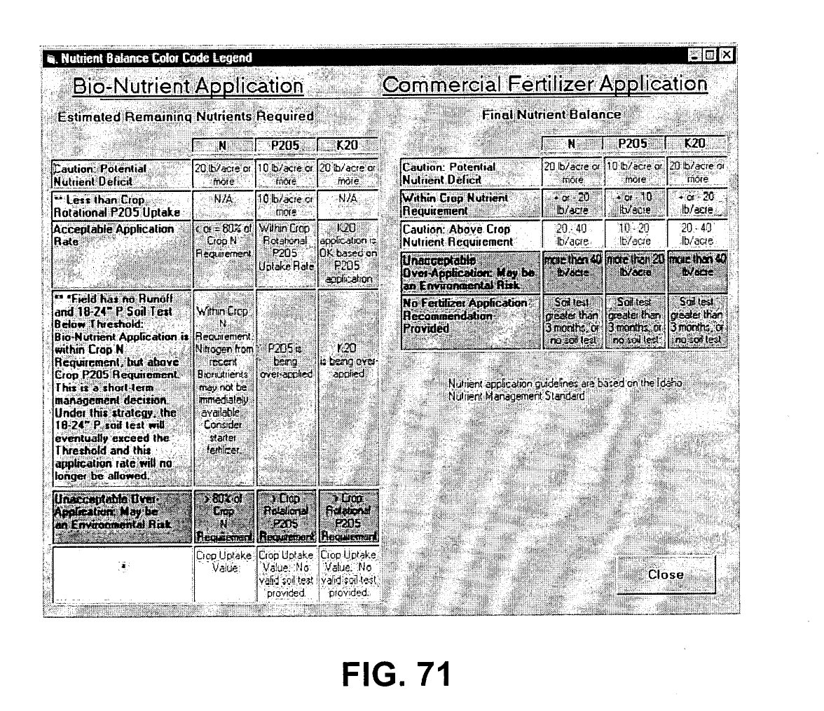

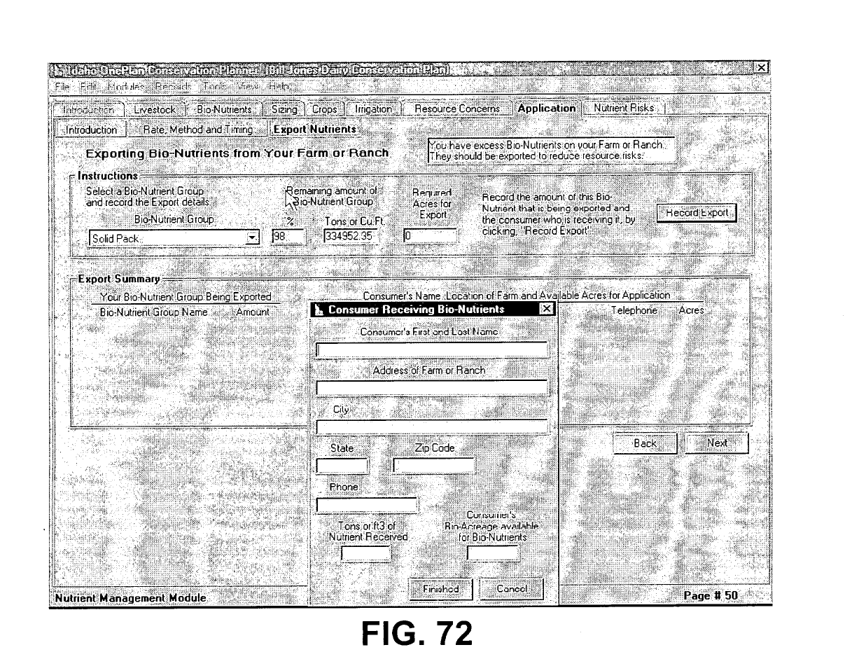

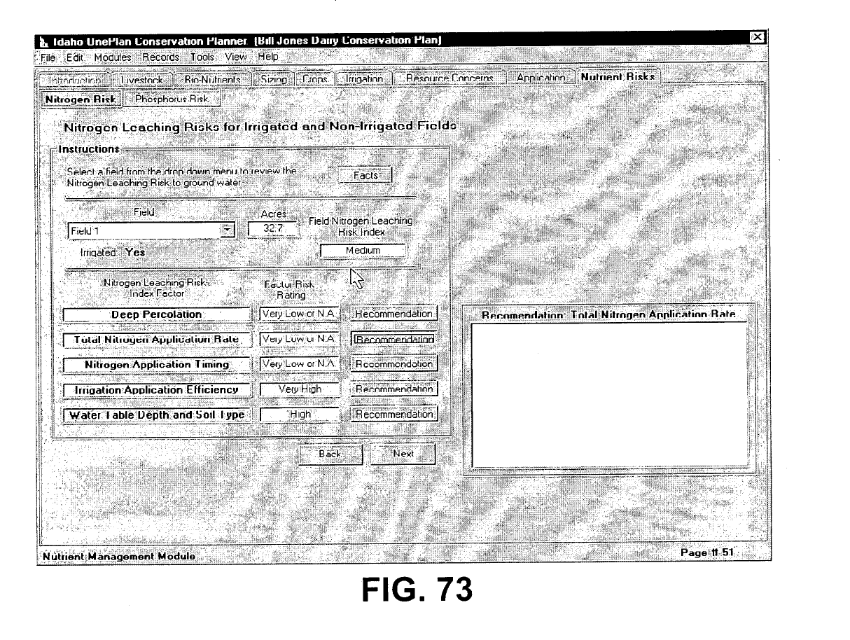

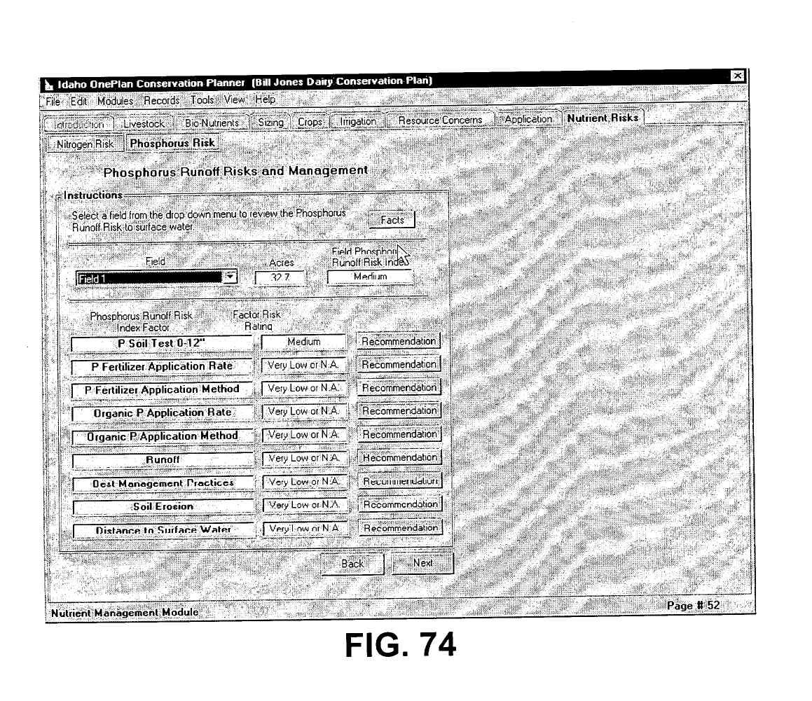

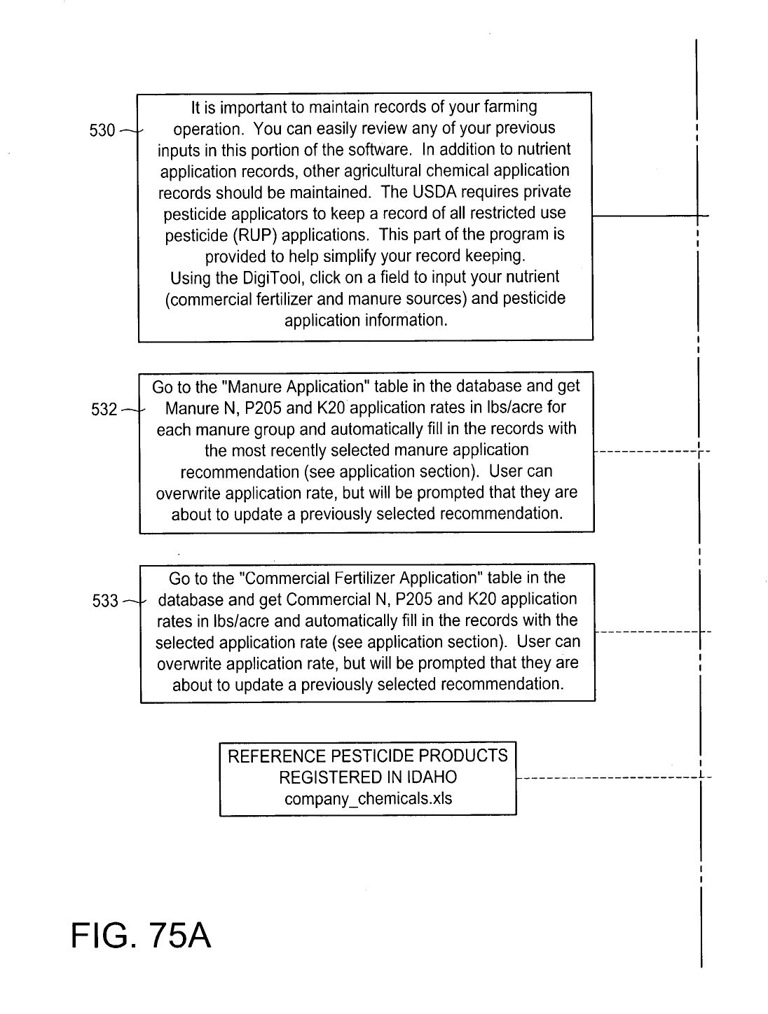

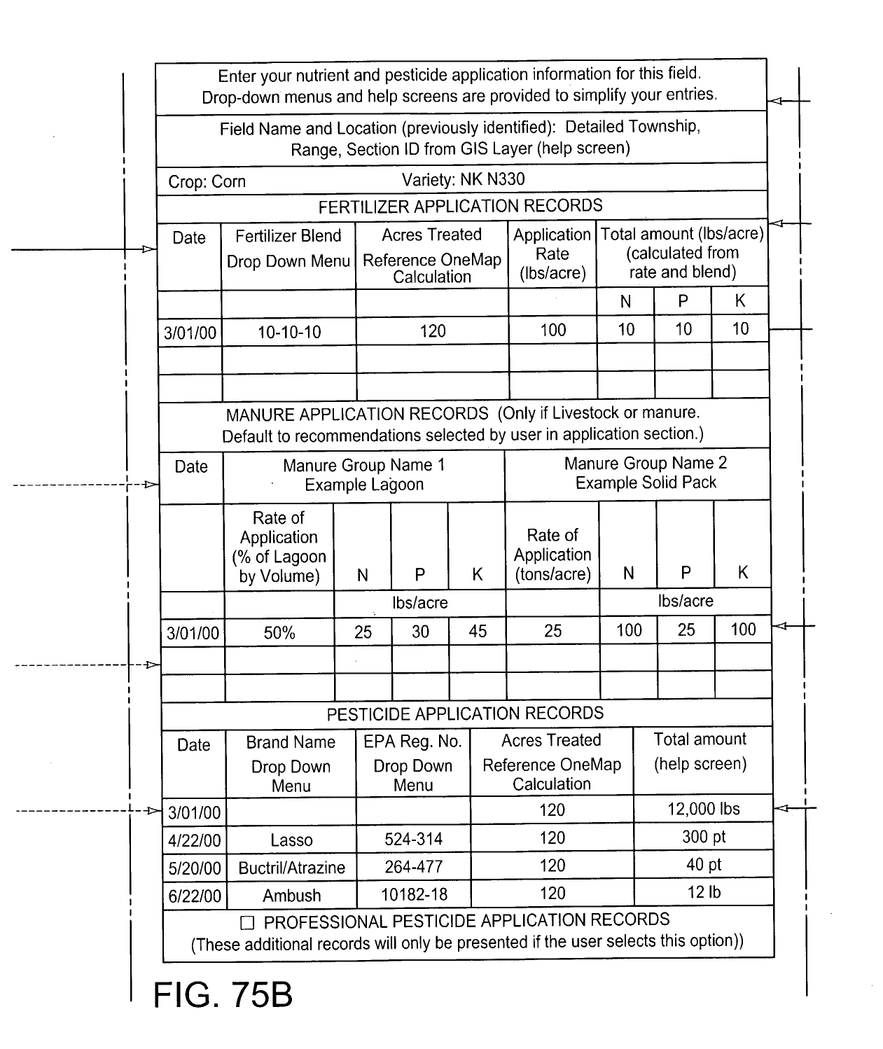

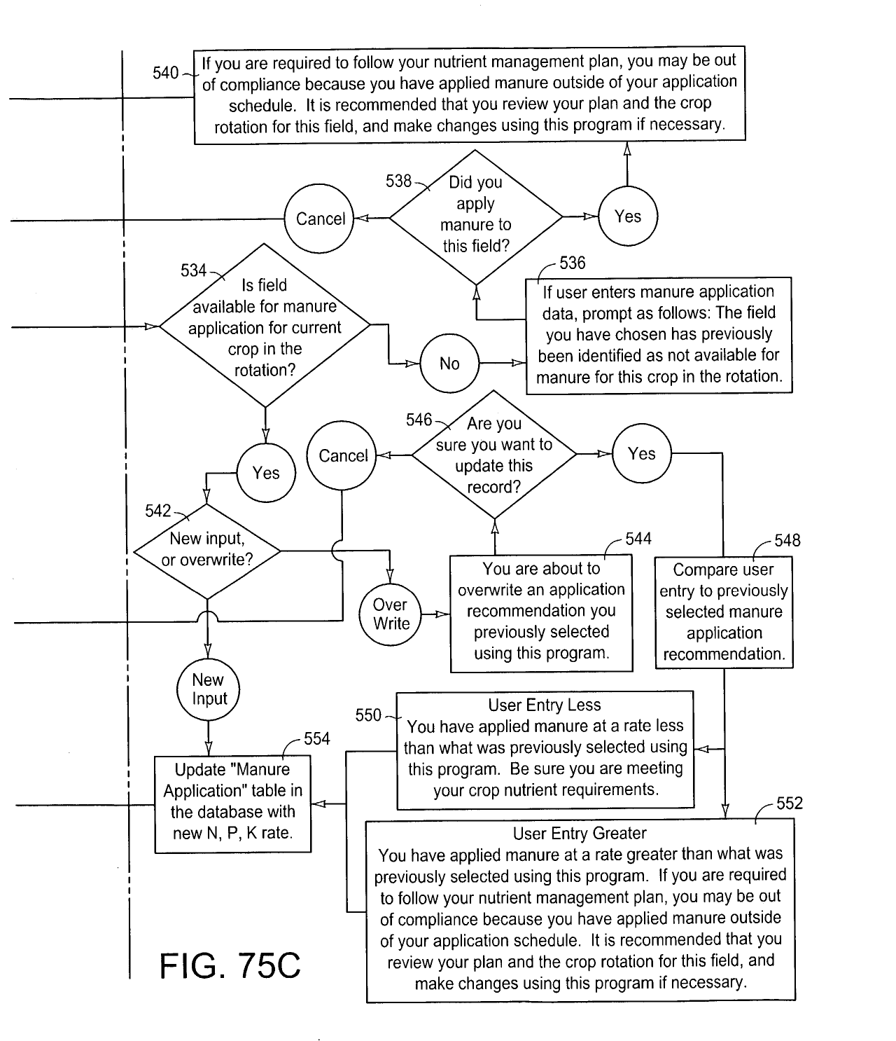

The new conservation planning process that may be implemented in the Idaho OnePlan™ decision support tool utilizes the Guidance Document Templates in a unique way to involve the producer user more in the planning process and reduce the time and cost to develop accurate conservation plans and conservation practice management plans. FIG. 21 illustrates a method that may be implemented in conservation module 24 of decision support program 22 (module 24 and program 22 are shown in FIGS. 4A and 4B) to develop an agricultural resource conservation plan. Referring to FIG. 21, once the user has defined the planning units, identified special characteristics of those units, including existing management practices, conservation module 22 programming aligns each planning unit with the applicable NRCS Guidance Document Template or Templates (step 200) to automatically identify resources that are typically a problem in that landscape planning unit (step 202). In an optional step, the user is prompted to assess each such resource to determine if it is actually a problem in the planning unit (step 204). In this assessment, which is described in more detail below, each resource is presented to the user along with applicable minimum quality criteria established by the Quality Criteria in Section III of the NRCS Field Office Technical Guide. Only those resources that the user determines do not meet the minimum quality criteria on any planning unit are identified as a problem. In an optional step, soil, water, air, plant, animal and other resource concerns not typical for a planning unit can also be assessed in the same way to determine if they might also present a problem in the planning unit (step 206).

Once each planning unit is properly aligned with the applicable NRCS Guidance Document Template or Templates, the user is prompted to select the conservation practice or practices necessary to resolve each resource problem from a list of Best Management Practices compiled by the NRCS in its Field Office Technical Guide and based specifically on the corresponding NRCS Guidance Document (step 208). The user is then prompted to assess existing and planned features of buildings and areas around the buildings to determine if any corrective actions should be taken in and around buildings (step 210). This part of the producer's operation is commonly referred to as the farmstead, and any corrective actions are noted in a farmstead action plan. An implementation schedule can then be developed for each conservation practice and each item in the farmstead action plan (step 212). Finally, the conservation plan is compiled and output (step 214). The conservation plan typically will include (1) a site map, description and characteristics; (2) the resource problems in each planning unit; (3) the conservation practices to be implemented in each planning unit; (4) the farmstead action plan; and (5) the implementation schedule.

The NRCS has developed resource assessments for each resource concern listed in the Field Office Technical Guide (FOTG) to determine resource problems and conservation practices that should be identified in a conservation plan. Many of these assessments involve complex algorithms and decision paths used by agency planners educated and experienced in resource management and conservation planning. Since the preferred version of PC based decision support program 22 is targeted for use by agricultural producers, many of the NRCS resource assessments are incorporated into support program 22 in a simplified form so that they can be used effectively by producers. One objective of the Idaho OnePlan™ is that most producers are able to complete each assessment on their own and that agency planners are able to use these assessments when working with producers to help them better understand a resource problem and conservation practices that can be put in place to correct the problem.

One example of a simplified resource assessment suitable for use in conservation module 24 of support program 22 is described below for Irrigation Induced Erosion. Each resource assessment identifies the resource concern that will be assessed, describes the resource problem and the desired condition, implements a decision making path or algorithm, and identifies conservation practices to resolve any problems. Initially, the user is prompted to select from a list of resource problems typical for the planning unit landscape. (These problems are identified in step 202 in FIG. 21.) In this example, the user has selected irrigation induced erosion and the assessment proceeds as follows to determine if typical resource problems actually apply (step 204 in FIG. 21) and to select the appropriate conservation practices to resolve any problems (step 208 in FIG. 21).

What is claimed is:

1. A computer readable medium having instructions thereon for:
associating geospatial information with digital imagery of geographic areas;
compiling geospatial information for a site selected from the digital imagery;
defining a planning unit within the site;
defining characteristics of the planning unit; and
based on defined characteristics, generating a conservation plan identifying resource problems for the planning unit and identifying practices that when implemented are expected to solve the resource problems.

2. The medium of claim 1, wherein generating a conservation plan comprises identifying resource problems for the planning unit, identifying practices that when implemented are expected to solve the resource problems and establishing a schedule for implementing the practices.

3. A computer readable medium having instructions thereon for:
associating geospatial information with digital imagery of multiple agricultural sites;
compiling the geospatial information for a site selected from the multiple sites;
defining a farm or ranch within the site;
defining characteristics of the farm or ranch including identifying geospatial information, irrigation features, hydrological features and facilities of the farm or ranch; and
based on defined characteristics, generating a conservation plan identifying resource problems for the farm or ranch and identifying practices that when implemented are expected to solve the resource problems.

4. The medium of claim 3, wherein identifying a farm or ranch comprises identifying a farm field or a ranch field and defining characteristics comprises defining characteristics of the farm field or ranch field including identifying geospatial information, irrigation features, hydrological features and facilities of the farm field or ranch field.

5. The medium of claim 3, wherein defining characteristics comprises defining characteristics of the farm or ranch including identifying geospatial information, irrigation features, hydrological features, facilities and practices being implemented on the farm or ranch.

6. A computer readable medium having instructions thereon for:
prompting a user to identify a planning unit;
aligning the planning unit with applicable NRCS common resource areas and/or NRCS Guidance Document Templates;
identifying resources typically a problem in the planning unit;
prompting the user to assess if a resource identified as typically a problem for the planning unit is actually a problem for the planning unit;
prompting the user to identify resource management practices needed to resolve each resource actually a problem for the planning unit from a list of conservation practices compiled by the NRCS in its Field Office Technical Guide;
generating a conservation plan identifying the planning unit, resources actually a problem for the planning unit and the resource management practices need to resolve each resource problem.

7. The medium of claim 6, having further instructions for:
prompting the user to assess existing and planned features of buildings and areas around buildings;
identifying in a farmstead action plan with any corrective actions to be taken in and around buildings; and
wherein generating a conservation plan comprises generating a conservation plan identifying the planning unit, identifying resources actually a problem for the planning unit, identifying the resource management practices need to resolve each resource problem, and describing the farmstead action plan.

8. The medium of claim 6, having further instructions for:
developing an implementation schedule for each resource management practice; and
wherein generating a conservation plan comprises generating a conservation plan identifying the planning unit, identifying resources actually a problem for the planning unit, identifying the resource management practices need to resolve each resource problem, and describing the implementation schedule.

9. The medium of claim 7, having further instructions for:
developing an implementation schedule for each resource management practice and each corrective action; and
wherein generating a conservation plan comprises generating a conservation plan identifying the planning unit, identifying resources actually a problem for the planning unit, identifying the resource management practices need to resolve each resource problem, describing the farmstead action plan, and describing the implementation schedule.

10. A resource management planning system, comprising:
a web server having access to digital imagery of geographic areas and geospatial information associated with the digital imagery;
computer programming for compiling geospatial information for a site selected from the digital imagery; and
computer programming for generating a conservation plan identifying resource problems for the site and identifying practices that when implemented are expected to solve the resource problems.

11. The system of claim 10, wherein the computer programming for compiling geospatial information resides on the web server and the computer programming for generating a conservation plan resides on a client remote from the web server.

12. The system of claim 10, wherein the computer programming for compiling geospatial information and the computer programming for generating a resource management plan reside on the web server.

13. The system of claim 10, wherein the computer programming for generating a resource management plan for the site based on the geospatial information comprises computer programming for:
defining a planning unit within the site;
defining characteristics of the planning unit including characteristics based on the geospatial information; and
generating a conservation plan for the planning unit based on defined characteristics, the plan identifying resource problems for the site and identifying practices that when implemented are expected to solve the resource problems.

14. The system of claim 10, further comprising computer programming for generating a nutrient management plan identifying nutrient management practices for agricultural operations on a selected site in which nutrients are applied to the land and/or animal waste or other bio-nutrients are handled.

15. Computer programming implementing an agricultural producer self-guided adaptation of NRCS conservation planning guidelines and processes.

16. The programming of claim 15, wherein implementing includes generating a series of graphical user interfaces prompting the producer to input information and answer questions related to conservation planning.

17. The programming of claim 16 wherein implementing also includes generating a conservation plan based on information input by the producer and the producer's answers to questions.

18. Computer programming implementing an agricultural producer self-guided adaptation of NRCS nutrient management planning guidelines and processes.

19. The programming of claim 18, wherein implementing includes generating a series of graphical user interfaces prompting the producer to input information and answer questions related to nutrient management.

20. The programming of claim 19 wherein implementing also includes generating a nutrient management plan based on information input by the producer and the producer's answers to questions.

21. A resource management planning system, comprising:
a web server having access to digital imagery of geographic areas and geospatial information associated with the digital imagery;
computer programming for compiling geospatial information for a site selected from the digital imagery; and
computer programming for generating a nutrient management plan identifying nutrient management practices for agricultural operations on a selected site in which nutrients are applied to the land and/or animal waste or other bio-nutrients are handled.

22. The system of claim 21, wherein the computer programming for compiling geospatial information resides on the web server and the computer programming for generating a conservation plan resides on a client remote from the web server.

23. A resource management planning system, comprising:
a web server having access to digital imagery of geographic areas and geospatial information associated with the digital imagery;
computer programming for compiling geospatial information for a site selected from the digital imagery; and
computer programming for generating a nutrient management plan identifying nutrient management practices for agricultural operations on a selected site in which nutrients are applied to the land and/or animal waste or other bio-nutrients are handled, including computer programming implementing an agricultural producer self-guided adaptation of NRCS nutrient management planning guidelines and processes through a series of graphical user interfaces prompting the producer to input information and answer questions related to nutrient management.

24. A computer readable medium having instructions thereon for:
associating geospatial information with digital imagery of geographic areas;
compiling geospatial information for a site selected from the digital imagery;
defining a planning unit within the site;
defining characteristics of the planning unit; and
based on defined characteristics, generating a nutrient management plan identifying nutrient management practices for agricultural operations on the planning unit in which nutrients are applied to the land and/or animal waste or other bio-nutrients are handled.

25. A computer readable medium having instructions thereon for:
associating geospatial information with digital imagery of multiple agricultural sites;
compiling the geospatial information for a site selected from the multiple sites;
defining a farm or ranch within the site;
defining characteristics of the farm or ranch including identifying geospatial information, irrigation features, hydrological features and facilities of the farm or ranch; and
based on defined characteristics, generating a nutrient management plan identifying nutrient management practices for operations on the farm or ranch in which nutrients are applied to the land and/or animal waste or other bio-nutrients are handled.

26. The medium of claim 25, wherein identifying a farm or ranch comprises identifying a farm field or a ranch field and defining characteristics comprises defining characteristics of the farm field or ranch field including identifying geospatial information, irrigation features, hydrological features and facilities of the farm field or ranch field.

27. The medium of claim 25, wherein defining characteristics comprises defining characteristics of the farm or ranch including identifying geospatial information, irrigation features, hydrological features, facilities and practices being implemented on the farm or ranch.

28. A computer readable medium having instructions thereon for:
associating geospatial information with aerial photographs of an agricultural site;
defining characteristics of the site including identifying geospatial information and facilities of the site;
prompting a user to identify nutrients produced in or imported to an agricultural operation at the site
prompting the user to identify nutrients used in the agricultural operation;
based on defined characteristics of the site, identifying the risk of environmental degradation associated with the production, importation and use of nutrients at the site; and
generating a nutrient management plan identifying resource management practices needed to reduce any unacceptably high risk of environmental degradation to an acceptable level.

29. The medium of claim 28, wherein:
prompting a user to identify nutrients produced in or imported to an agricultural operation at the site comprises prompting an agricultural producer to identify nutrients produced in or imported to an agricultural operation at the site; and
prompting the user to identify nutrients used in the agricultural operation comprises prompting the producer to identify nutrients used in the agricultural operation.

30. A computer readable medium having instructions thereon for:
associating geospatial information with aerial photographs of an agricultural site;
prompting a user to indicate whether livestock is raised or animal waste is imported to the site;
in response to an indication that livestock is raised and/or animal waste is imported, prompting the user to input information about animal waste production or importation and the use of animal waste at the site;
sizing facilities to store animal waste at the site;
prompting the user to indicate whether crops are grown at the site;
in response to an indication that crops are raised, prompting the user to input information about the crops raised at the site;
determining the amount of animal waste that can be safely applied to crops raised at the site;
prompting the user to identify irrigation systems used in crop production at the site;
in response to identifying irrigation systems, prompting the user to input information about each irrigation system used in crop production at the site;
determining if excess water is being applied at the site through irrigation;
based on information input animal waste, crops and irrigation, identifying physical and/or operational features of the site that create an unacceptably high risk of undesirable nutrient transport; and
generating a nutrient management plan identifying resource management practices needed to modify identified features to reduce the risk to an acceptable level.

31. The medium of claim 30, wherein:
prompting a user to indicate whether livestock is raised or animal waste is imported to the site comprises prompting an agricultural producer to indicate whether livestock is raised or animal waste is imported to the site;
prompting the user to input information about animal waste production or importation and the use of animal waste at the site comprises prompting the producer to input information about animal waste production or importation and the use of animal waste at the site;
prompting the user to indicate whether crops are grown at the site comprises prompting the producer to indicate whether crops are grown at the site;
prompting the user to input information about the crops raised at the site comprises prompting the producer to input information about the crops raised at the site;
prompting the user to identify irrigation systems used in crop production at the site comprises prompting the producer to identify irrigation systems used in crop production at the site; and
prompting the user to input information about each irrigation system used in crop production at the site comprises prompting the producer to input information about each irrigation system used in crop production at the site.

32. A method for conservation planning, comprising:
associating geospatial information with digital imagery of geographic areas;
compiling geospatial information for a site selected from the digital imagery;
defining a planning unit within the site;
defining characteristics of the planning unit; and
based on defined characteristics, generating a conservation plan identifying resource problems for the planning unit and identifying practices that when implemented are expected to solve the resource problems.

33. The method of claim 32, wherein generating a conservation plan comprises identifying resource problems for the planning unit, identifying practices that when implemented are expected to solve the resource problems and establishing a schedule for implementing the practices.

34. A method for conservation planning, comprising:
associating geospatial information with digital imagery of multiple agricultural sites;
compiling the geospatial information for a site selected from the multiple sites;
defining a farm or ranch within the site;
defining characteristics of the farm or ranch including identifying geospatial information, irrigation features, hydrological features and facilities of the farm or ranch; and
based on defined characteristics, generating a conservation plan identifying resource problems for the farm or ranch and identifying practices that when implemented are expected to solve the resource problems.

35. The method of claim 34, wherein identifying a farm or ranch comprises identifying a farm field or a ranch field and defining characteristics comprises defining characteristics of the farm field or ranch field including identifying geospatial information, irrigation features, hydrological features and facilities of the farm field or ranch field.

36. The method of claim 34, wherein defining characteristics comprises defining characteristics of the farm or ranch including identifying geospatial information, irrigation features, hydrological features, facilities and practices being implemented on the farm or ranch.

37. A method for conservation planning, comprising:
prompting a user to identify a planning unit;
aligning the planning unit with applicable NRCS Guidance Document Templates;
identifying resources typically a problem in the planning unit;
prompting the user to assess if a resource identified as typically a problem for the planning unit is actually a problem for the planning unit;
prompting the user to identify resource management practices needed to resolve each resource actually a problem for the planning unit from a list of Best Management Practices compiled by the NRCS in its Field Office Technical Guide;
generating a conservation plan identifying the planning unit, resources actually a problem for the planning unit and the resource management practices need to resolve each resource problem.

38. The method of claim 37, further comprising:
prompting the user to assess existing and planned features of buildings and areas around buildings;
identifying in a farmstead action plan with any corrective actions to be taken in and around buildings; and
wherein generating a conservation plan comprises generating a conservation plan identifying the planning unit, identifying resources actually a problem for the planning unit, identifying the resource management practices need to resolve each resource problem, and describing the farmstead action plan.

39. The method of claim 37, further comprising:
developing an implementation schedule for each resource management practice; and
wherein generating a conservation plan comprises generating a conservation plan identifying the planning unit, identifying resources actually a problem for the planning unit, identifying the resource management practices need to resolve each resource problem, and describing the implementation schedule.

40. The method of claim 38, further comprising:
developing an implementation schedule for each resource management practice and each corrective action; and
wherein generating a conservation plan comprises generating a conservation plan identifying the planning unit, identifying resources actually a problem for the planning unit, identifying the resource management practices need to resolve each resource problem, describing the farmstead action plan, and describing the implementation schedule.

41. A method for nutrient management planning, comprising:
associating geospatial information with digital imagery of geographic areas;
compiling geospatial information for a site selected from the digital imagery;
defining a planning unit within the site;
defining characteristics of the planning unit; and
based on defined characteristics, generating a nutrient management plan identifying nutrient management practices for agricultural operations on the planning unit in which nutrients are applied to the land and/or animal waste or other bio-nutrients are handled.

42. A method for nutrient management planning, comprising:
associating geospatial information with digital imagery of multiple agricultural sites;
compiling the geospatial information for a site selected from the multiple sites;
defining a farm or ranch within the site;
defining characteristics of the farm or ranch including identifying geospatial information, irrigation features, hydrological features and facilities of the farm or ranch; and
based on defined characteristics, generating a nutrient management plan identifying nutrient management practices for operations on the farm or ranch in which nutrients are applied to the land and/or animal waste or other bio-nutrients are handled.

43. The method of claim 42, wherein identifying a farm or ranch comprises identifying a farm field or a ranch field and defining characteristics comprises defining characteristics of the farm field or ranch field including identifying geospatial information, irrigation features, hydrological features and facilities of the farm field or ranch field.

44. The method of claim 42, wherein defining characteristics comprises defining characteristics of the farm or ranch including identifying geospatial information, irrigation features, hydrological features, facilities and practices being implemented on the farm or ranch.

45. A method for nutrient management planning, comprising:
associating geospatial information with aerial photographs of an agricultural site;
defining characteristics of the site including identifying geospatial information and facilities of the site;
prompting a user to identify nutrients produced in or imported to an agricultural operation at the site
prompting the user to identify nutrients used in the agricultural operation;
based on defined characteristics of the site, identifying the risk of environmental degradation associated with the production, importation and use of nutrients at the site; and
generating a nutrient management plan identifying resource management practices needed to reduce any unacceptably high risk of environmental degradation to an acceptable level.

46. The method of claim 45, wherein:
prompting a user to identify nutrients produced in or imported to an agricultural operation at the site comprises prompting an agricultural producer to identify nutrients produced in or imported to an agricultural operation at the site; and
prompting the user to identify nutrients used in the agricultural operation comprises prompting the producer to identify nutrients used in the agricultural operation.

47. A method for nutrient management planning, comprising:
associating geospatial information with aerial photographs of an agricultural site;
prompting a user to indicate whether livestock is raised or animal waste is imported to the site;
in response to an indication that livestock is raised and/or animal waste is imported, prompting the user to input information about animal waste production or importation and the use of animal waste at the site;
sizing facilities to store animal waste at the site;
prompting the user to indicate whether crops are grown at the site;
in response to an indication that crops are raised, prompting the user to input information about the crops raised at the site;
determining the amount of animal waste that can be safely applied to crops raised at the site;
prompting the user to identify irrigation systems used in crop production at the site;
in response to identifying irrigation systems, prompting the user to input information about each irrigation system used in crop production at the site;
determining if excess water is being applied at the site through irrigation;
based on information input animal waste, crops and irrigation, identifying physical and/or operational features of the site that create an unacceptably high risk of undesirable nutrient transport; and
generating a nutrient management plan identifying resource management practices needed to modify identified features to reduce the risk to an acceptable level.

48. The method of claim 47, wherein:
prompting a user to indicate whether livestock is raised or animal waste is imported to the site comprises prompting an agricultural producer to indicate whether livestock is raised or animal waste is imported to the site;
prompting the user to input information about animal waste production or importation and the use of animal waste at the site comprises prompting the producer to input information about animal waste production or importation and the use of animal waste at the site;
prompting the user to indicate whether crops are grown at the site comprises prompting the producer to indicate whether crops are grown at the site;
prompting the user to input information about the crops raised at the site comprises prompting the producer to input information about the crops raised at the site;
prompting the user to identify irrigation systems used in crop production at the site comprises prompting the producer to identify irrigation systems used in crop production at the site; and
prompting the user to input information about each irrigation system used in crop production at the site comprises prompting the producer to input information about each irrigation system used in crop production at the site.
